(19) United States
(12) Patent Application Publication
(10) Pub. No.: US 2020/0133307 A1
(43) Pub. Date: Apr. 30, 2020

(54) SYSTEMS AND METHODS FOR SWARM ACTION

(71) Applicant: Honda Motor Co., Ltd., Tokyo (JP)

(72) Inventors: Paritosh Kelkar, Dearborn, MI (US); Xue Bai, Novi, MI (US); Samer Rajab, Novi, MI (US); Shigenobu Saigusa, West Bloomfield, MI (US); Hossein Mahjoub, Ann Arbor, MI (US); Yasir Al-Nadawi, Ann Arbor, MI (US)

(21) Appl. No.: 16/730,217

(22) Filed: Dec. 30, 2019

Related U.S. Application Data
(63) Continuation-in-part of application No. 16/050,158, filed on Jul. 31, 2018.
Application No. 16/050,158 is a continuation-in-part of application No. 16/415,379, filed on May 17, 2019.
Application No. 16/415,379 is a continuation-in-part of application No. 16/050,158, filed on Jul. 31, 2018.
(60) Provisional application No. 62/862,518, filed on Jun. 17, 2019.
(60) Provisional application No. 62/900,480, filed on Sep. 14, 2019.
(60) Provisional application No. 62/941,257, filed on Nov. 27, 2019.

(51) Int. Cl. G05D 1/02; G08G 1/01; G06K 9/62; G06K 9/00

(52) U.S. Cl. CPC G05D 1/0291; G08G 1/0125; G05D 2201/0213; G06K 9/00791; G06K 9/6288

(57) ABSTRACT

Systems and methods for a swarm management framework are described. According to one embodiment, a swarm management framework includes a goal module, a target module, a negotiation module, and a perception module. The goal module determines a cooperation goal. The target module identifies a vehicle associated with the cooperation goal and sends a swarm request to the vehicle to join a swarm. The negotiation module receives a swarm acceptance from the vehicle. The perception module determines a cooperative action for the vehicle relative to the swarm.

### RELATED APPLICATIONS

This application expressly incorporates by reference herein each of the following: U.S. application Ser. No. 15/686,262 filed on Aug. 25, 2017 and now published as U.S. Pub. No. 2019/0069052; U.S. application Ser. No. 15/686,250 filed on Aug. 25, 2017 and now issued as U.S. Pat. No. 10,334,331; U.S. application Ser. No. 15/851,536 filed on Dec. 21, 2017 and now published as U.S. Pub. No. 2019/0196025; U.S. application Ser. No. 15/851,566 filed on Dec. 21, 2017 and now issued as U.S. Pat. No. 10,168,418; and U.S. application Ser. No. 16/177,366 filed on Oct. 31, 2018 now issued as U.S. Pat. No. 10,338,196.

Furthermore, this application is a continuation in part and incorporates by reference herein each of the following: U.S. application Ser. No. 16/050,158 filed Jul. 31, 2018; U.S. application Ser. No. 16/415,379 filed on May 17, 2019; and claims the benefit of U.S. Prov. App. Ser. 62/862,518 filed on Jun. 17, 2019; U.S. Prov. App. Ser. 62/900,480 filed on Sep. 14, 2019; and U.S. Prov. App. Ser. 62/941,257 filed on Nov. 27, 2019; all of the foregoing again are expressly incorporated herein by reference.

### BACKGROUND

Vehicles have varying levels of autonomy. Some vehicles can assist drivers with lane keeping and parallel parking, while vehicles with higher levels of autonomy can maneuver on busy city streets and congested highways without driver intervention. Multiple vehicles, having some level of autonomy, operating in a coordinated manner, are referred to as a swarm. The vehicles operating in coordinated manner are members of the swarm. The collective behavior of the members of the swarm that emerges from the interactions. The collective behavior may be determined in order to achieve a specific goal.

### BRIEF DESCRIPTION

According to one aspect, a swarm management framework includes a goal module, a target module, a negotiation module, and a perception module. The goal module determines a cooperation goal. The target module identifies a vehicle associated with the cooperation goal and sends a swarm request to the vehicle to join a swarm. The negotiation module receives a swarm acceptance from the vehicle. The perception module determines a cooperative action for the vehicle relative to the swarm.

According to another aspect, a computer-implemented method for utilizing a swarm management framework. The computer-implemented method includes determining a cooperation goal. The method also includes identifying a vehicle associated with the cooperation goal and sending a swarm request to the vehicle to join a swarm. The method further includes receiving a swarm acceptance from the vehicle. The method yet further includes determining cooperative action for the vehicle relative to the swarm.

According to a further aspect, a non-transitory computer-readable storage medium including instructions that when executed by a processor, cause the processor to perform a method. The computer-implemented method includes determining a cooperation goal. The method also includes identifying a vehicle associated with the cooperation goal and sending a swarm request to the vehicle to join a swarm. The method further includes receiving a swarm acceptance from the vehicle. The method yet further includes determining cooperative action for the vehicle relative to the swarm.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings.

FIG. 1 is a block diagram of an exemplary swarm management framework according to one embodiment.

FIG. 2A is a schematic diagram of an exemplary traffic scenario on a roadway at a first time according to one embodiment.

FIG. 2B is a schematic diagram of an exemplary traffic scenario on a roadway at a second time, later than the first time according to one embodiment.

FIG. 3 is a schematic view of an exemplary sensor map of a swarm member, according to one embodiment.

FIG. 4 is a block diagram of an operating environment for implementing a swarm management framework according to an exemplary embodiment.

FIG. 5 is a process flow for utilizing a swarm management framework according to one embodiment.

FIG. 6 is a process flow for swarm creation according to one embodiment.

FIG. 7 is a block diagram of an exemplary swarm management framework according to an exemplary embodiment.

FIG. 8 is a process flow for a swarm management framework according to one embodiment.

FIG. 9 is a schematic view of an exemplary traffic scenario on a roadway according to one embodiment.

FIG. 10 is a block diagram of an exemplary swarm management framework for implementing a cooperative sensing system according to an exemplary embodiment.

FIG. 11 is a process flow for shared autonomy through cooperative sensing according to one embodiment.

FIG. 12 is a block diagram of subsystems present on vehicles with different levels of autonomy according to an exemplary embodiment.

FIG. 13 is a schematic view of an exemplary traffic scenario on a roadway having vehicles with different levels of autonomy according to one embodiment.

FIG. 14 is a process flow for a cooperative position plan according to one embodiment.

FIG. 15 is a schematic view of an exemplary traffic scenario on a roadway having the vehicles in a cooperative position according to one embodiment.

FIG. 16 is a schematic view of an exemplary traffic scenario on a roadway having vehicles engaging in parameter negotiation according to one embodiment.

FIG. 17 is a schematic view of an exemplary traffic scenario on a roadway having vehicles engaging in cooperative sensing according to one embodiment.

FIG. 18 is a schematic view of an exemplary traffic scenario on a roadway having vehicles engaging in cooperative sensing to generate a sensor map according to one embodiment.

FIG. 19 is a schematic view of an exemplary traffic scenario on a roadway having an obstacle according to one embodiment.

FIG. 20 is a schematic view of an exemplary traffic scenario on a roadway having multiple principal vehicles engaging in a cooperative swarm according to one embodiment.

FIG. 21 is a process flow for shared autonomy in a cooperative swarm according to one embodiment.

FIG. 22 is a schematic view of an exemplary traffic scenario on a roadway having different groupings of cooperating vehicles according to one embodiment.

FIG. 23 is a schematic view of an exemplary visual representation of cooperating vehicles according to one embodiment.

FIG. 24 is a process flow for shared autonomy using a visual representation according to one embodiment.

FIG. 25 is a process flow for shared autonomy with a cooperative position sensor adjustment according to one embodiment.

FIG. 26 is a process flow for shared autonomy according to one embodiment.

FIG. 27 is a process flow for shared autonomy based on a vehicle occupant state according to one embodiment.

FIG. 28A is a schematic view of an exemplary traffic scenario on a roadway having multiple swarms according to one embodiment.

FIG. 28B is a schematic view of an exemplary traffic scenario on a roadway having a super swarm according to one embodiment.

FIG. 28C is a schematic view of an exemplary traffic scenario on a roadway having swapped swarms according to one embodiment.

FIG. 29 is a process flow for shared autonomy for a super swarm according to one embodiment.

FIG. 30 is a process flow for shared autonomy for swapped swarms according to one embodiment.

### DETAILED DESCRIPTION

The swarm framework facilitates coordination between multiple vehicles to achieve a goal. The goal may be to confer a benefit to one or more vehicles or to the traffic on the roadway as a whole, and include a unidirectional goal, a bidirectional goal, or an omnidirectional goal. The unidirectional goal may confer a benefit to an individual vehicle. In particular, the unidirectional goal may harness the power of the multiple vehicles for the benefit one. For example, members of the swarm may be controlled to pull off to the side of the road to make way for an emergency vehicle. Another example of a unidirectional benefit may be additional sensor data being provided from a vehicle with a higher level of autonomy to a vehicle with a lower level of autonomy to supplement the lower autonomy vehicle's sensor data. The bidirectional goal confers a benefit to multiple vehicles. Continuing the example from above, the lower autonomy vehicle may also provide sensor data to the higher autonomy vehicle to increase the higher autonomy vehicle's sensor range, such that both the lower autonomy vehicle and the higher autonomy vehicle receive a benefit by sharing sensor data. The omnidirectional goal confers a benefit to objects in the environment. For example, the omnidirectional benefit may benefit a pedestrian crossing a crosswalk. As another example, the omnidirectional benefit may benefit the movement of the swarm as a whole.

As discussed above, the members of the swarm may exhibit some level of autonomy, such that, to some degree, the members can be controlled without intervention from a vehicle occupant. The members of the swarm may control themselves according to the goal and/or may control each other. For example, using the swarm framework, may optimized shape of the swarm may be determined according to the instantaneous traffic scenario and the goal of the swarm. For example, the goal may be to enhance the traffic throughput, safety objectives, and/or other driver-specific needs. To satisfy the goal, one or more of the members of the swarm may be subordinate vehicles that are controlled by one or more members of the swarm that are principal vehicles, capable of remotely controlling other vehicles. Alternatively, each members of the swarm may control themselves in order to satisfy the goal.

The swarm management framework 100 facilitates achievement of the goal. For example, the swarm management framework 100 may determine a goal, identify the vehicles necessary for a swarm to achieve the goal, and determine a control strategy for the vehicles of the swarm. Consequently, the swarm management framework 100 provides the benefit between the members of the swarm. In some embodiments, the swarm management framework 100 is impartial such that the swarm management framework 100 does not prioritize or give privileges to certain members of the swarm based on their levels of autonomy, specific built-in features, etc. Additionally, the impartiality may be considered among non-swarm agents (e.g., vehicles that have left the swarm, classic vehicles) or cooperative vehicles that have the capability to participate in the swarm but are currently not. Conversely, the swarm management framework 100 may prioritize members of the swarm. For example, a principal vehicle may make decisions and transmit those decisions to the other members of the swarm. In yet another embodiment, a member of the swarm may be prioritized over other members of the swarm based on seniority in swarm, autonomy level, position in the swarm, etc. or combination thereof.

The swarm management framework 100 may also monitor the members of the swarm to determine compliance. Compliance may be determined based on whether the members of the swarm are acting to benefit themselves, an individual member of the swarm, or the swarm as a whole. For example, compliance monitoring may determine whether the individual decisions of a member of the swarm contradict the swarm strategy which aims to maximize the overall swarm benefits and/or the swarm goal.

### Definitions

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Processor Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, instructions for execution, and a computer. A computer component(s) can reside within a process and/or thread. A computer component can be localized on one computer and/or can be distributed between multiple computers.

“Computer communication,” as used herein, refers to a communication between two or more computing devices (e.g., computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, vehicle to cloud communications, among others. Computer communication can utilize any type of wired, wireless, or network communication protocol including, but not limited to, Ethernet (e.g., IEEE 802.3), Wi-Fi (e.g., IEEE 802.11), communications access for land mobiles (CALM), WiMAX, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk and/or a memory.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Input/output device” (I/O device) as used herein can include devices for receiving input and/or devices for outputting data. The input and/or output can be for controlling different vehicle features which include various vehicle components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to: display devices, and other devices for outputting information and functions.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Obstacle”, as used herein, refers to any objects in the roadway and may include pedestrians crossing the roadway, other vehicles, animals, debris, potholes, etc. Further, an ‘obstacle’ may include most any traffic conditions, road conditions, weather conditions, buildings, landmarks, obstructions in the roadway, road segments, intersections, etc. Thus, obstacles may be identified, detected, or associated with a path along a route on which a vehicle is travelling or is projected to travel along.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets and e-readers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

“Vehicle,” as used herein, refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more human occupants. Further, the term “vehicle” can include vehicles that are automated or non-automated with pre-determined paths or free-moving vehicles.

“Vehicle display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be located in various locations of the vehicle, for example, on the dashboard or center console. In some embodiments, the display is part of a portable device (e.g., in possession or associated with a vehicle occupant), a navigation system, an infotainment system, among others.

“Vehicle control system” and/or “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, a monitoring system, a passenger detection system, a vehicle suspension system, a vehicle seat configuration system, a vehicle cabin lighting system, an audio system, a sensory system, an interior or exterior camera system among others.

“Vehicle occupant,” as used herein can include, but is not limited to, one or more biological beings located in the vehicle. The vehicle occupant can be a driver or a passenger of the vehicle. The vehicle occupant can be a human (e.g., an adult, a child, an infant) or an animal (e.g., a pet, a dog, a cat).

### I. System Overview

Referring now to the drawings, the drawings are for purposes of illustrating one or more exemplary embodiments and not for purposes of limiting the same. The examples below will be described with respect to vehicles for clarity, but may be applied to other objects, such as robots, that navigate space and can coordinate with other objects.

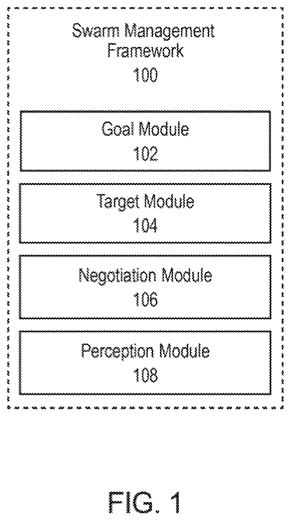

FIG. 1 is a block diagram of the swarm management framework 100 according to one embodiment. The swarm management framework 100 includes a goal module 102, a target module 104, a negotiation module 106, and a perception module 108. The swarm management framework 100 will be described with respect to different embodiments. For example, the swarm management framework 100 may be used in conjunction within a vehicle computing device (VCD) 402 and may be implemented with a cooperating vehicle, for example, as part of a telematics unit, a head unit, an infotainment unit, an electronic control unit, an on-board unit, or as part of a specific vehicle control system, among others. In other embodiments, the swarm management framework 100 can be implemented remotely from a cooperating vehicle, for example, with a portable device 454, or the remote server 436, connected via the communication network 420 or the wireless network antenna 434.

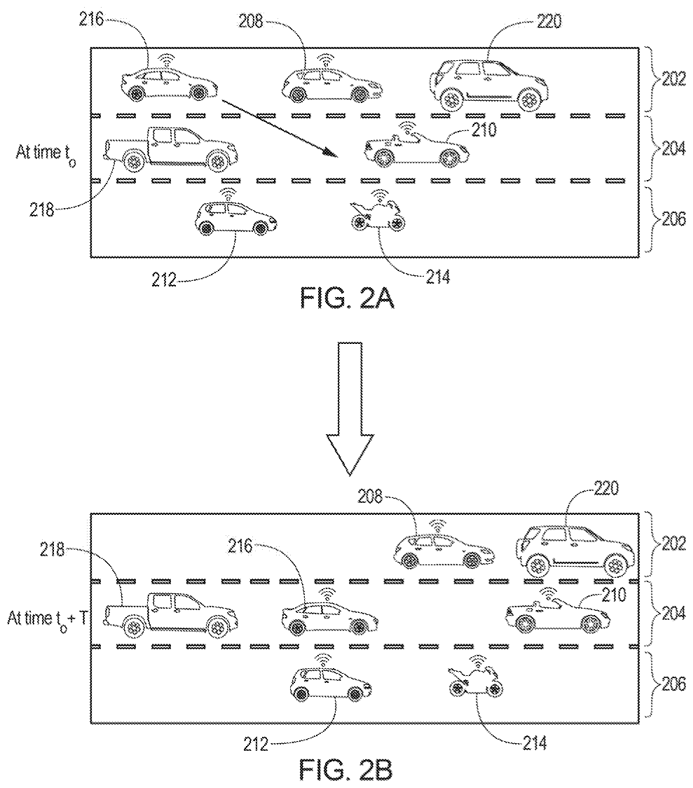

FIGS. 2A and 2B are schematic views of an exemplary traffic scenario on a roadway that will be used to describe swarm management for multiple vehicles according to one embodiment. The roadway can be any type of road, highway, freeway, or travel route. In FIG. 2, the roadway includes a first lane 202, a second lane 204, and a third lane 206 with vehicles traveling in the same longitudinal direction, however, the roadway can have various configurations not shown and can have any number of lanes.

The roadway includes a plurality of vehicles. The plurality of vehicles may be classified based on their membership in the swarm and/or autonomy capability. Because vehicles may join and leave the swarm, the classification of the vehicles based on membership in the swarm is time dependent. Suppose that FIG. 2A is a snapshot of the roadway at a first time, while FIG. 2B is a snapshot of the roadway at a second time that is later than the first time. The classification of one or more vehicles may change in time based on their current relationship with the swarm. For example, a cooperative vehicle may be any vehicle that is capable of participating in a swarm but is currently not participating in a swarm.

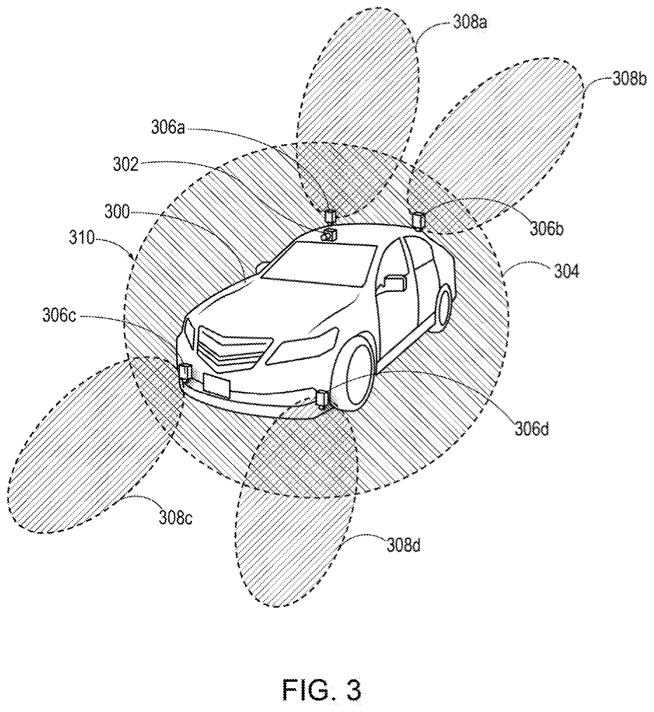

In FIG. 2A, the swarm members include cooperative vehicles 208, 210, 212, and 214. While cooperative vehicle 216 is a requestor that is requesting to join the swarm at the first time represented in FIG. 2A, as will be discussed in greater detail below. In FIG. 2B, the swarm members include the cooperative vehicles 208, 210, 212, and 214 as well as the cooperative vehicle 216 because the request to join the swarm has been granted by the second time, represented by FIG. 2B. The cooperative vehicles exhibit some level of functioning autonomy, such as parking assist or adaptive cruise control, and are able to engage in computer communication with other vehicles. A cooperative vehicle may be a host vehicle to an operating environment 400 having access, either directly or remotely, to a VCD 402 that will be described in further detail with respect to FIG. 3.

The cooperative vehicles may be autonomous vehicles having the same or varying levels of autonomy. The levels of autonomy describe a cooperative vehicle's ability to sense its surroundings and possibly navigate pathways without human intervention. In some embodiments, the levels may be defined by specific features or capabilities that the cooperative vehicle may have, such as a cooperative vehicle's ability to plan a path.

Classic vehicles, such as non-cooperating vehicle 218 may also be traveling the roadway 200, as shown in FIGS. 2A and 2B. A classic vehicle without sensing capability or decision-making ability may have a null autonomy level meaning that the car has only the most basic sensing ability, such as environmental temperature, and no decision-making ability.

Whether a vehicle is a cooperative vehicle or classic vehicle may be based on the vehicle's ability to communicate with other vehicles, roadside equipment, infrastructure, a data storage cloud etc. Additionally or alternatively, whether a vehicle is a cooperative vehicle or classic vehicle may be based on the vehicle's autonomy level. Accordingly, a cooperative vehicle may defined by a combination of factors. For example, suppose that an example vehicle is fully autonomous, but is damaged and is unable to communicate with other vehicles. The example vehicle may still be autonomous, but not be a cooperative vehicle because the example vehicle cannot currently communicate with other vehicles.

As an example of autonomy levels, a vehicle capable of decision making, path planning, and navigation without human intervention may have a full autonomy level. A fully autonomous vehicle may function, for example, as a robotic taxi. In between the null autonomy level and the full autonomy level exist various autonomy levels based on sensing ability and decision-making capability. A vehicle with a lower level of autonomy may have some sensing ability and some minor decision-making capability. For example, a cooperating vehicle having a lower level may use light sensors (e.g., cameras and light detecting and ranging (LiDAR) sensors) for collision alerts. A cooperating vehicle having a higher level of autonomy may be capable of decision making, path planning, and navigation without human intervention, but only within a defined area. These descriptions of levels are exemplary in nature to illustrate that there are differences in the autonomous abilities of different vehicles. More or fewer autonomy levels may be used. Furthermore, the levels may not be discrete, for example based on a binary determination of whether they include specific functionalities, but rather be more continuous in nature.

As a further example of autonomy levels, the Society of Automotive Engineers (SAE) has defined six levels of autonomy. SAE Level 0 includes an automated system that issues warnings and may momentarily intervene but has no sustained vehicle control. At SAE Level 1 the driver and the automated system share control of the vehicle. For example, SAE Level 1 includes features like Adaptive Cruise Control (ACC) and Parking Assistance. At SAE Level 2 the automated system takes full control of the vehicle (accelerating, braking, and steering), but the driver must monitor the driving and be prepared to intervene immediately at any time if the automated system fails to respond properly. A vehicle at SAE Level 3 allows the driver to safely turn their attention away from the driving tasks and the vehicle will handle situations that call for an immediate response, like emergency braking. At SAE Level 4 driver attention is not required for safety, for example, the driver may safely go to sleep or leave the driver's seat. However, self-driving may only be supported in predetermined spatial areas. A vehicle at SAE Level 5 does not require human intervention. For example, a robotic taxi would be operating at SAE Level 5.

The SAE Levels are provided as an example to understand the difference in autonomy levels and are described in the embodiments herein merely for clarity. However, the systems and methods described herein may operate with different autonomy levels. The autonomy levels may be recognized by other swarm members and/or cooperating vehicles based on standardized autonomy levels such as the SAE levels or as provided by the National Highway Traffic Safety Administration (NHTSA). For example, a cooperating vehicle may broadcast its autonomy level.

Returning to FIGS. 2A and 2B, one or more of the cooperative vehicles, such as cooperative vehicles 208, 210, 212, 214, and 216, may include at least one sensor for sensing objects and the surrounding environment. In an exemplary embodiment, the surrounding environment may be defined as a predetermined area located around (e.g., ahead, to the side of, behind, above, below) a host vehicle 300 and includes a road environment in front, to the side, and/or behind of the cooperative vehicle. Turning to FIG. 3, the at least one sensor may include a light sensor 302 for capturing principal sensor data in a light sensing area 304 and one or more principal image sensors 306a, 306b, 306c, and 306d for capturing sensor data in corresponding image sensing areas 308a, 308b, 308c, and 308d which form an example sensor map. The sensor map 310 shown in FIG. 3 is based on one configuration of sensors including the light sensor 302 and the one or more principal image sensors 306a, 306b, 306c, and 306d. However, the sensor map 310 may have various configurations not shown in FIG. 3 based on the presence, position, acuity, etc. of vehicle sensors of the members of the swarm.

The light sensor 302 may be used to capture light data in the light sensing area 304. The size of the light sensing area 304 may be defined by the location, range, sensitivity, and/or actuation of the light sensor 302. For example, the light sensor 302 may rotate 360 degrees around a cooperative vehicle and collect principal sensor data from the light sensing area 304 in sweeps. Conversely, the light sensor 302 may be omnidirectional and collect principal sensor data from all directions of the light sensing area 304 simultaneously. For example, the light sensor 302 emits one or more laser beams of ultraviolet, visible, or near infrared light in the light sensing area 304 to collect principal sensor data.

The light sensor 302 may be configured to receive one or more reflected laser waves (e.g., signals) that are reflected off one or more objects in the light sensing area 304. In other words, upon transmitting the one or more laser through the light sensing area 304, the one or more laser beams may be reflected as laser waves by one or more traffic related objects (e.g., vehicles, pedestrians, trees, guardrails, etc.) that are located within the light sensing area.

The one or more principal image sensors 306a, 306b, 306c, and 306d may also be positioned around cooperative vehicle to capture additional principal sensor data from the corresponding image sensing areas 308a, 308b, 308c, and 308d. The size of the image sensing areas 308a-308d may be defined by the location, range, sensitivity and/or actuation of the one or more principal image sensors 306a-306d.

The one or more principal image sensors 306a-306d may be disposed at external front and/or side portions of the cooperative vehicle, including, but not limited to different portions of the vehicle bumper, vehicle front lighting units, vehicle fenders, and the windshield. The one or more principal image sensors 306a-306d may be positioned on a planar sweep pedestal (not shown) that allows the one or more principal image sensors 306a-306d to be oscillated to capture images of the external environment of the host vehicle 300 at various angles. Additionally, the one or more principal image sensors 306a-306d may be disposed at internal portions of the host vehicle 300 including the vehicle dashboard (e.g., dash mounted camera), rear side of a vehicle rear view mirror, etc.

The sensor data includes the captured sensor data from the at least one sensor of the principal vehicle. In this example, the sensor data is captured from the light sensing area 304 and the image sensing areas 308a-308d. Therefore, the sensor data is from the area encompassed in the sensor map 310. The members of the swarm send and receive sensor data. For example, a first member may send sensor data from a first sensor map corresponding to the first member. The first member receives sensor data from a second sensor map corresponding to a second member. Because the sensor data is shared between each of the members of the swarm, the collective sensor data can be used to generate a swarm sensor map of the area encompassed by the swarm. Accordingly, the sensor map of an individual vehicle may expand as the sensor maps of the members of the swarm combine and overlap. The members of the swarm perceive the area of the swarm sensor map as sensor data is communicated between members of the swarm.

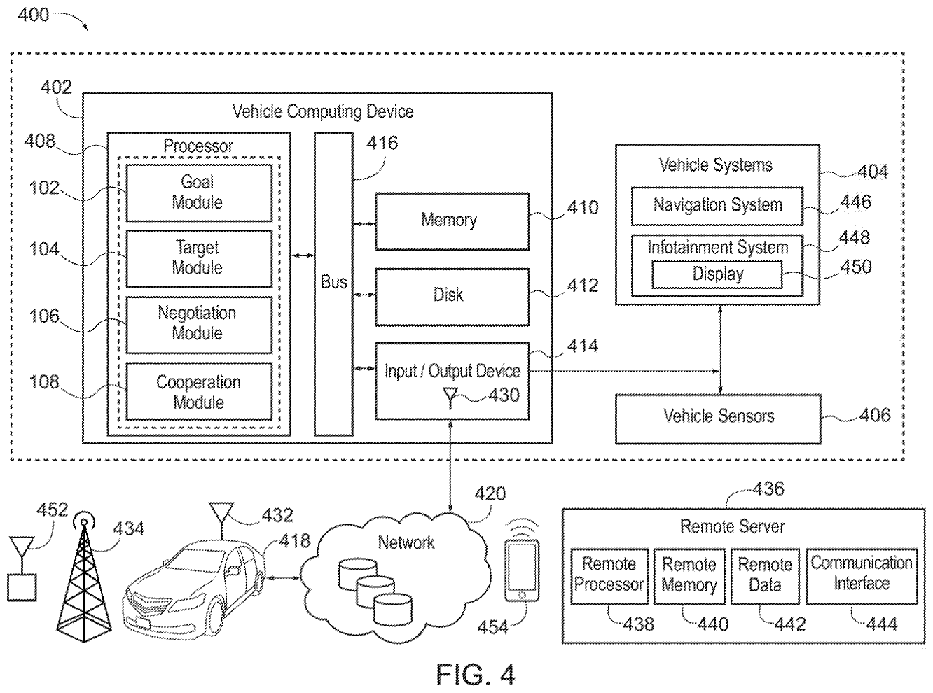

Members of the swarm have an operating environment that allows them to utilize the sensor data with a swarm management framework 100. For clarity, the operating environment will be described with respect to the host vehicle 300 which may represent an individual member of the swarm, a potential member of the swarm or be centralized for the swarm as a whole. Accordingly, any or all of the members of the swarm can act as the host vehicle 300 with respect to the operating environment 400 shown in FIG. 4.

FIG. 4 is a block diagram of the operating environment 400 for implementing a cooperative sensing system according to an exemplary embodiment. In FIG. 4, the host vehicle includes a vehicle computing device (VCD) 402, vehicle systems 404, and vehicle sensors 406. Generally, the VCD 402 includes a processor 408, a memory 410, a disk 412, and an input/output (I/O) device 414, which are each operably connected for computer communication via a bus 416 and/or other wired and wireless technologies defined herein. The VCD 402 includes provisions for processing, communicating, and interacting with various components of the host vehicle 300. In one embodiment, the VCD 402 can be implemented with the host vehicle, for example, as part of a telematics unit, a head unit, an infotainment unit, an electronic control unit, an on-board unit, or as part of a specific vehicle control system, among others. In other embodiments, the VCD 402 can be implemented remotely from the host vehicle, for example, with a remote transceiver 432 or a portable device 454) or a remote server (not shown) connected via the communication network 420.

The processor 408 can include logic circuitry with hardware, firmware, and software architecture frameworks for facilitating swarm control of the host vehicle 300. The processor 408 can store application frameworks, kernels, libraries, drivers, application program interfaces, among others, to execute and control hardware and functions discussed herein. For example, the processor 408 can include the goal module 102, the target module 104, the negotiation module 106, and the perception module 108, although the processor 408 can be configured into other architectures. Further, in some embodiments, the memory 410 and/or the disk 412 can store similar components as the processor 408 for execution by the processor 408.

The I/O device 414 can include software and hardware to facilitate data input and output between the components of the VCD 402 and other components of the operating environment 400. Specifically, the I/O device 414 can include network interface controllers (not shown) and other hardware and software that manages and/or monitors connections and controls bi-directional data transfer between the I/O device 414 and other components of the operating environment 400 using, for example, the communication network 420.

More specifically, in one embodiment, the VCD 402 can exchange data and/or transmit messages with other cooperating vehicles, such as other members of the swarm, and/or other communication hardware and protocols. As will be described in greater detail below, cooperative vehicles in the surrounding environment whether they are members of the swarm or not, can also exchange data (e.g., vehicle sensor data, swarm creation requests, swarm join requests, swarm leave requests, etc.) over remote networks by utilizing a wireless network antenna (not shown), roadside equipment (not shown), and/or the communication network 420 (e.g., a wireless communication network), or other wireless network connections. In some embodiments, data transmission can be executed at and/or with other infrastructures and servers.

In some embodiments, cooperating vehicles may communicate via a transceiver (not shown). The transceiver may be a radio frequency (RF) transceiver can be used to receive and transmit information to and from a remote server. In some embodiments, the VCD 402 can receive and transmit information to and from the remote server including, but not limited to, vehicle data, traffic data, road data, curb data, vehicle location and heading data, high-traffic event schedules, weather data, or other transport related data. In some embodiments, the remote server can be linked to multiple vehicles, other entities, traffic infrastructures, and/or devices through a network connection, such as via the wireless network antenna, the roadside equipment, and/or other network connections.

In this manner, vehicles that are equipped with cooperative sensing systems may communicate via the remote transceiver if the cooperating vehicles are in transceiver range. Alternatively, the vehicles may communicate by way of remote networks, such as the communication network, the wireless network antenna, and/or the roadside equipment. For example, suppose the cooperating vehicle is out of transceiver range of the host vehicle. Another cooperating vehicle may communicate with the host vehicle using the transceiver. The transceiver may also act as interface for mobile communication through an internet cloud and is capable of utilizing a GSM, GPRS, Wi-Fi, WiMAX, or LTE wireless connection to send and receive one or more signals, data, etc. directly through the cloud. In one embodiment, the out of range vehicles may communicate with the host vehicle via a cellular network using the wireless network antenna.

Referring again to the host vehicle, the vehicle systems 404 can include any type of vehicle control system and/or vehicle described herein to enhance the host vehicle and/or driving of the host vehicle. For example, the vehicle systems 404 can include autonomous driving systems, driver-assist systems, adaptive cruise control systems, lane departure warning systems, merge assist systems, freeway merging, exiting, and lane-change systems, collision warning systems, integrated vehicle-based safety systems, and automatic guided vehicle systems, or any other advanced driving assistance systems (ADAS). Here, the vehicle systems 404 include a navigation system 446 and an infotainment system 448. The navigation system 446 stores, calculates, and provides route and destination information and facilitates features like turn-by-turn directions. The infotainment system 448 provides visual information and/or entertainment to the vehicle occupant and can include a display 450.

The vehicle sensors 406, which can be implemented with the vehicle systems 404, can include various types of sensors for use with the host vehicle and/or the vehicle systems 404 for detecting and/or sensing a parameter of the host vehicle, the vehicle systems 404, and/or the environment surrounding the host vehicle. For example, the vehicle sensors 406 can provide data about vehicles and/or downstream objects in proximity to the host vehicle. For example, the vehicle sensors 406 can include, but are not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. The vehicle sensors 406 can be any type of sensor, for example, acoustic, electric, environmental, optical, imaging, light, pressure, force, thermal, temperature, proximity, among others.

Using the system and network configuration discussed above, cooperative sensing and vehicle control can be provided based on real-time information from vehicles using vehicular communication of sensor data. Detailed embodiments describing exemplary methods using the system and network configuration discussed above, will now be discussed in detail.

One or more components of the operating environment 400 can be in whole or in part a vehicle communication network. It is understood that the host vehicle 300 having the operating environment 400 may be a potential member of a swarm or a member of the swarm. Other cooperating vehicles, such as the cooperative vehicles 208, 210, 212, 214 and 216 or non-cooperating vehicle 218 can include one or more of the components and/or functions discussed herein with respect to the host vehicle 300. Thus, although not shown in FIG. 4, one or more of the components of the host vehicle 300, can also be implemented with other cooperating vehicles and/or a remote server, other entities, traffic indicators, and/or devices (e.g., V2I devices, V2X devices) operable for computer communication with the host vehicle 300 and/or with the operating environment 400. Further, the components of the host vehicle 300 and the operating environment 400, as well as the components of other systems, hardware architectures, and software architectures discussed herein, can be combined, omitted, or organized or distributed among different architectures for various embodiments.

For purposes of illustration, cooperative vehicles 208, 210, 212, 214, and 216 is equipped for computer communication as defined herein. Vehicle 218 and 220 may be non-cooperating that do not utilize the swarm management framework 100. Although non-cooperating vehicles 218 and 220 may not participate in swarm activities, the methods and systems can perform swarm activities based on the information about the non-cooperating vehicles 218 and 220. The percentage of cooperating vehicles that are participating is the penetration rate of cooperating vehicles. A partial penetration rate is due to the existence of non-cooperating vehicles in a traffic scenario that also includes cooperating vehicles. The methods and systems can utilize the swarm framework based on the information received from the cooperating vehicles, even with a partial penetration rate.

### II. Methods for Swarm Activity

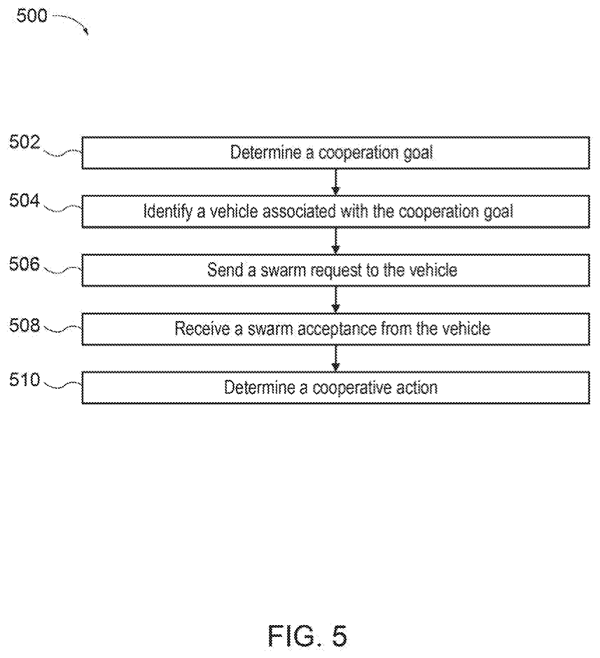

Referring now to FIG. 5, a method 500 for swarm activity is provided according to one embodiment will be described with respect to FIGS. 1-4. At block 502, the method 500 include the goal module 102 determines a cooperation goal. The cooperation goal may be to join a swarm. The goal may be a unidirectional goal, a bidirectional goal, or an omnidirectional goal as discussed above, such that a benefit may be conferred to a single vehicle, a group of vehicles, and/or the environment.

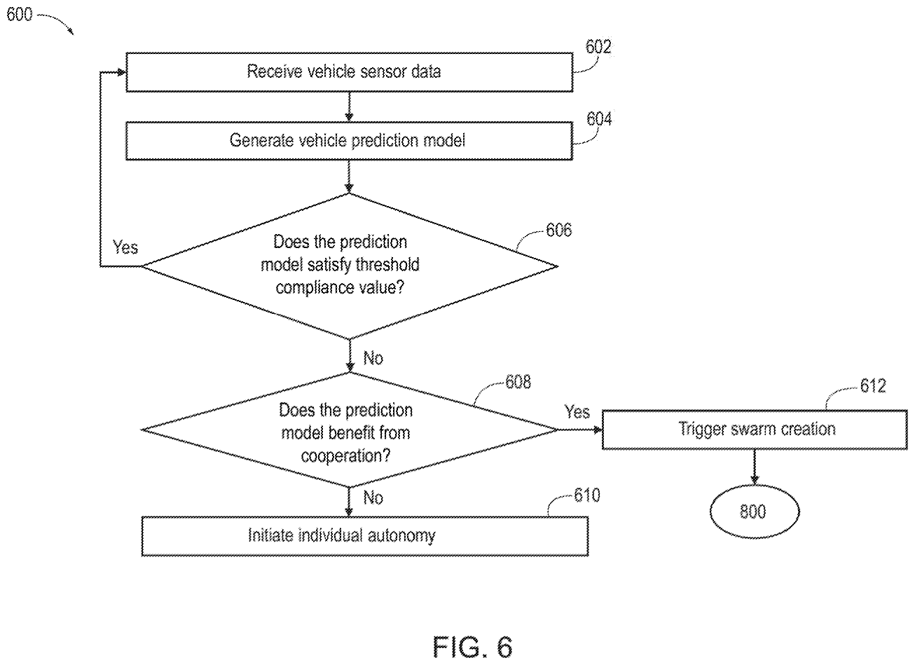

The goal may be determined based on the vehicle data, traffic data, road data, curb data, vehicle location and heading data, high-traffic event schedules, weather data, or other transport related data from any number of sources such as the cooperative vehicles 208-220, roadway devices, infrastructure, etc. Additionally or alternatively, the goal module 102 may be determined based on the vehicle systems 404 such as the navigation system 446 and/or the vehicle sensors 406. The goal may also be determined based on compliance with a predetermined or predicted threshold, as will be described in greater detail with respect to FIG. 6.

At block 504, the method 500 includes the target module 104 identifying a vehicle associated with the cooperation goal. For example, suppose that the goal module 102 identifies cooperative vehicle 208 as an obstacle in first lane 202 because the cooperative vehicle 208 is moving slowly based on vehicle sensor data from the vehicle sensors 406. The goal module 102 may identify the goal as the cooperative vehicle 216 from behind the cooperative vehicle 208 in the first lane 202 to the second lane 204. The target module 104 identifies cooperating vehicles that affect the goal. For example, to move into the second lane 204, the cooperative vehicle 216 may require a certain amount of space relative to vehicles already traveling in the second lane. Here, the space may be between the cooperative vehicle 210 and the non-cooperating vehicle 218. Accordingly, the target module 104 may identify the cooperative vehicle 210 and the non-cooperating vehicle 218 as targets for swarm activity, such that the cooperative vehicle 210 and the non-cooperating vehicle 218 are target vehicles. In another embodiment, the target module 104 may identify that non-cooperating vehicle 218 is a classic vehicle incapable of participating in swarm, and therefore, not include non-cooperating vehicle 218 as a target vehicle.

Further suppose that the cooperative vehicle 212 has indicated that it plans to move into the space between the cooperative vehicle 210 and the non-cooperating vehicle 218. The indication may be received as vehicle sensor data, for example, if a turn signal of the cooperative vehicle 212 is illuminated. In another embodiment, the cooperative vehicle 212 may be broadcasting an indication with the portable device 454, or the remote server 436, connected via the communication network 420 or the wireless network antenna 434. Because the goal is associated with the same space between the cooperative vehicle 210 and the non-cooperating vehicle 218, the target module 104 may further identify the cooperative vehicle 212 as a target for swarm activity based on vehicle sensor data and/or computer communication, such that the cooperative vehicle 212 is a target vehicle.

At block 506, the method 500 includes the target module 104 sending a swarm request to the vehicles identified as targets. As will be discussed in greater detail below with respect to FIG. 6, the swarm request may be a swarm creation request to create a new swarm. The swarm request may also be a request that the target vehicles join an existing swarm. The swarm request may be solely for the purpose of achieving the goal or may be non-specific.

The swarm request may be sent to all of the vehicles from the target module 104 with the portable device 454, or the remote server 436, connected via the communication network 420 or the wireless network antenna 434. In another embodiment, the swarm request may be relayed to cooperative vehicles as they are identified as target vehicles.

At block 508, the method 500 includes the negotiation module 106 receiving a swarm acceptance from the target vehicles. The acceptance may include vehicle identification information, vehicle sensor and system data, and/or cooperating parameters. The cooperating parameters define the relationship between the cooperative vehicles and between the cooperative vehicles and the swarm. The cooperative vehicles may include a number a number of cooperating parameters that apply to one or more of the vehicles or the swarm itself. In some embodiments, the cooperating parameters may be negotiated by the negotiation module 106. For example, the cooperating parameters may be received from the target vehicle by the swarm and compared to the swarm's own listing of cooperating parameters to determine if the cooperating parameters are amenable. The cooperating parameters may also be compared to safety guidelines, vehicle capabilities, etc. before determining whether the cooperating parameters are amenable.

At block 510, the method 500 includes the perception module 108 determining a cooperative action. The cooperative action may be an action for a target vehicle, roadway device, or infrastructure to facilitate achieving the goal. Continuing the example from above

Referring now to FIG. 6, a method 600 for swarm creation according to one embodiment will be described with reference to FIGS. 1-4. At 602, the method 600 includes receiving vehicle sensor data from vehicle systems 404 and vehicle sensors 406 of the host vehicle 300. The sensor fusion module 702 of the host vehicle 300 may collect data regarding the sensor map 310 using the vehicle sensors 306. The host vehicle 300 may already be receiving sensor data from multiple sources such as cooperating vehicles on the roadway 200, roadside equipment, portable devices, etc. The sensor fusion module 702 may combine the data from the multiple sources based on timing and relative position

At 604, the method 600 includes generating a vehicle prediction model. The prediction module 704 may include on or more possible future events that would affect the host vehicle 300 based on one or more objects identified from the vehicle sensor data. For example, prediction module 704 may determine one or more possible future events in the traffic scene for one or more of the identified objects based on the vehicle sensor data. In this manner the prediction model may forecast the aggregated possible future events based on scene understanding of the objects in the roadway 200. In some embodiments, the prediction module 704 may use additional data, algorithms, predetermined models, historical data, user data, etc. to generate the vehicle prediction model.

The prediction module 704 may use a prediction domain having one or more prediction parameters to determine the possible future events. For example, a prediction parameter may include a prediction time horizon. The prediction time horizon may define a range of time for the prediction. The prediction time horizon may be the amount of time that the prediction module 704 looks forward. For example, the prediction time horizon may set a six second period forward from the current time for predictions. Alternatively, the prediction time may define the amount of time that the prediction module 704 collects vehicle sensor data in order to make a prediction. For example, the prediction module 704 may look back an amount of time corresponding to prediction time in order to determine one or more possible future events.

Another prediction parameter may be a prediction distance that defines the distance for which the prediction module 704 attempts to make prediction. In one embodiment, the prediction distance may be 500 yards ahead. The prediction module 704 may use vehicle sensor data corresponding to a radial distance corresponding to the prediction distance. Suppose that the prediction distance is 500 yards, the prediction module 704 may use vehicle sensor data corresponding to 500 yard radial distance from the host vehicle 300.

At 606, the decision module 706 determines whether a possible future event of the one or more possible future events satisfy a threshold compliance value. The determination may be based on one more logic methods, such as a set of prioritized rules, a pre-trained neural network (e.g. a deep learning approach, machine learning, etc.), artificial intelligence, etc. for assessing different plausible situations. The logic methods assess the prediction model to determine if the forecasted behavior of the prediction model satisfies a threshold compliance. The threshold compliance value may be adjusted based on the preferred relationship and driving style of each of the host vehicles. The threshold compliance value may define a maximum speed, a minimum distance between the host vehicle and cooperative vehicle or obstacle, define the relationship and any cooperation between the cooperating vehicles, including conditions and parameters for vehicle operation. The threshold compliance value may be sent in the form of specific values, ranges of values, plain text, messages, and signals, among others. In this manner, the decision module 706 determines whether the prediction model is in conflict with one or more compliance thresholds that would make swarm creation inappropriate or if the vehicle can manage the forecasted events without joining a swarm.

Suppose that the host vehicle 300 is the cooperative vehicle 208 in the traffic scenario of the roadway shown in FIG. 2A and the prediction module 704 determines that the cooperative vehicle 208 will approach the preceding cooperative vehicle 220 with a distance of 1.8 meters if the current speed of the cooperative vehicle is maintained. The threshold compliance value may set a minimum distance between vehicles at 2 meters. Accordingly, the decision module 706 may determine that the possible future event of the cooperative vehicle 208 approaching the preceding cooperative vehicle 220 within a distance of 1.8 meters violates the threshold compliance value of 2 meters.

When the decision module 706 determines that the threshold compliance value is not satisfies, the decision module may generate a compliance action that would result in the threshold compliance value being satisfied. Returning to the example from above, the decision module 706 may set the compliance action—reduce speed. Suppose, that the cooperative vehicle 208 is able to reduce its speed in time to avoid violating the threshold compliance value of 2 meters. At 608, the decision module 706 determines that cooperation is not necessitated and accordingly the method 600 would continue to 610 and initiate individual autonomy. Thus, the host vehicle may slow such that the prediction module 704 would not determine that the threshold compliance value of 2 meters would be violated. Conversely, suppose that the cooperative vehicle 208 is not able to reduce its speed in time to avoid violating the threshold compliance value of 2 meters. The decision module 706 may determine that cooperation is necessitated and accordingly the method 600 would continue to 612. At 612, a swarm creation request is triggered.

If the prediction model satisfies the threshold compliance value, the method 600 returns to receiving vehicle sensor data at 602. Therefore, the swarm management framework 100 continues monitoring the traffic scenario using the vehicle sensor data from the host vehicle 300. Conversely, if the prediction model satisfies the threshold compliance value, the method 600 continues to 608. At 608, the decision module 706 determines whether the prediction model may benefit from cooperation with another vehicle. The determination may be based on a threshold benefit relative to the swarm goal. For example, the threshold benefit may be set by the personalization module 708 based on personalization parameters the personalization module 708. Suppose that the swarm goal is to decrease trip time by 10%. The threshold benefit may be set so that a decrease in trip time of 5% is acceptable. Accordingly, a decrease in trip time of 10% would satisfy the 5% threshold benefit.

Although described with respect to a single threshold compliance value, a plurality of threshold compliance values may be used by the decision module 706 to determine whether the one or more possible future events satisfy threshold compliance values.

If the decision module 706 determines that the prediction model would benefit from cooperation, the method 600 continues to 610 and individual autonomy is initiated such that the host vehicle 300 uses its own autonomy control. Conversely, if the decision module 706 determines that the prediction model may benefit from cooperation within at least one other vehicle, the method 600 proceeds to 612 and swarm creation is triggered.

A swarm creation request being triggered may cause a join request being sent from the host vehicle 300 to other cooperating vehicles on the roadway. For example, suppose that the host vehicle 300 is the cooperative vehicle 208 and a join request may be sent to the cooperative vehicles 210, 212, 214, and 216. The swarm creation request may include a swarm goal as set by the cooperative vehicle 208 is the initial member of the swarm or a predetermined swarm goal associated with one more of the other cooperating vehicles. For example, the swarm goal may be to maximize traffic throughput. The swarm creation request may be sent to specific cooperative vehicles based on the vehicle sensor data, swarm goal, etc. Alternatively, the swarm creation request may be indiscriminately broadcast. In another embodiment, the swarm creation request may be provided to a vehicle system or vehicle occupant for approval.

The swarm creation request may include a swarm goal, prerequisites to joining, action parameters, etc. The swarm creation request may include timing and/or a position in the swarm. As one example, the swarm creation request may be received by the processor 408 or a vehicle system of the vehicle systems 404 for approval.

The vehicle system may approve the swarm creation request based on vehicle preferences.

The vehicle preferences are adjusted based on the preferred relationship and driving style of the vehicle or vehicle occupant defined by the personalization module 708 and managed by the personalization module 708. For example, the vehicle preferences may preset situations when a swarm creation request is to be approved. In one embodiment, the vehicle preferences may define the relationship and any swarm activity conducted with the swarm members, including conditions and parameters for the vehicle joining the swarm.

As another example of providing a swarm creation request, the vehicle occupant may receive the swarm creation request for manual approval. To approve the swarm the vehicle occupant may select an input on, for example, the display 430 of the infotainment system 448. The vehicle occupant may also approve the swarm creation request with audible cue (e.g., a vocalization) or visual cue (e.g., gesture), etc. The swarm creation request may be approved or denied if a predetermined amount of time if the vehicle occupant does not take action on the swarm creation request.

The swarm creation request may be sent as a default but bypassed for critical events. For example, a critical event may be a situation that poses a risk to the vehicle, vehicle occupant, or biological being. Additionally or alternatively, a critical event may be an event that is forecasted to have imminent repercussions. The prediction module 704 may identify critical events based on threshold determinations including associated with, for example, a time to collision value, risk assessment, and the vehicle preferences, among others. In response to an identifying a critical event, a swarm creation request may be bypassed and the vehicle may be conscripted into the swarm. In another embodiment, a swarm creation request may be generated in response to determining that the swarm goal is not based on a non-critical event.

In addition to swarm creation requests, non-swarm members may be invited. For example cooperative vehicles that are swarm technology equipped, may be invited to join the swarm on the fly. The swarm management framework may also enable non-swarm members to request to join to an existing swarm based on their assessment of the swarm goal(s) and their own goals. In the latter case, this request should be approved by current swarm members for them to be allowed to join the swarm. Therefore, swarm members may accept a request to create the swarm, send a request to join an existing swarm, or be invited to join the existing swarm.

In addition, non-cooperating entities may participate in swarm creation and management. For example, pedestrians also may initiate the swarm creation request, although they won't be directly part of the swarm. For instance, if a pedestrian wants to take a taxi, he can send a swarm creation request that would increase vehicle throughput in order to make it faster for the taxi to arrive to his location.

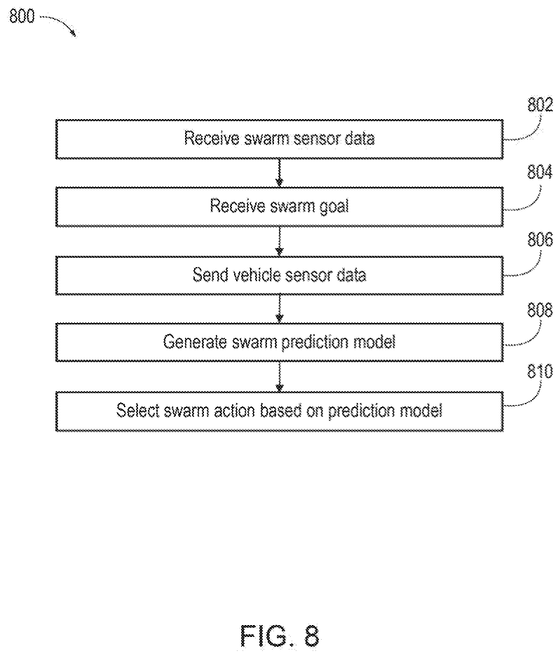

FIG. 8 is a process flow for a swarm management framework will be described with reference to FIGS. 1-5 according to one embodiment. Once a swarm is created, decisions for the members of the swarm are based on the swarm rather than the individual members. For example, at block 802, the sensor fusion module 702 receives proximate sensor data from the members of the swarm and combines the proximate sensor data with the vehicle sensor data to generate swarm sensor data. In particular, the swarm sensor data is vehicle data from the other cooperative vehicles. For example, suppose that the host vehicle 300 is cooperative vehicle 208. Vehicle sensor data collected by cooperative vehicle 216 and received by the cooperative vehicle 208 is swarm sensor data.

At block 804 the sensor fusion module 702 may also receive a swarm goal. At block 806, the method 800 includes the sensor fusion module 702 may also send the vehicle data of the host vehicle 300 to other members of the swarm. In this manner, the members of the swarm that have accepted the swarm creation request exchange the data from their respective vehicle systems and vehicle sensors thereby forming a swarm sensor map.

At block 808, the method 800 includes the prediction module 704 determines vehicle actions based on the swarm sensor data, the vehicle sensor data, and/or the swarm goal. The prediction module 704 may determine vehicle actions based on a prediction model. The prediction model may be generated in a similar manner as described above with respect to FIG. 5. Furthermore, the personalization module 708 may allow members of the swarm to adjust action parameters that affect the vehicle action. For example, the personalization module 708 may have an action parameter that sets the maximum speed that the host vehicle will travel when executing a vehicle action.

At block 810, the method 800 includes the decision module 706 selecting a swarm action based on the prediction module 704. In one embodiment, selecting the swarm action may cause the vehicle systems to initiate the selected swarm action. In another embodiment, the selected swarm action may be sent to the members of the swarm for confirmation before initiating the selected swarm action. Accordingly, the host vehicle may select a swarm action that does not necessarily individually benefit the host vehicle 300 but rather benefits the swarm based on the swarm goal.

### II. Methods for Shared Autonomy Through Cooperative Sensing

The systems and methods discussed herein are generally directed to shared autonomy through cooperative sensing between cooperating vehicles. Shared autonomy occurs when cooperating vehicles participate in cooperative automation. During cooperative automation, a principal vehicle provides a subordinate vehicle with data, functionality, and/or control that allows the subordinate vehicle to function in a manner consistent with a higher level of autonomy than the inherent level of autonomy of the subordinate vehicle. Cooperative automation also occurs when the subordinate vehicle provides the principal vehicle with sensor data, information, and/or remuneration for the principal vehicle's cooperation.

The cooperative sensing allows a vehicle having a higher level of autonomy, the principal vehicle, to extend its sensing capability and path planning ability to a vehicle having a lower level of autonomy, the subordinate vehicle. For example, the principal vehicle may use principal sensor data from its own sensors, as well as subordinate sensor data from the subordinate vehicle to plan a path for the subordinate vehicle. The principal vehicle provides navigation data to the subordinate vehicle, which allows the subordinate vehicle to mimic a higher level of autonomy even though the subordinate vehicle may not have the autonomy level necessary to independently maneuver. Because the decision making is performed by the principal vehicle, during cooperative automation, a vehicle occupant of the subordinate vehicle would perceive that the subordinate vehicle as having a higher level of autonomy than it does. In this manner, subordinate vehicles are able to take advantage of the increased sensing capability and path planning of the principal vehicles.

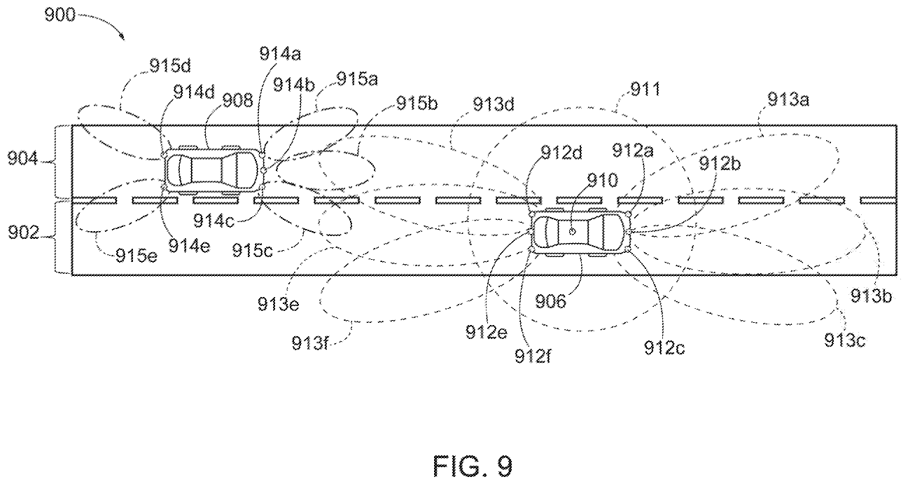

Furthermore, in some embodiments, the principal vehicle is able to leverage the support provided to the subordinate vehicle. For example, the principal vehicle may send the subordinate vehicle business parameters that include a pecuniary arrangement for cooperative automation. In another embodiment, a principal vehicle sharing autonomy with a subordinate vehicle may have access to a restricted lane (e.g., high occupancy vehicle lane, increased speed lane, etc.). Cooperative sensing also enlarges the sensing area of the principal vehicle thereby allowing the principal vehicle to plan more informed and safer paths. Accordingly, both the principal vehicle and the subordinate vehicle can benefit from a cooperative sensing. FIG. 9 is a schematic view of an exemplary traffic scenario on a roadway 900 that will be used to describe shared autonomy through cooperative sensing according to one embodiment. The roadway 900 can be any type of road, highway, freeway, or travel route. In FIG. 9, the roadway 900 includes a first lane 902 and a second lane 904 with vehicles traveling in the same longitudinal direction, however, the roadway 900 can have various configurations not shown in FIG. 9 and can have any number of lanes.

The roadway 900 includes a plurality of vehicles. Here, the vehicles are cooperating vehicles, specifically a principal vehicle 906 and a subordinate vehicle 908. Cooperating vehicles exhibit some level of functioning autonomy, such as parking assist or adaptive cruise control, and are able to engage in computer communication with other vehicles. A cooperating vehicle may be a host vehicle to an operating environment 400 having access, either directly or remotely, to a VCD 402.

The principal vehicle 906 is traveling in the first lane 902 and the subordinate vehicle 908 is traveling in the second lane 904. The principal vehicle 906 and the subordinate vehicle 908 have different levels of autonomy. The levels of autonomy describe a vehicles ability to sense its surroundings and possibly navigate pathways without human intervention. In some embodiments, the levels may be defined by specific features or capabilities that the cooperating vehicle may have, such as a cooperating vehicle's ability to plan a path.

A classic vehicle without sensing capability or decision-making ability may have a null autonomy level meaning that the car has only the most basic sensing ability, such as environmental temperature, and no decision-making ability. Conversely, a vehicle capable of decision making, path planning, and navigation without human intervention may have a full autonomy level. A fully autonomous vehicle may function, for example, as a robotic taxi. In between the null autonomy level and the full autonomy level exist various autonomy levels based on sensing ability and decision-making capability. A vehicle with a lower level of autonomy may have some sensing ability and some minor decision-making capability. For example, a cooperating vehicle having a lower level may use light sensors (e.g., cameras and light detecting and ranging (LiDAR) sensors) for collision alerts. A cooperating vehicle having a higher level of autonomy may be capable of decision making, path planning, and navigation without human intervention, but only within a defined area. These descriptions of levels are exemplary in nature to illustrate that there are differences in the autonomous abilities of different vehicles. More or fewer autonomy levels may be used. Furthermore, the levels may not be discrete such that they include specific functionalities, but rather be more continuous in nature.

Suppose the principal vehicle 906 has the same or a greater level of autonomy than the subordinate vehicle 908. For example, the principal vehicle 906 may be an SAE Level 4 autonomous vehicle and the subordinate vehicle 908 may be an SAE Level 2 autonomous vehicle. The principal vehicle 906 includes at least one sensor for sensing objects and the surrounding environment around the principal vehicle 906. In an exemplary embodiment, the surrounding environment of the principal vehicle 906 may be defined as a predetermined area located around (e.g., ahead, to the side of, behind, above, below) the principal vehicle 906 and includes a road environment in front, to the side, and/or behind of the principal vehicle 906 that may be within the vehicle's path. The at least one sensor may include a light sensor 910 for capturing principal sensor data in a light sensing area 911 and one or more principal image sensors 912a, 912b, 912c, 912d, 912e, and 912f for capturing principal sensor data in corresponding image sensing principal areas 913a, 913b, 913c, 913d, 913e, and 913f.

The light sensor 910 may be used to capture light data in the light sensing area 911. The size of the light sensing area 911 may be defined by the location, range, sensitivity, and/or actuation of the light sensor 910. For example, the light sensor 910 may rotate 360 degrees around the principal vehicle 906 and collect principal sensor data from the light sensing area 911 in sweeps. Conversely, the light sensor 910 may be omnidirectional and collect principal sensor data from all directions of the light sensing area 911 simultaneously. For example, the light sensor 910 may emit one or more laser beams of ultraviolet, visible, or near infrared light in the light sensing area 911 to collect principal sensor data.

The light sensor 910 may be configured to receive one or more reflected laser waves (e.g., signals) that are reflected off one or more objects in the light sensing area 911. In other words, upon transmitting the one or more laser beams through the light sensing area 911, the one or more laser beams may be reflected as laser waves by one or more traffic related objects (e.g., motor vehicles, pedestrians, trees, guardrails, etc.) that are located within the light sensing area 911 and are received back at the light sensor 910.

The one or more principal image sensors 912a, 912b, 912c, 912d, 912e, and 912f may also be positioned around the principal vehicle 906 to capture additional principal sensor data from the corresponding image sensing principal areas 913a, 913b, 913c, 913d, 913e, and 913f. The size of the image sensing principal areas 913a-913f may be defined by the location, range, sensitivity and/or actuation of the one or more principal image sensors 912a-912f.

The one or more principal image sensors 912a-912f may be disposed at external front and/or side portions of the principal vehicle 906, including, but not limited to different portions of the vehicle bumper, vehicle front lighting units, vehicle fenders, and the windshield. The one or more principal image sensors 912a-912f may be positioned on a planar sweep pedestal (not shown) that allows the one or more principal image sensors 912a-912f to be oscillated to capture images of the external environment of the principal vehicle 906 at various angles. Additionally, the one or more principal image sensors 912a-912f may be disposed at internal portions of the principal vehicle 906 including the vehicle dashboard (e.g., dash mounted camera), rear side of a vehicle rear view mirror, etc.

The principal sensor data includes the captured sensor data from the at least one sensor of the principal vehicle 906. In this example, the principal sensor data is captured from the light sensing area 911 and the image sensing principal areas 913a-913f. Therefore, the principal sensor data is from the principal sensor area defined by the light sensing area 911 and the image sensing principal areas 913a-913f.

The subordinate vehicle 908 also includes at least one sensor for sensing objects and the surrounding environment around the subordinate vehicle 908. The surrounding environment of the subordinate vehicle 908 may be defined as a predetermined area located around (e.g., ahead, to the side of, behind, above, below) the subordinate vehicle 908 and includes a road environment in front, to the side, and/or behind of the principal vehicle 906 that may be within the vehicle's path.

The at least one sensor of the subordinate vehicle 908 may include one or more subordinate image sensors 914a, 914b, 914c, 914d, and 914e similar to the one or more principal image sensors 912a-912f and that operate in a similar manner. The one or more subordinate image sensors 914a-914e capture subordinate sensor data from the corresponding image sensing subordinate areas 915a, 915b, 915c, 915d, and 915e. The size of the image sensing subordinate areas 915a-915f may be defined by the location, range, sensitivity and/or actuation of the one or more subordinate image sensors 914a-914f. However, the one or more subordinate image sensors 914a-914e may have less coverage than the one or more principal image sensors 912a-912f. The reduced coverage may be due to a smaller field of view of the individual image sensors or the fewer number of image sensors. Accordingly, the subordinate sensing area of the subordinate vehicle 908 may be smaller than the principal sensing area of the principal vehicle 906. In this example, the subordinate sensor data is captured from the image sensing subordinate areas 915a-915e. Therefore, the subordinate sensor data is from the subordinate sensing area defined by the image sensing subordinate areas 915a-915e.

The principal vehicle 906 uses principal sensor data from the light sensor 910 and the one or more principal image sensors 912a-912f combined with the subordinate sensor data from the one or more subordinate image sensors 914a-914e of the subordinate vehicle 908. The combined sensor data forms a sensor map that includes the principal sensor area and the subordinate sensor area. Thus, here, the sensor map includes the light sensing area 911, the image sensing principal areas 913a-913f, and the image sensing subordinate areas 915a-915e. The sensor map may additionally encompass both the principal vehicle 906 and the subordinate vehicle 908.

The sensor map allows the principal vehicle 906 to analyze the surrounding environment of both the principal vehicle 906 and the subordinate vehicle 908. Thus, the principal vehicle 906 is able to generate a behavior plan that includes actions that accommodate both the principal vehicle 906 and the subordinate vehicle 908 based on the sensor map. For example, the principal vehicle 906 may generate a behavior plan specifically for the subordinate vehicle 908 with individualized actions for the subordinate vehicle 908 to execute even if the principal vehicle does not execute similar actions. By executing the behavior plan provided by the principal vehicle 906, the subordinate vehicle 908 is able to take advantage of the superior decision making of the principal vehicle 906, and thereby the higher autonomy level of the principal vehicle 906. In this manner the principal vehicle 906 shares autonomy with the subordinate vehicle 908 and the subordinate vehicle 908 appears to have a higher autonomy level than the subordinate vehicle 908 inherently has.

The light sensor 910, the one or more principal image sensors 912a-912f, and the one or more subordinate image sensors 914a-914e are shown and described in a specific arrangement as an example to provide clarity. The sensor arrangements of the principal vehicle 906 and the subordinate vehicle 908 may employ more or fewer sensors, sensors of different types, and/or different configurations of sensors not shown in FIG. 9.

Cooperating vehicles, including the principal vehicle 906 and the subordinate vehicle 908, have an operating environment that allows them to share autonomy through cooperative sensing. A host vehicle, as used herein, refers to a cooperating vehicle having the operating environment. Accordingly, either the principal vehicle 906 or the subordinate vehicle 908 can act as a host vehicle with respect to the operating environment 400 shown in FIG. 4. In particular, FIG. 4 is a block diagram of the operating environment 400 for implementing a cooperative sensing system according to an exemplary embodiment.

In such embodiments, the swarm management framework 100 may include addition modules. For example, the target module may include a rendezvous module 1002 and a positioning module 1004.

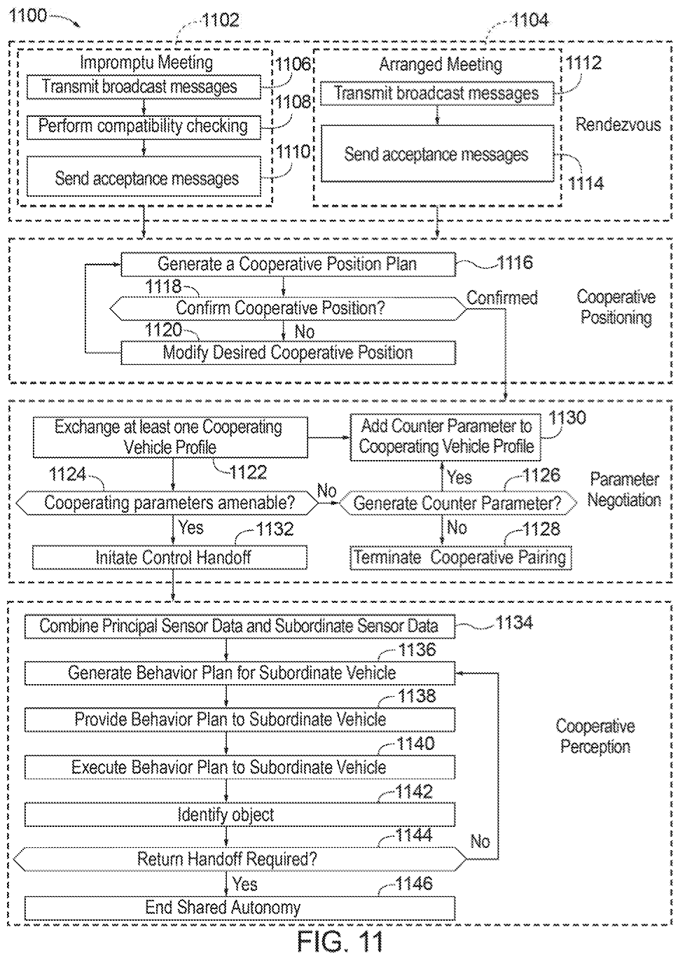

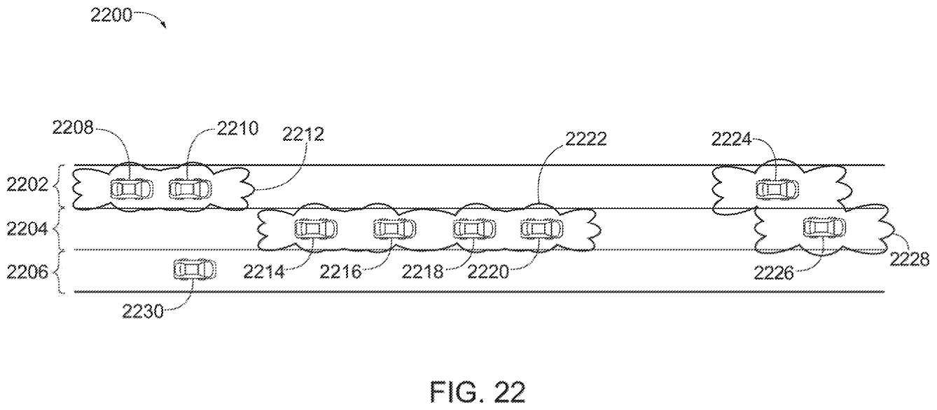

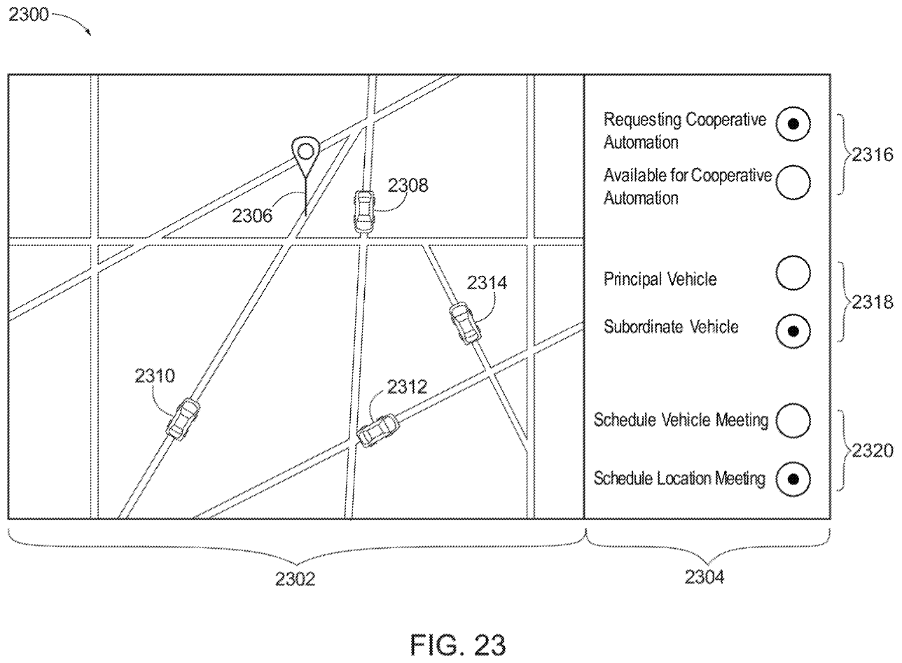

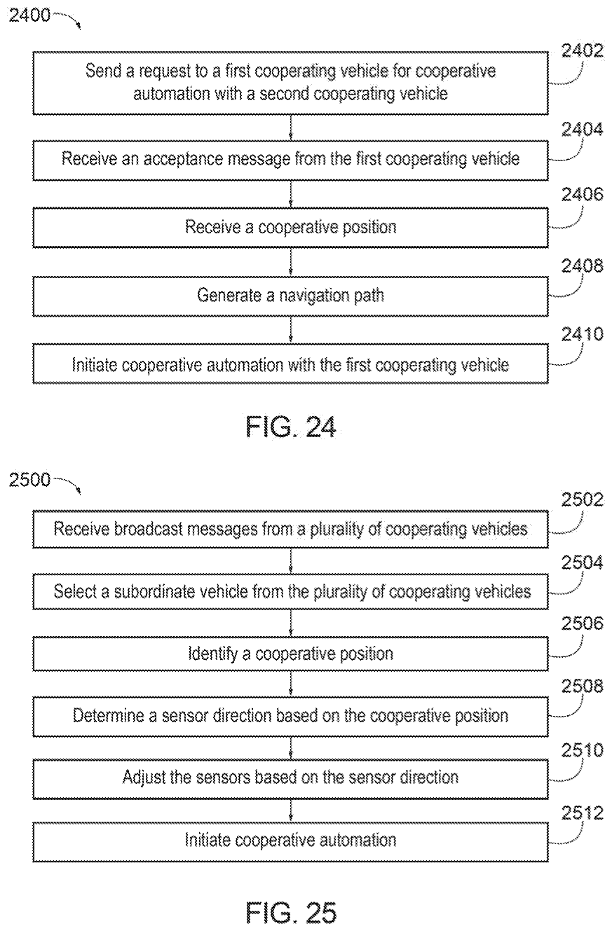

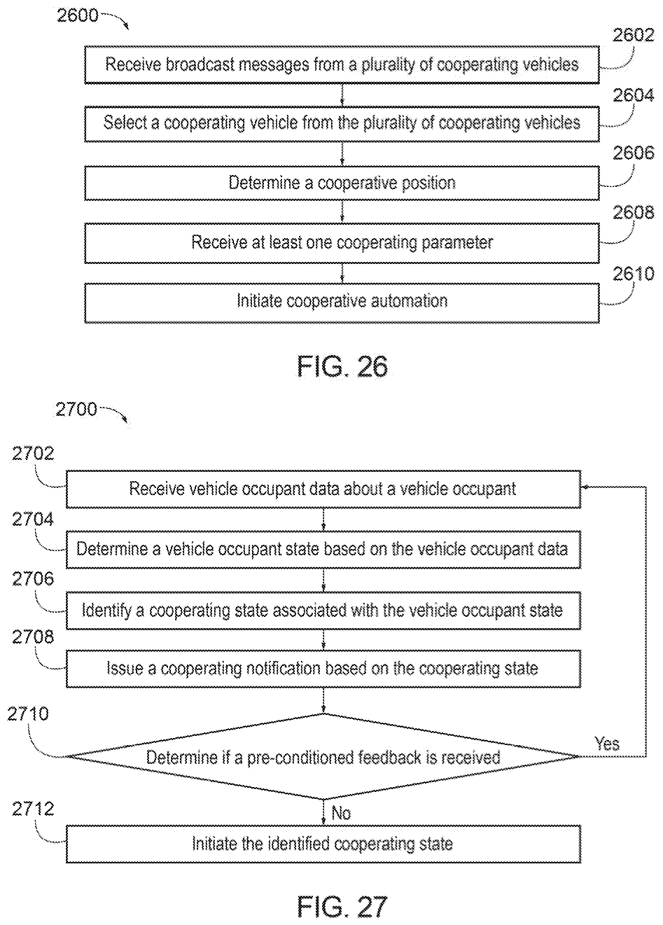

Referring now to FIG. 11, a method 1100 for cooperative sensing will now be described according to an exemplary embodiment. FIG. 11 will also be described with reference to FIGS. 4, 9, and 12-22.

As shown in FIG. 11, the method for shared autonomy through cooperative sensing can be described by four stages, namely, (A) rendezvous, (B) cooperative positioning, (C) parameter negotiation, and (D) cooperative perception. For simplicity, the method 1100 will be described by these stages, but it is understood that the elements of the method 1100 can be organized into different architectures, blocks, stages, and/or processes.

### A. Rendevous

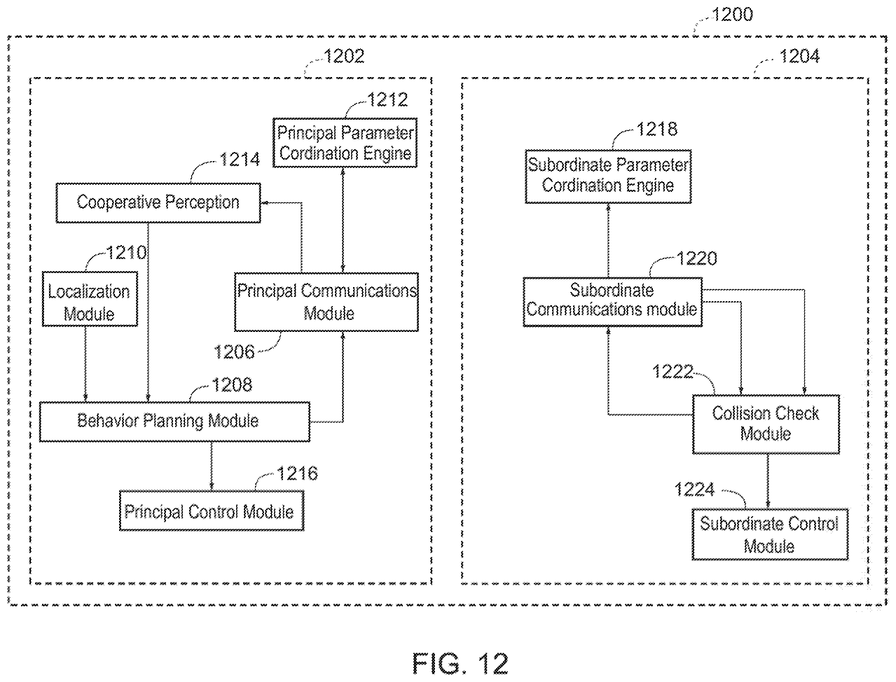

In the rendezvous stage, cooperating vehicles identify one another. The rendezvous processes described below are performed by, coordinated by, and/or facilitated by the rendezvous module 1002 for the cooperating vehicles. The rendezvous module 1002 may additionally utilize other components of the operating environment 400, including vehicle systems 404 and the vehicle sensors 406 as well as the subsystems 1200 shown in FIG. 12.

Returning to FIG. 11, the identification of the cooperating vehicles may be impromptu, shown at the impromptu meeting 1102, or prearranged, shown at the arranged meeting 1104. For example, an impromptu meeting may occur when the cooperating vehicles are traveling in the same direction on a roadway. At block 1106, the cooperating vehicles transmit broadcast messages. For example, the broadcast messages may be sent from the communications module 1206 of the principal vehicle subsystems 1202 to the subordinate communications module 1220 the subordinate vehicle 908 having subordinate vehicle subsystems 1204. The communications modules 1206 and 1220 by utilizing the remote transceiver 432, a wireless network antenna 434, roadside equipment 452, and/or the communication network 420 (e.g., a wireless communication network), or other wireless network connections.

The broadcast messages may include vehicle identifiers and a level of autonomy of the cooperating vehicle. Accordingly, while meeting on the roadway 900 may not be planned, cooperating vehicles can identify one another with broadcast messages. A vehicle identifier may include a unique identifier that allows another cooperating vehicle to identify the broadcasting cooperating vehicle. For example, the vehicle identifier may include location information that indicates a global position of the cooperating vehicle so that a host vehicle can identify a cooperating vehicle based on the relative position of the cooperating vehicle to the host vehicle.

The vehicle identifier may also include a redundant identifier. The redundant identifier may be information about the cooperating vehicle that allows a host vehicle to check the identification of the cooperating vehicle using sensor data. For example, the redundant identifier may be a color of the vehicle. Suppose that the host vehicle identifies a specific cooperating vehicle based on the cooperating vehicle's relative position and the host vehicle receives a redundant identifier indicating that the cooperating vehicle is red. The host vehicle may use an image sensor and image processing to determine the color of the identified vehicle at the vehicle's relative position. If the identified vehicle is blue, the host vehicle may request an updated vehicle identifier. If the identified vehicle is red, the host vehicle confirms the identity of the broadcasting cooperating vehicle. A similar process could be carried out with other redundant identifiers, such as license plate numbers or vehicle type or shape (car, truck, sedan, coupe or hatchback).

As described above, the broadcast message also includes a cooperating vehicle's level of autonomy. The level of autonomy is based on the cooperating vehicle's ability to sense its surroundings and navigate pathways without human intervention. In some embodiments, the levels of autonomy may be based on standardized levels proprietary to cooperating vehicles or defined by a third party, such as the SAE levels of autonomy described above.

In one embodiment, the broadcast messages may include a level of autonomy based on the cooperating vehicle's ability at the time of manufacture. For example, the level of autonomy may be set at the time of manufacture based on the design specification of the cooperating vehicle. Additionally or alternatively, the level of autonomy may reflect the effective ability of the cooperating vehicle at the time of broadcast. For example, while initially the level of autonomy of the cooperating vehicle may be set based on the design specifications, the level of autonomy may be changed if the ability of the cooperating vehicle changes, for example through an accident (decreased functionality) or software update (increased functionality). In some embodiments, the autonomy level may be automatically diagnostically determined and included in the broadcast message.

Suppose that a cooperating vehicle is an SAE Level 4 vehicle, but one or more of the sensors are damaged in an accident. Before the accident, the broadcast message may include an autonomy level that indicates that the cooperating vehicle is an SAE Level 4 vehicle. However, after the accident the cooperating vehicle may run a diagnostic to determine the extent of damage to the vehicle systems 404, the vehicle sensors 406, and\or the subsystems, such as the subsystems 1200 shown in FIG. 12. If a subsystem is damaged resulting in the vehicle having an effective autonomy level of SAE Level 2 after the accident, then the broadcast messages after the accident may automatically indicate that the cooperating vehicle is an SAE Level 2 vehicle without a vehicle occupant intervening.

A broadcast message may also include a cooperating proposal. The cooperating proposal may form a basis for sharing autonomy. For example, the cooperating proposal may include a destination, planned route, preferred pricing, specific cooperating parameters, etc. Thus, the cooperating vehicles may use the cooperating proposal to determine whether there is a minimum threshold advantage to the cooperating vehicles before engaging in cooperative sensing.

The rendezvous module 1002 of a cooperating vehicle may control transmission of the broadcast messages over remote networks by utilizing the remote transceiver 232, a wireless network antenna 234, roadside equipment 452, and/or the communication network 420 (e.g., a wireless communication network), or other wireless network connections. The broadcast messages may be transmitted based on a predetermined schedule (e.g., every second, every 10 seconds, 10 minutes, etc.), proximity to sensed vehicles (e.g., when cooperating vehicles are within 500 yards of the host vehicle), or a hybrid event (e.g., every second when a cooperating vehicle is within a predetermined radius of the host vehicle but 110 seconds when a cooperating vehicle is not within a predetermined radius of the host vehicle), amongst others.

Returning to FIG. 11, at block 1108, the method 1100 includes performing a compatibility check. As described above with respect to FIG. 1, shared autonomy occurs when the principal vehicle 906, having a higher autonomy level provides information to the subordinate vehicle 908 that allows the subordinate vehicle 908 to operate at a higher autonomy level. The difference in the autonomy levels between the principal vehicle 906 and the subordinate vehicle 908 is the differential autonomy. The compatibility check determines whether the principal vehicle 906 and the subordinate vehicle 908 exhibit a predetermined differential autonomy sufficient to allow the principal vehicle 906 to share autonomy with the subordinate vehicle 908.

The differential autonomy may be a specific set of levels for the principal vehicle 906 and the subordinate vehicle 908. For example, the differential autonomy may deem that the principal vehicle 906 should be an SAE Level 4 vehicle and the subordinate vehicle 908 should be at least an SAE Level 2 vehicle. In another embodiment, the differential autonomy may be an autonomy level spread. For example, the differential autonomy may deem that the principal vehicle 906 be at least two autonomy levels higher that the subordinate vehicle 908. Alternatively, the differential autonomy may be defined as the principal vehicle 906 having predetermined features that the subordinate vehicle 908 does not have and/or as the subordinate vehicle 908 not having predetermined features that the principal vehicle 906 has.

The principal vehicle 906 and/or the subordinate vehicle 908 may perform the compatibility check. In some embodiments, the cooperating vehicle that is broadcasting messages for shared autonomy performs the compatibility check. For example, a principal vehicle 906 may indicate that it is available for sharing autonomy in its broadcast messages. The rendezvous module 1002 of a subordinate vehicle 908, interested in shared autonomy, may perform the compatibility check upon receiving a broadcast message from the principal vehicle 906. Alternatively, the principal vehicle 906 may receive a broadcast message from a subordinate vehicle 908 requesting shared autonomy. The rendezvous module 1002 of the principal vehicle 906 may perform the compatibility check upon receiving the broadcast message of the subordinate vehicle 908. Accordingly, the compatibility check may occur in response to a broadcast message being received by a host vehicle. Otherwise, the compatibility check may be performed in response to a response message from the cooperating vehicle that received the broadcast message.

Additionally, at block 1108, the compatibility check may include determining whether the principal vehicle 906 and/or the subordinate vehicle 908 meet system and/or sensor requirements for cooperative sensing. The system and/or sensor requirements may be based on the cooperating vehicles autonomy level. For example, a Level 4 cooperating vehicle may be required to have a requisite number of sensors with a predetermined field of view. Accordingly, the principal vehicle 906 and/or the subordinate vehicle 908 may be declined cooperative sensing on the basis of system and/or sensor requirements.

The compatibility check may also include determining whether the routes of the principal vehicle 906 and the subordinate vehicle 908 are compatible based on the cooperating proposal including a shared destination, planned route, etc. For example, suppose the subordinate vehicle 908 is broadcasting broadcast messages requesting cooperative autonomy. The broadcast message from the subordinate vehicle 908 may include a planned route that the subordinate vehicle 908 plans to travel to a desired destination.

Upon receiving the broadcast message, the principal vehicle 906 may determine if the principal vehicle 906 also plans to travel along the planned route of the subordinate vehicle 908. For example, the rendezvous module 1002 of the principal vehicle 906 may compare the planned route to navigation data from the navigation system 446. If the principal vehicle 906 does plan to travel the planned route of the subordinate vehicle 908, the route planning portion of the compatibility check, at block 1108, may be deemed successful.

Conversely, if the principal vehicle 906 does not plan to travel the planned route, the compatibility check may still be deemed successful if the principal vehicle 906 plans to travel at least a portion of the planned route, even if not through to the desired destination. Here, the principal vehicle 906 may schedule a handoff at the point when the planned route of the subordinate vehicle 908 diverges from the planned route of the principal vehicle 906. For example, the principal vehicle may set a geofence at the point of divergence. The geofence, which will be described in greater detail with respect to FIG. 11 below, is an intangible boundary defined by coordinates such as global positioning satellite (GPS) coordinates or radio-frequency identification (RFID) coordinates. Here, the geofence may be defined at the divergence point as the location at which cooperative sensing or vehicle-to-vehicle control is scheduled to end. In this manner, the compatibility check, at block 1108, may be deemed successful given a specified geofence.

Alternatively, if the principal vehicle 906 plans to travel at least a portion of the planned route of the subordinate vehicle 908, the principal vehicle 906 may provisionally determine that the compatibility check is successful with regard to the portion of the planned route that both the principal vehicle 906 and the subordinate vehicle 908 plan to travel. Likewise, the principal vehicle 906 may provisionally determine that the compatibility check is successful if the principal vehicle 906 is also traveling to the desired destination of the subordinate vehicle 908. The provisional determination may be revisited at the parameter negotiation stage, discussed below, to determine if the principal vehicle 906 or the subordinate vehicle 908 are willing to negotiate the planned route or the desired destination. Accordingly, in some embodiments, the rendezvous stage is a preliminary determination of whether cooperative sensing would provide the cooperating vehicles at least a minimal benefit.

While described above with respect to a broadcast message sent by the subordinate vehicle 908, the principal vehicle 906 may additionally or alternatively broadcast messages indicating that the principal vehicle is available for cooperative sensing given a planned route and/or a desired destination. Accordingly, during the compatibility check, at block 1108, the subordinate vehicle 908 may determine whether the planned route and/or desired destination of the principal vehicle 906 are at least partially compatible with the planned route of the subordinate vehicle 908.

At block 1110, the method 1100 includes sending an acceptance message to initiate cooperative autonomy. The acceptance message may be sent by the rendezvous module 1002 when the host vehicle performs a successful compatibility check. For example, suppose the principal vehicle 906 transmits a broadcast message indicating that it is available for sharing autonomy, and a subordinate vehicle 908 performs the compatibility check upon receiving a broadcast message from the principal vehicle 906. The subordinate vehicle 908 may send an acceptance message and enter a shared autonomy mode. In the shared autonomy, a cooperating vehicle performs, coordinates, or facilitates sharing of autonomy between the cooperating vehicles. For example, a cooperating vehicle may share sensor data, decision-making capability, behavior plans, actions, etc.

The subordinate vehicle 908 may send an acceptance messages indicating that the subordinate vehicle 908 is entering a shared autonomy mode and recommending that the principal vehicle 906 enter a shared autonomy mode. Likewise, suppose that the principal vehicle 906 received a broadcast message from a subordinate vehicle 908 requesting shared autonomy and the principal vehicle performed a successful compatibility check. The principal vehicle 906 may send an acceptance message indicating that the principal vehicle 906 is entering a shared autonomy mode and recommending that the subordinate vehicle 908 enter a shared autonomy mode.

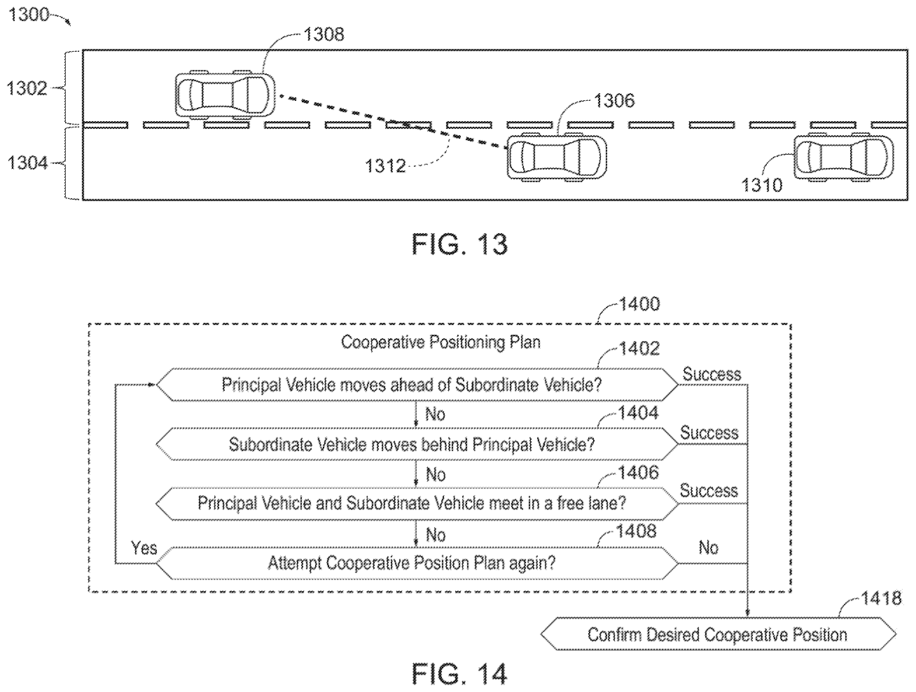

In some embodiments, multiple principal vehicles and or multiple subordinate vehicles may be looking to be paired. Referring to FIG. 13, a number of cooperating and non-cooperating vehicles may share the roadway 1300 having a first lane 1302 and a second lane 1304. The cooperating vehicles may have varying levels of autonomy facilitated by an ability to communicate with other vehicles. Conversely, non-cooperating vehicles may not have autonomy (e.g., SAE Level 0) or be unable to communicate with other vehicles. Here, the cooperating vehicles may include a principal vehicle 1306 and subordinate vehicles 1308 and 1310.

Principal vehicles and subordinate vehicles may be identified from the cooperating vehicles based on one or more autonomy factors. An autonomy factor may be whether a cooperating vehicle is available for cooperative sensing and thus is broadcasting that it will act like a principal vehicle or whether a cooperating vehicle is requesting cooperative sensing and thus is broadcasting that it will act as a subordinate vehicle. Autonomy factors may also include a cooperating vehicle's autonomy level, historical actions acting as a principal vehicle 906 or a subordinate vehicle 908, and/or other vehicle information. The rendezvous module 1002 of a host vehicle may determine whether another cooperating vehicle is a principal vehicle 906 or subordinate vehicle 908 based on information from received broadcast messages. Thus, the broadcast messages may include autonomy factors.

Turning to FIG. 13, suppose that the cooperating vehicles include a principal vehicle 1306 broadcasting in broadcast messages that it is available for cooperative sensing and subordinate vehicles 1308 and 1310 are both requesting increased autonomy. The principal vehicle 1306 may select either subordinate vehicle 1308 or 1310 based on autonomy factors including autonomy levels of the subordinate vehicles 1308 and 1310, the autonomy differential between each of the subordinate vehicles 1308 and 1310 and the principal vehicle 1306, sensor capability of subordinate vehicles 1308 and 1310 (e.g., number of sensors, sensor range, type of sensors, etc.), amongst others. The autonomy factors may be included in broadcast messages sent by the subordinate vehicle 1308 or 1310, calculable by the rendezvous module 1002 of the principal vehicle 1306, or requested by the principal vehicle 1306 from the subordinate vehicles 1308 and 1310. Accordingly, the principal vehicle 1306 may select between the subordinate vehicles 1308 and 1310 based on the autonomy factors.

In one embodiment, the autonomy factors may include preferred pricing. The preferred pricing indicates the pricing that vehicle occupants of principal vehicles, such as a principal vehicle 1306, wish to be paid or the pricing that subordinate vehicles, such as subordinate vehicles 1308 and 1310, wish to pay for cooperative sensing. For example, the broadcast messages from the subordinate vehicles 1308 and 1310 may include preferred pricing for cooperative sensing. The rendezvous module 1002 of the principal vehicle 1306 may receive the preferred pricing from the subordinate vehicles 1308 and 1310 and select either the subordinate vehicle 1308 or the subordinate vehicle 1310 based on which preferred pricing more closely approaches the preferred pricing of the principal vehicle 1306 or a combination of autonomy factors including the preferred pricing. The preferred pricing may be additionally addressed by business parameters. For example, may determine if the preferred pricing is in within an acceptable range. If so, an exact price can be determined in parameter negotiation using the business parameters. Accordingly, determining the remuneration for cooperative autonomy can be determined over multiple stages.

In another embodiment, the principal vehicle 1306 may select both the subordinate vehicle 1308 and 1310 based on the autonomy factors. For example, the rendezvous module 1002 of the principal vehicle 1306 may determine that the subordinate vehicles 1308 and 1310 have adequate sensor coverage to encompass each of the principal vehicle 1306 and the subordinate vehicle 1308 or 1310 in a cooperative position. As will be discussed in greater detail below, the cooperative position is a physical arrangement of the principal vehicles 1306 and the subordinate vehicle 1308 or 1310. Accordingly, the principal vehicle 1306 may select both the subordinate vehicles 1308 and 1310. Selecting both the subordinate vehicles 1308 and 1310 may be dependent on a contingent cooperative position. For example, the contingent cooperative position may include a subordinate vehicle on either end of the principal vehicle such that the subordinate vehicles 1308 and 1310 can take advantage of the sensors of the principal vehicle 1306.

The selection of the subordinate vehicle 1308 and/or 1310 may be communicated to the subordinate vehicle 1308 and/or 1310 in the acceptance message. The acceptance being conditional may also be sent in an acceptance message with the contingency, such as the contingent cooperative position and/or cooperating parameters.

Blocks 1106, 1108, and 1110 describe an impromptu meeting 1102 of cooperating vehicles. Alternatively, at block 1112, the method 1100 includes scheduling a prearranged meeting between cooperating vehicles at 1104. Vehicle occupants may be able to schedule shared autonomy through the host vehicle, such as through a display 450, or through a portable device 454. For example, a vehicle occupant may be able to schedule shared autonomy by indicating a location and time for the principal vehicle 906 and the subordinate vehicle 908 to meet. This may be done well in advance of a meeting or while a host vehicle is traveling.

In another embodiment, shared autonomy may be scheduled based on a navigated path of the cooperating vehicles. For example, cooperating vehicles may choose to make navigational data available to other cooperative vehicles. The navigational data may be made available through a remote server 436 such as remote data 442 or sent from the navigation system 446 of the host vehicle. A vehicle occupant, of a host vehicle, requesting shared autonomy or announcing availability for shared autonomy may be alerted when a corresponding cooperating vehicle having or desiring shared autonomy shares the navigated path of the host vehicle.

Moreover, the host vehicle may provide additional navigational data to facilitate a meeting with a cooperating vehicle. For example, the navigation system 446 may adjust the navigational path of the host vehicle to bring the host vehicle within a predetermined proximity of a cooperating vehicle. The predetermined proximity may be a radial distance from the cooperating vehicle. The adjustment to the navigational path may be based on a threshold detour. The threshold detour indicates the amount distance that a vehicle occupant is willing to deviate from the navigated path or additional time that the vehicle occupant is willing to add to the estimated time of arrival in order to meet a cooperating vehicle.

At block 1114, the method 1100 includes sending an acceptance message. Scheduling a prearranged meeting 1104 may incorporate a compatibility check, and the acceptance message may be sent when the cooperating vehicles are within the predetermined proximity to one another. The acceptance message indicates that the host vehicle is entering a shared autonomy mode and recommends that the cooperating vehicle also enter a shared autonomy mode.

In one embodiment, a rendezvous with one subordinate vehicle may be an impromptu meeting 1102 and the rendezvous with a second subordinate vehicle may be a prearranged meeting 1104. For example, the principal vehicle 1306 may plan to meet a first subordinate vehicle, such as the subordinate vehicle 1308, and meet a second subordinate vehicle, such as the subordinate vehicle 1310 in an impromptu meeting. The second subordinate vehicle may be met at the same time as the first subordinate vehicle or after the principal vehicle 1306 and a subordinate vehicle have already cooperatively paired.

The rendezvous stage describes the interactions between cooperating vehicles to initiate cooperative sensing, for example, by entering a shared autonomy mode. Once the shared autonomy mode is initiated the cooperating vehicles enter the cooperative positioning stage and the parameter negotiation stage. The cooperative positioning stage may occur first or the parameter negotiation stage may occur first. Alternatively, the cooperative positioning stage and the parameter negotiation stage may occur simultaneously. In the rendezvous stage, and possibly also the cooperative positioning stage and/or the parameter negotiation stage, it is determined whether cooperative sensing would provide a minimum threshold advantage to the cooperating vehicles.

### B. Cooperative Positioning

To engage in cooperative sensing, including shared autonomy, the cooperating vehicles are arranged in a cooperative position. The cooperative position defines a physical arrangement of the cooperating vehicles. The cooperative position may be a physical arrangement that facilitates cooperative sensing by facilitating computer communication, sharing sensor data, etc. For example, with respect to FIG. 13, the principal vehicle 1306 and the one or more subordinate vehicles, such as the subordinate vehicle 1308, arrange themselves in the cooperative position.

The cooperative positioning processes described below are performed, coordinated, or facilitated by the positioning module 1004 for cooperative vehicles. The positioning module 1004 may additionally utilize other components of the operating environment 400, including vehicle systems 404 and the vehicle sensors 406 as well as the subsystems 1200 shown in FIG. 12.

FIG. 12 illustrates example subsystems 1200 of cooperating vehicles. The subsystems 1200 may be implemented with the VCD 402 and/or the vehicle systems 404 shown in FIG. 2. In one embodiment, the subsystems 1200 can be implemented with the cooperating vehicle, for example, as part of a telematics unit, a head unit, an infotainment unit, an electronic control unit, an on-board unit, or as part of a specific vehicle control system, among others. In other embodiments, the subsystems 1200 can be implemented remotely from a cooperating vehicle, for example, with a portable device 454, a remote device (not shown), or the remote server 236, connected via the communication network 420 or the wireless network antenna 234.

The subsystems 1200 included in the cooperating vehicle may be based on the autonomy level of the cooperating vehicle. To better illustrate the possible differences in the subsystems 1200, suppose the cooperating vehicles are the principal vehicle 1306 (shown in FIG. 13) having principal vehicle subsystems 1202 and the subordinate vehicle 1308 (shown in FIG. 13) having subordinate vehicle subsystems 1204. The differences illustrated are merely exemplary in nature. One or more of the subsystems 1200 described with respect to the principal vehicle subsystems 1202 may be a component of the subordinate vehicle subsystems 1204 and vice versa.

The positioning module 1004 may utilize the subsystems 1200 to achieve the cooperative position. With regard to the example discussed with respect to FIG. 13, suppose that the principal vehicle 1306 and the subordinate vehicle 1308 have participated in the rendezvous stage and the principal vehicle 1306 sends a position message to the subordinate vehicle 1308 with the desired cooperative position. For example, the position message may be sent from the communications module 1206 of the principal vehicle subsystems 1202 to the subordinate communications module 1220 the subordinate vehicle 908 having subordinate vehicle subsystems 1204. The communications modules 1206 and 1220 by utilizing the remote transceiver 232, a wireless network antenna 234, roadside equipment 452, and/or the communication network 420 (e.g., a wireless communication network), or other wireless network connections.

The desired cooperative position may be a predetermined default cooperative position. For example, the default cooperative position may be the principal vehicle 1306 immediately ahead of the subordinate vehicle 1308. The principal vehicle 1306 is in the second lane 1304, longitudinally ahead of the subordinate vehicle 1308 in the first lane 1302. The desired cooperative position may be modified from the default cooperative position based on sensor data, data from behavior planning module 1208, data from the vehicle systems 404, etc. For example, the behavior planning module 1208 may determine a cooperative position plan 1400 based on the relative position of the principal vehicle 1306 and the subordinate vehicle 1308 as determined by the localization module 1210.

Returning to FIG. 11, at block 1116, the method 1100 includes generating a cooperative position plan 1400, as shown in FIG. 14. For example, the positioning module 1004 may utilize the behavior planning module 1208 to determine a number of actions that will result in the cooperating vehicles being arranged in the default cooperative position. The vehicle systems 404, principal vehicle subsystems 1202, and/or vehicle sensors 406 determine if the action of the cooperative positing in plan are appropriate given the current traffic flow, roadway conditions, etc. Accordingly, in addition to sending the desired cooperative position, the host vehicle may additionally send the cooperative position plan 1400.

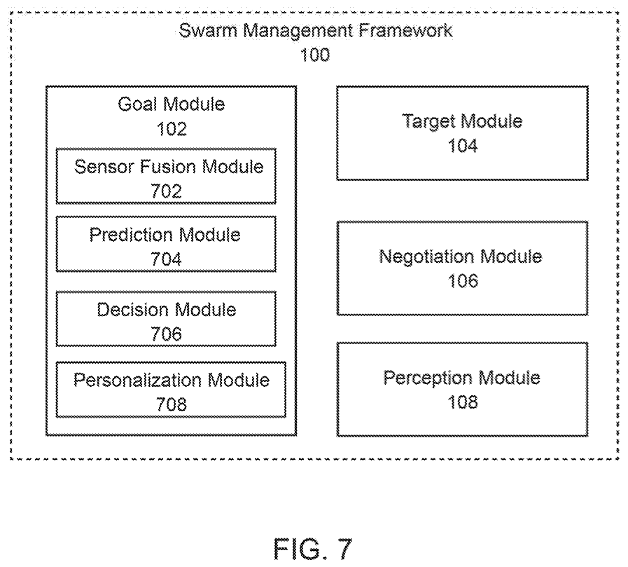

An example cooperative position plan 1400 is illustrated in FIG. 14. The cooperative position plan 1400 will be described with respect to FIGS. 11, 12, 13, and 7. In one embodiment, the cooperative position plan 1400 includes a number actions for a cooperating vehicle to achieve the cooperative position. In another embodiment, as will described below, the cooperative position plan 1400 may include a default cooperative position and a number of alternate cooperative positions. For example, the cooperative position plan may include a first position and a second position that may be selected when a cooperating vehicle is unable to assume the first position. The cooperative position plan 1400 is exemplary in nature so the actions may be different in substance or in number. The behavior planning module 1208 may generate the cooperative position plan 1400 based on the cooperative position. For example, the cooperative position plan 1400 may include a number of actions that when executed by the cooperating vehicles, such as the principal vehicle 1306 and/or the subordinate vehicle 1308, cause the cooperating vehicles to be arranged in the cooperative position.

The actions described with respect to the cooperative position plan 1400 may correspond to messages between the principal vehicle 1306 and the subordinate vehicle 1308 for communicating the cooperative position plan 1400. Accordingly, in addition to longitudinal and lateral movements, the actions may include other kinematic parameters such as trajectory, speed, etc. to achieve the actions.

Suppose the principal vehicle 1306 and the subordinate vehicle 1308 are a cooperating pair. At block 1402, the cooperative position plan 1400 includes an action step in which the principal vehicle 1306 moves ahead of the subordinate vehicle 1308 in the first lane 1302. As discussed above, in FIG. 13 the principal vehicle 1306 is in the second lane 1304 and the subordinate vehicle 1308 is in the first lane 1302. Therefore, while the principal vehicle 1306 is ahead of the subordinate vehicle 1308, the principal vehicle 1306 is separated from the subordinate vehicle 1308 by the cross-lane line 1312. Accordingly, the action described at block 1402 dictates that the principal vehicle 1306 to change lanes in front of the subordinate vehicle 1308 as illustrated by the in-lane line 1502 of FIG. 7.

Suppose the principal vehicle 1306 generates the cooperative position plan 1400. The cooperative position plan 1400 may include kinematic parameters for the principal vehicle 1306. For example, in generating the cooperative position plan 1400, the behavior planning module 1208 additionally calculates the kinematic parameters needed to execute the action. For example, here, the kinematic parameters for the principal vehicle 1306 to move ahead of the subordinate vehicle 1308 may include increasing the speed of the principal vehicle 1306, trajectory (angle, lateral distance, longitudinal distance) for the principal vehicle 1306, etc.

Additionally, the principal vehicle 1306 may send the actions of the cooperative position plan 1400 to the subordinate vehicle 1308. The actions, such as the action at block 1402, may include kinematic parameters for the subordinate vehicle 1308. For example, the kinematic parameters for the subordinate vehicle 1308 may include decreasing the speed of the subordinate vehicle 1308 to increase the gap length at a potential lane change location. Accordingly, the cooperative position plan 1400 may vary based on the intended recipient of the cooperative position plan 1400.

In one embodiment, the behavior planning module 1208 sends a message to the subordinate communications module 1220 of the subordinate vehicle 1308 through the communications module 1206 of the principal vehicle 1306. In another embodiment, the action is transmitted to a collision check module 1222. The collision check module 1222 receives information from the vehicle system 404 and the vehicle sensors 406 to determine if the action is feasible for the subordinate vehicle 1308. If so, the action may be sent to the subordinate control module 1224 for execution.

If the action at block 1402 is successful, the cooperative position plan 1400 is complete and the cooperative positioning stage moves to block 1118 of the method 1100, shown in FIG. 11, to confirm that the desired cooperative position has been achieved. Conversely, if the principal vehicle 1306 is unable to move ahead of the subordinate vehicle 1308 in the first lane 1302, the cooperative position plan 1400 moves to the next action at block 1404.

At block 1404, the cooperative position plan 1400 includes the subordinate vehicle 1308 moving behind the principal vehicle 1306 in the second lane 1304. For example, subordinate vehicle 1308 may be an SAE Level 2 vehicle that can perform a lane change based on the position message received from the principal vehicle 1306. In another embodiment, the position message may prompt a driver of the subordinate vehicle 1308 to execute a lane change.

If the action at block 1404 is successful, the cooperative position plan 1400 is complete. Conversely, if the subordinate vehicle 1308 is unable to move behind the principal vehicle 1306 in the second lane 1304, the cooperative position plan 1400 moves to the next action at block 1406. At the block 1406, the cooperative position plan 1400 includes an action step in which the principal vehicle 1306 and the subordinate vehicle 1308 meet in a free lane. If this action is successful, the cooperative position plan 1400 is complete and the cooperative positioning stage moves to block 1118 of the method 1100, shown in FIG. 11. Conversely, if the principal vehicle 1306 is unable to meet the subordinate vehicle 1308, the cooperative position plan 1400 moves to the next action at block 1408.

At block 1408 it is determined whether the cooperative position plan 1400 should be attempted again. In some embodiments, the cooperative position plan 1400 may be attempted again based on information from the vehicle systems 404 and the vehicle sensors 406. For example, suppose there is a vehicle (not shown) making multiple lane changes around the principal vehicle 1306 and the subordinate vehicle 1308. If vehicle sensor data from the vehicle sensors 406 indicates that the lane-changing vehicle has passed the principal vehicle 1306 and the subordinate vehicle 1308, then the cooperative position plan 1400 may be attempted again. In other embodiments, the cooperative position plan 1400 may be attempted a predetermined number of times. Accordingly, determining whether the cooperative position plan 1400 should be attempted again may be based on dynamic incoming data or be preset.

If it is determined that the cooperative position plan 1400 will be attempted again, the cooperative position plan 1400 returns to the action at block 1116 to initiate the cooperative position plan 1400. If it is determined that the cooperative position plan 1400 will not be attempted again, the cooperative positioning stage moves to the block 1118 of the method 1100 shown in FIG. 11. As discussed above, at block 1118, it is determined whether the desired cooperative position has been achieved. The determination may be based on sensor data from the principal vehicle 1306 and/or the subordinate vehicle 1308. For example, suppose the desired cooperative position is a default position in which the principal vehicle 1306 is positioned immediately ahead of the subordinate vehicle 1308. The principal vehicle 1306 may use rear sensors to determine if the subordinate vehicle 1308 is directly behind the principal vehicle 1306. Alternatively, the principal vehicle 1306 and/or the subordinate vehicle 1308 may communicate with one another to determine whether the default cooperative position has been achieved.

If at block 1118, the desired cooperative position is confirmed, the method 1100 moves on to a next stage, such as the parameter negotiation stage. If instead at block 1118, the desired cooperative position is not confirmed, the method 1100 continues to block 1120 of the method 1100. At block 1120, the desired cooperative position is modified. As discussed above, the current desired cooperative position may be modified based on sensor data, data from behavior planning module 1208, etc. to generate a modified cooperative position.

The positioning module 1004 may reassess the vehicle sensor data to determine if the current relative position of the principal vehicle 1306 and the subordinate vehicle 1308 are better suited to a different cooperative position. Therefore, the modified cooperative position may be based on dynamic incoming data. Alternatively, the modified cooperative position may be predetermined. For example, a series of modified cooperative positions may be iteratively tried until the principal vehicle 1306 and the subordinate vehicle 1308 achieve a cooperative position.

In some embodiments, modifying the desired cooperative position may include the positioning module 1004 deferring to the rendezvous module 1002 to reassess the pairing of the principal vehicle 1306 and the subordinate vehicle 1308. For example, the principal vehicle 1306 may select a different subordinate vehicle, such as subordinate vehicle 1310. Accordingly, modifying the desired cooperative position may include changing the cooperating vehicles involved.

When the cooperative position plan 1400 returns to block 1116, a cooperative position plan is generated based on the modified cooperative position. Because the behavior planning module 1208 may determine a cooperative position plan 1400 for the modified cooperative position based on the relative position of the principal vehicle 1306 and the subordinate vehicle 1308 which are changing as the vehicles proceed along the roadway, the regenerated cooperative position plan 1400 may be different than the initially generated cooperative position plan 1400.

### C. Parameter Negotiation

As discussed above, once the cooperative sensing is initiated in response to the rendezvous stage being completed, the cooperating vehicles also enter the cooperative positioning stage and the parameter negotiation stage. The parameter negotiation processes described below are performed, coordinated, or facilitated by the negotiation module 106 for cooperative vehicles. The negotiation module 106 may additionally utilize other components of the operating environment 400, including vehicle systems 404 and the vehicle sensors 406 as well as the subsystems 1200 shown in FIG. 12.

In the parameter negotiation stage, the cooperating vehicles are able to adjust cooperating parameters. The cooperating parameters are adjusted based on the preferred relationship and driving style of each of the cooperating vehicles. Cooperating parameters define the relationship and any cooperation between the cooperating vehicles, including conditions and parameters for sharing autonomy. The cooperating parameters may be sent in the form of specific values, ranges of values, plain text, messages, and signals, among others.

Returning to FIG. 11 and the method 1100, at block 1122, at least one cooperating vehicle profile is exchanged. A cooperating vehicle profile aggregates at least one cooperating parameter for that cooperating vehicle. With reference to FIG. 8, the principal vehicle 1306 may have a principal profile 1602 (represented as an arrow) and/or the subordinate vehicle 1308 may have a subordinate profile 1604 (represented as an arrow). The principal vehicle 1306 may send the principal profile 1602 the subordinate vehicle 1308. Additionally or alternatively, the subordinate vehicle 1308 may send the subordinate profile 1604 to the principal vehicle 1306. Alternatively, in some embodiments, rather than sending a cooperating vehicle profile, a cooperating vehicle may send one or more cooperating parameters individually.

The cooperating vehicle profiles may be managed by subsystems 1200 of FIG. 12. In particular, the principal profile 1602 may be managed by the principal parameter coordination engine 1212 and the subordinate profile 1604 may be maintained by a subordinate parameter coordination engine 1218. For example, the principal parameter coordination engine 1212 may aggregate, maintain, and update cooperating parameters in the principal profile 1602 for the principal vehicle 1306. Likewise, the subordinate parameter coordination engine 1218 may aggregate, maintain, and update cooperating parameters in the subordinate profile 1604 for the subordinate vehicle 1308.

Returning, to FIG. 11, at block 1124, it is determined whether the cooperating parameters are amenable. As described above, the principal vehicle 1306 and the subordinate vehicle 1308 receive the other cooperating vehicle's profile and determine if the cooperating parameters defined by the other cooperating vehicle are agreeable. The determination may be made by comparing the cooperating parameters received from the other cooperating vehicle to the vehicle's own listing of cooperating parameters. Additionally or alternatively, the cooperating parameters received from the other cooperating vehicle may be compared to safety guidelines, vehicle capabilities, etc. before determining whether the cooperating parameters are amenable.

The cooperating vehicles, including the principal vehicle 1306 and the subordinate vehicle 1308, exchange cooperating parameters to determine the manner in which the cooperative sensing will be performed by the cooperating vehicles. Suppose a cooperating parameter is sent from the subordinate vehicle 1308 to the principal vehicle 1306 in a subordinate profile 1604, and that the cooperating parameter is a desired speed of the subordinate vehicle 1308, such as 65 miles per hour (mph). The principal vehicle 1306 may have a safety guideline that dictates that the principal vehicle 1306 will not exceed a posted speed limit. Suppose the speed limit of the first lane 1302 is 60 mph. Additionally or alternatively, the cooperating parameters of the principal vehicle 1306 may include a range of traveling speeds, such as a range of 55 mph to 65 mph. In this example, the desired traveling speed in the cooperating parameter of the subordinate vehicle 1308, 65 mph, is within the range of traveling speeds, the range of 55 mph to 65 mph. However, the desired traveling speed in the cooperating parameter of the subordinate vehicle 1308, 65 mph, exceeds the safety guideline, because the posted speed limit is 60 mph. Accordingly, the desired traveling speed in the cooperating parameter of the subordinate vehicle 1308 is not amenable to participating in cooperative sensing with the principal vehicle 1306.

If at block 1124, one or more of the cooperating vehicles do not find the cooperating parameters amenable, then the method 1100 continues to block 1126. At block 1126, the one or more cooperating vehicles that did not find the cooperating parameters amenable, attempt to generate a counter parameter. A counter parameter is a cooperating parameter that proposes an adjustment to a cooperating parameter. The counter parameter may be selected from a range of alternative values provided with a cooperating parameter. For example, rather than sending a single desired speed of 65 mph, the subordinate vehicle 1308, the subordinate vehicle 1308 may include a desired speed range, such as 60 mph to 65 mph. Accordingly, the principal vehicle 1306 may select 60 mph from the desired speed range as a counter parameter to satisfy both the cooperating parameters and safety guidelines of the principal vehicle 1306. Thus, the cooperating parameters and counter parameters can be discrete values, ranges, thresholds, etc.

In another embodiment, a vehicle occupant may be prompted to confirm the cooperating parameters are amenable with a negotiation alert. The negotiation alert may be an audio cue, visual cue, hybrid cue, etc. generated through an audio system (not shown) or a display 450 of the vehicle systems 404. The vehicle occupant of the principal vehicle 1306 may be alerted that the subordinate profile 1604 includes a desired speed of 65 mph, which exceeds the posted speed limit. The negotiation alert may prompt the vehicle occupant to accept the desired speed of the subordinate vehicle 1308 (i.e., the cooperating parameter is amenable). The negotiation alert may also provide the vehicle occupant an opportunity to provide a counter parameter. In this manner, the vehicle occupant may manually input the counter parameter, at block 1126, such that the vehicle occupant is able to take an active role in the parameter negotiation.

Alternatively, the negotiation module 106 may generate a counter parameter, at block 1126, based on the proposed cooperating parameter of the subordinate vehicle. For example, the negotiation module 106 may determine that the desired traveling speed in the cooperating parameter of the subordinate vehicle 1308, 65 mph, is greater than the posted speed limit of 60 mph. Because the posted speed limit, 60 mph is the highest speed in the range of traveling speeds, the range of 55 mph to 65 mph that the principal vehicle will travel, the negotiation module 106 may calculate the counter parameter to be 60 mph and send the calculated counter parameter to the subordinate vehicle 1308.

Counter parameters may be based on cooperating vehicle profile, historical data in a similar scenario, the type of vehicle that the cooperating vehicle (e.g., recreational vehicle, sedan, truck, all-terrain vehicle, etc., type of roadway (e.g., state highway, residential street, off-road area, etc.). The counter parameter may be used to tailor the cooperating proposal to the cooperative scenario based on past and current data. For example, the negotiation module 106 may determine that the desired traveling speed in the cooperating parameter of the subordinate vehicle 1308, exceeds a safety threshold based on historical data for a given roadway on the planned route. Accordingly, the negotiation module 106 may calculate the counter parameter with a lower traveling speed and send the calculated counter parameter to the subordinate vehicle 1308.

In some embodiments, a counter parameter may not be able to be generated at block 1126. For example, a cooperating vehicle may not be able to calculate counter parameters based on other cooperating parameters or safety guidelines. Alternatively, the counter parameter may not be generated due to another cooperating vehicle indicating that it is unwilling to negotiate. If a counter parameter cannot be generated, the method 1100 continues to block 1128.

At block 1128, the shared autonomy mode established in the rendezvous stage is terminated. Terminating the shared autonomy mode severs the cooperative sensing between the cooperating vehicles for a current instance. However, it may not a bar to future cooperative pairings between the cooperating vehicles. In some embodiments, terminating the shared autonomy mode may cause a cooperating vehicle to reenter the rendezvous stage in an attempt to identify other cooperating vehicles. So that the cooperating vehicles do not enter into a loop of initiating and terminating a shared autonomy mode, once a shared autonomy mode is terminated, the cooperating vehicles involved may be temporarily barred from re-initiating the shared autonomy mode for a predetermined amount of time and/or mileage.

If a counter parameter is generated at 1126, the method 1100 continues to block 1130. At block 1130, the counter parameter is added to the cooperating vehicle profile. For example, suppose the principal vehicle 1306 generates a counter parameter. The counter parameter is added to the principal profile 1602 by the principal parameter coordination engine 1212. In some embodiments, the principal parameter coordination engine 1212 may add the counter parameter to the principal profile 1602 by updating an existing cooperating parameter with the counter parameter.

The method 1100 then returns to block 1122. The counter parameter is sent to the other cooperating vehicles when the cooperating vehicle profiles are exchanged at block 1122. For example, the counter parameter being generated may prompt the negotiation module 106 to resend the vehicle profile. In this manner, the other cooperating vehicles can assess the counter parameter at block 1124. If the counter parameter is not amenable, the negotiation cycle begins again, and at block 1126 a new counter parameter may be generated by the other cooperating vehicles and again the vehicle profiles are resent.

Once each of the cooperating vehicles in the cooperative pairing determine that the cooperating parameters are amenable at block 1124, the method 1100 continues to block 1132. At block 1132, a control handoff is initiated in the shared autonomy mode. The control handoff occurs when a cooperating vehicle hands off control to another cooperating vehicle. For example, the principal vehicle 1306 begins sharing autonomy with the subordinate vehicle 1308 by providing the subordinate vehicle 1308 with data, functionality, and/or control to function in a manner consistent with a higher level of autonomy than the inherent level of autonomy of the subordinate vehicle 1308. Initiating the control handoff may be performed negotiation module 106 without intervention by a vehicle occupant of either the principal vehicle 1306 or the subordinate vehicle 1308. Accordingly, the negotiation stage as well as the rendezvous stage and the cooperative positioning stage may happen in a way that is transparent to the vehicle occupant and appear to be automatic. In some embodiments, the control handoff may be initiated before the cooperating vehicles have reached the cooperative position. In another embodiment, the control handoff may be delayed until the cooperating vehicles assume the cooperative position.

In one embodiment, initiating the control handoff may include alerting a vehicle occupant of the principal vehicle 1306 and/or a vehicle occupant of the subordinate vehicle 1308 with a handoff alert. The handoff alert may prompt the vehicle occupant to confirm the autonomy sharing. Thus, the vehicle occupant may have an opportunity to approve the autonomy sharing before the principal vehicle 1306 provides the subordinate vehicle 1308 with data, functionality, and/or control.

Turning back to the types of cooperating parameters, the cooperating parameters include categories of parameters, such as business parameters, kinematic parameters and relative parameters, which will be discussed in greater detail below. The listed categories are not exhaustive of the types of cooperating parameters, and more or fewer categories may be employed. The grouping of different categories of the cooperating parameters is given for organizational clarity of the cooperating parameters. However, the VCD 402, the vehicle systems 404, vehicle sensors 406, and/or negotiation module 106 may not recognize categorical differences between the cooperating parameters.

In some embodiments, categories of parameters may be recognized and the cooperating vehicles may even prioritize categories. By prioritizing categories of cooperating parameters, cooperating vehicles may identify the cooperating parameters based on importance. For example, cooperating parameters in a first category of cooperating parameters may have a higher priority than a second category of cooperating parameters. By prioritizing the categories of cooperating parameters, the cooperating vehicles may indicate the categories of cooperating parameters that it is less likely to negotiate (e.g., categories of cooperating parameters that have a high priority) as compared to those that the cooperating vehicle is more likely to negotiate (e.g., categories of cooperating parameters that have a lower priority).

### 1. Business Parameter

The cooperating vehicles establish remuneration for cooperative sensing. For example, the principal vehicle 1306 and subordinate vehicle 1308 may establish a pecuniary arrangement. For example, the subordinate vehicle 1308 may pay the principal vehicle 1306 for sharing autonomy with the subordinate vehicle 1308. Accordingly, the subordinate vehicle 1308 may pay for cooperative sensing. Additionally or alternatively, the principal vehicle 1306 may provide the subordinate vehicle 1308 with data such as navigation data or principal sensor data that the subordinate vehicle 1308 can use to make limited decisions. The subordinate vehicle 1308 may pay for that data.

As discussed above, the business parameter may be considered at the rendezvous stage. In the parameter negotiation stage the business parameters may be negotiated. The business parameter may describe the details of the pecuniary arrangement. In the example given above, the business parameters may describe how the subordinate vehicle 1308 will pay the principal vehicle 1306 for cooperative sensing. For example, the business parameters may include the rates of payments (e.g. an amount of payment per time (e.g., minute, hour, etc.), amount of payment per distance (e.g., mile, kilometer, etc.), flat rate, etc.), payment details, how payment is made (e.g., credit card, through a vehicle payment system, payment applications, etc.), when the payment will be made including whether a deposit is required, how a receipt is received, among others.

Suppose the principal profile 1602 has cooperating parameters that include at least one business parameter, for example, that a subordinate vehicle 1308 will be charged $0.10 per mile during cooperative sensing. With respect to the parameter negotiation stage described in the method 1100, at 1122 the business parameter is sent by the principal vehicle 1306 to the subordinate vehicle 1308 in the principal profile 1602.

As discussed above, the cooperating vehicles involved in the exchange of vehicle profiles at block 1122, at block 1124 the cooperating vehicles determine whether the cooperating parameters are amenable. Suppose the subordinate vehicle 1308 has a vehicle profile that defines a preferred pricing with a maximum of $0.08. Accordingly, the subordinate vehicle 1308 may object to being charged $0.10 per mile during cooperative sensing. Accordingly, the subordinate vehicle 1308 may generate a counter parameter in response to the business parameter, in accordance with block 1126. For example, the subordinate vehicle 1308 may counter with a counter parameter, for example, $0.05 per mile. If approved by the principal vehicle 1306, the principal vehicle 1306 may initiate a handoff. Alternatively, the principal vehicle 1306 could suggest a further counter parameter, such as charging the subordinate vehicle 1308 a rate of $0.07 per mile. The principal vehicle 1306 could also choose to end negotiations by terminating the shared autonomy mode and thus the cooperative pairing at block 1128.

As another example, the business parameter may be based on a group affiliation. For example, one or more of the cooperating vehicles, or a vehicle occupant thereof, may be associated with a group that augments the business parameter. The group may be a subscription service, loyalty program, membership service, industry group, preferred group, undesirable group, or other group that collectively affects the pecuniary arrangement between the cooperating vehicles. For example, a preferred group may have predetermined business parameters (e.g., reduced payment rates, reduced deposit, etc.), preferred cooperating vehicles, and pre-negotiated parameters, among others.

As on example, suppose that the subordinate vehicle 1308 has a vehicle profile that indicates that the subordinate vehicle 1308 is associated with the group. The subordinate vehicle 1308 may include this information in the broadcast message (e.g., block 1106 or block 1112) or send affiliation information for the group as a counter parameter in response to receiving the business parameter, in accordance with block 1126. Based on the affiliation with the group, the principal vehicle 1306 may suggest a counter parameter, such as reduced payment, extend negotiations beyond a threshold, access pre-negotiated business parameters which may be specific to the group, or extend other benefits. Alternatively, the principal vehicle 1306 may suggest deterrents such as increased pricing or distances based on the affiliation of the subordinate vehicle 1308.

The negotiation module 106 of the host vehicles, here the principal vehicle 1306 and the subordinate vehicle 1308, may negotiate a pecuniary arrangement. As discussed above, the negotiation performed by the negotiation module 106 may be based on the vehicle profiles and the vehicle occupant may not intervene. Accordingly, the whole process may be transparent to the vehicle occupant. Alternatively, the vehicle occupant may participate in the negotiation.

### 2. Kinematic Parameter

Kinematic parameters are cooperating parameters that describe a preferred style of driving as it pertains to the kinematic operation of the principal vehicle 1306 and/or the subordinate vehicle 1308. For example, the kinematic parameters may include a destination, preferred travel route, acceptance of routes with toll roads, desired average travel speed, maximum travel speed, minimum travel speed, and preferred lane, amongst others.

The kinematic parameters may also include parameters for specific maneuvers. For example, a lane change maneuver may have specific kinematic parameters that describe the instances when a lane change would be deemed appropriate, such as when traveling at or near the minimum travel speed due to a preceding vehicle moving slowly, encountering an obstacle in the roadway, sensing an emergency vehicle, etc. The lane change maneuver may also be associated with kinematic parameters that describe the physical boundaries of the lane change, such as the desired gap length between a preceding vehicle (not shown) and a following vehicle (not shown) or the number of lanes that can be laterally traversed in a lane change maneuver.

By way of example, suppose a kinematic parameter defines a range of minimum speeds or minimum speed threshold that when satisfied, prompt a request for a lane change. Whether the lane change request is made to or from the subordinate vehicle 1308 depends on whether the kinematic parameter is received from the principal vehicle 1306 or the subordinate vehicle 1308. For example, if the subordinate profile 1604 includes the kinematic parameter then the subordinate vehicle 1308 may request that the principal vehicle 1306 change lanes when the minimum speed threshold is satisfied. Conversely, if the principal profile 1602 includes the kinematic parameter then the principal vehicle 1306 may inform the subordinate vehicle 1308 that a lane change is imminent.

An additional kinematic parameter may require that permission from subordinate vehicle 1308 be received before a lane change is attempted. For example, when the minimum speed threshold is satisfied, the principal vehicle 1306 may request a lane change before attempting the lane change maneuver. Thus, the kinematic parameters allow the vehicle occupant to control how their vehicle is driven such that another cooperating vehicle is not able to cause their vehicle to behave in a manner that is antithetical to the vehicle occupants' driving habits or styles. Accordingly, by defining how the cooperating vehicle can be driven in the vehicle profile with kinematic parameters, the vehicle occupant maintains their desired driving experience.

### 3. Relative Parameter

Relative parameters are cooperating parameters that describe the relationship between the cooperating vehicles sharing autonomy. For example, the relative parameters may define a preferred following distance between the principal vehicle 1306 and the subordinate vehicle 1308. A relative parameter may also define the operation of signaling devices (e.g., turn signals, blind spot indicators) mounted on various locations of the vehicle, for example, front, side, rear, the top of the vehicle, the side mirrors, among others. For example, the principal vehicle 1306 may control a turn signal control system (not shown) of the subordinate vehicle 1308 for controlling lighting (e.g., head lights, flood lights, brake lights, signaling lights, etc.), such that during cooperative sensing the principal vehicle 1306 can illuminate lights on the subordinate vehicle 1308.

The relative parameter may include adaptive cruise control (ACC) parameters. The ACC parameters may be used by the principal vehicle 1306 to control the subordinate vehicle 1308. For example, the ACC parameters may be used to control acceleration and/or deceleration by generating an acceleration control rate and/or modifying a current acceleration control rate (e.g., a target acceleration rate). Likewise, the ACC parameters may control the manner in which the subordinate vehicle 1308 adjusts speed, velocity, yaw rate, steering angle, throttle angle, range or distance data, among others. The ACC parameters may also include status information about different vehicle systems the subordinate vehicle 1308, such as turn signal status, course heading data, course history data, projected course data, kinematic data, current vehicle position data, and any other vehicle information about the subordinate vehicle. The ACC parameters may also include parameters related to cooperative adaptive cruise control (C-ACC), intelligent cruise control systems, autonomous driving systems, driver-assist systems, lane departure warning systems, merge assist systems, freeway merging, exiting, and lane-change systems, collision warning systems, integrated vehicle-based safety systems, and automatic guided vehicle systems.

The ACC parameters may be negotiated based on a preferred driving style of the principal vehicle 1306 or the subordinate vehicle 1308. For example, the principal vehicle 1306 may have an ACC parameter that indicates the subordinate vehicle 1308 should accelerate at a predetermined acceleration rate. The subordinate vehicle 1308, however, may have an ACC parameter indicative of a slower acceleration rate. In some embodiments the principal vehicle 1306 and the subordinate vehicle 1308 may negotiate a difference acceleration rate. Alternatively, the principal vehicle 1306 may support the slower acceleration rate of the subordinate vehicle as long as the subordinate vehicle stays in a predetermined sensor range of the principal vehicle 1306. Accordingly, the ACC parameters can be negotiated to determine how the principal vehicle 1306 and subordinate vehicle 1308 will operate relative to one another.

The relative parameters may also identify the types of vehicles that can be a principal vehicle 1306 or subordinate vehicle 1308. For example, a subordinate vehicle 1308 may have a relative parameter indicating that only vehicles that have not been involved in an accident for a predetermined amount of time can act as a principal vehicle 1306. The communications modules 1206 and/or 1220 may access vehicle histories and/or vehicle occupant records by accessing remote data 442 on the remote server linked to law enforcement or insurance agencies. Additionally or alternatively, a relative parameter may be associated with a vehicle occupant. For example, a subordinate vehicle 1308 may have a relative parameter indicating that only vehicles registered to a vehicle occupant with a clean driving record can act as a principal vehicle. Accordingly, the relative parameters may be used to ensure or reassure vehicle occupant safety.

While for clarity, the categories of the cooperating parameters have been described in insular examples, different types of cooperating parameters can be combined. For example, suppose a relative parameter of the subordinate profile 1604 indicated that the subordinate vehicle 1308 should maintain a following distance of 50 feet in order to make use of the rear sensors of the principal vehicle 1306 rather than employ the rear sensors of the subordinate vehicle 1308.

The principal profile 1602 may prefer a following distance of 100 feet. In this situation, the principal vehicle 1306 may send a counter parameter that the following distance of 50 feet is acceptable if the subordinate vehicle 1308 accepts a business parameter, that a $0.03 per mile be applied to any rate already being charged to the subordinate vehicle 1308. Accordingly, the categories of cooperating parameters are not exclusive and may be used in combination including conditional dependence.

While the cooperating parameters have been described with respect to parameter negotiation, one or more of the cooperating parameters may be used to select a cooperating vehicle. For example, the broadcast messages described with respect to the rendezvous stage may include one or more of the cooperating parameters. For example, the principal vehicle 1306 may broadcast that the principal vehicle 1306 is available for cooperative sensing given a specific business parameter, such as at predetermined principal price per mile. Likewise, the subordinate vehicles 1308 and 1310 may broadcast a request for cooperative sensing at predetermined subordinate prices per mile. Accordingly, the principal vehicle 1306 can select either the subordinate vehicle 1308 or the subordinate vehicle 1310 based on the business parameter, here, how much the subordinate vehicles 1308 and 1310 are willing to pay for cooperative sensing.

The cooperating vehicles may additionally engage in a preliminary negotiation in the rendezvous stage when a cooperating proposal is included in the broadcast messages, as discussed above. A preliminary negotiation may occur in a similar manner as described above with respect to negotiation in the parameter negotiation stage. For example, the cooperating vehicles may communicate with one or more of principal and subordinate profiles, counter parameters, vehicle occupant input, etc. Accordingly, the cooperating parameters can be adjusted by one or more of the cooperating vehicles in the rendezvous stage. In this manner, the cooperating parameters can be used during the rendezvous stage for selection of one or more cooperating vehicles.

In addition to being used at the rendezvous stage for selection purposes, the cooperating parameters may additionally be used at the parameter negotiation stage for customization. As described above, the cooperating parameters define the relationship and any cooperation between the cooperating vehicles, including conditions and parameters for sharing autonomy. Accordingly, one or more of the initial cooperating parameters may be shared at the rendezvous stage for selection of one or more cooperating vehicle and other cooperating parameters may be negotiated at the parameter negotiation stage to customize cooperative sensing experience based on vehicle occupant preferences using, for example, the cooperating vehicle profiles.

As an example of the cooperating parameters exhibiting conditional dependence in the rendezvous stage, the principal vehicle 1306 may select the subordinate vehicle 1308 from the plurality of cooperating vehicles. The principal vehicle 1306 may also include the pecuniary arrangement with the subordinate vehicle 1308 based on the destination of the plurality of cooperating vehicles. Suppose, the principal vehicle 1306 has a business parameter that indicates a minimum compensation for cooperative sensing. The principal vehicle 1306 may broadcast the principal vehicle's destination and indicate that the principal vehicle will tow for a shorter distance than that indicated by the principal vehicle's destination if the minimum compensation is satisfied.

Additionally, the conditional dependence in the rendezvous stage may be based on a cooperating vehicle profile. For example, a subordinate vehicle 1308 may have to agree to a pecuniary arrangement and have a cooperating vehicle profile with cooperating parameters indicative of a desired driving style. Suppose the travel route traverses a busy roadway, the principal vehicle 1306 may select a subordinate vehicle 1308 with cooperating vehicle profile that is similar to the cooperating vehicle profile of the principal vehicle 1306. Therefore, the selection of the subordinate vehicle 1308 may be based on the type of roadway to be traversed, cooperating vehicle profiles, and/or specific cooperating parameters, such as the business parameters, being satisfied.

### D. Cooperative Perception

As discussed above, once the control handoff is initiated, the cooperating vehicles enter the cooperative perception stage. The cooperative perception processes described below are performed by, coordinated by, or facilitated by the perception module 108 of cooperative vehicles. The perception module 108 may additionally utilize other components of the operating environment 400, including vehicle systems 404 and the vehicle sensors 406 as well as the subsystems 1200 shown in FIG. 12. For example, the principal vehicle subsystems 1202 may include a cooperative perception module 1214.

During the cooperative perception stage, the cooperating vehicles participate in cooperative sensing such that the cooperating vehicles may share sensor data from one or more of the sensors, such as the forward, side, or rearward sensors, of a cooperating vehicle. Accordingly, the cooperating vehicles can share their perception of their environment using sensor data. Furthermore, one cooperating vehicle may exert control over another cooperating vehicle. For example, the cooperating vehicle may provide another cooperating vehicle a behavior plan, as will be discussed below. In this manner the perception and/or behavior of the cooperating vehicles becomes interdependent.

The cooperative perception stage begins at block 1134 of the method 1100. At block 1134 the principal vehicle 1306 combines principal sensor data with subordinate sensor data. With respect to FIG. 9, the principal sensor data sensor data from the sensors of the principal vehicle 1306 including the vehicle sensors 406 such as a light sensor 910 and the one or more principal image sensors 912a, 912b, 912c, 912d, 912e, and 912f that operate in a similar manner as the light sensor 910 and the one or more principal image sensors 912a, 912b, 912c, 912d, 912e, and 912f as described with respect to FIG. 9.

The light sensor 910 may be used to capture light data in the light sensing area 911. The size of the light sensing area 1711 may be defined by the location, range, sensitivity, and/or actuation of the light sensor 1710. The one or more principal image sensors 1712a, 1712b, 1712c, 1712d, 1712e, and 1712f may be used to capture image sensing data in corresponding image sensing areas 1713a, 1713b, 1713c, 1713d, 1713e, and 1713f. Accordingly, the principal sensor data of the principal vehicle 1306 may include the light sensing data from the light sensing area 1711 and the image sensing data from the image sensing areas 1713a-1713f. The principal sensor data may also include data from the vehicle systems 404 of the principal vehicle 1306, such as a cruise control system (not shown) or navigation system 446, which can provide kinematic data such as speed and trajectory. Likewise, the principal sensor data may include information from the principal vehicle subsystems 1202, shown in FIG. 12.

The subordinate sensor data includes sensor data from the vehicle sensors on the subordinate vehicle 1308 including the one or more subordinate image sensors 1714a, 1714b, 1714c, 1714d and 1714e that operate in a similar manner as the subordinate image sensors 914a, 914b, 914c, 914d and 914e described with respect to FIG. 9. The subordinate sensor data may also include data from vehicle systems 404 or subordinate vehicle subsystems 1204 of the subordinate vehicle 1308. In this example, the subordinate sensor data is captured using the one or more subordinate image sensors 1714a, 1714b, 1714c, and 1714d from the image sensing subordinate areas 1715a-1715e. Therefore, the subordinate sensor data is from the subordinate sensing area defined by the image sensing subordinate areas 1715a-1715e.

The principal sensor data is combined with the subordinate sensor data using the perception module 108, shown in FIG. 2, as wells as the principal vehicle subsystems 1202, shown in FIG. 12. For example, the cooperative perception module 1214 receives principal sensor data from the vehicle systems 404 and vehicle sensors 406. Accordingly, the subsystems 1200 may be integrated with the vehicle sensors 406.

The subordinate sensor data may be sent through the subordinate vehicle subsystems 1204. For example, the subordinate sensor data is sent through the subordinate communications module 1220 to the principal communications module 1206. The cooperative perception module 1214 receives the subordinate sensor data from the principal communications module 1206. The cooperative perception module 1214 aggregates the principal sensor data and the subordinate sensor data to generate the combined sensor data. The combined sensor data may include a sensor map of an area surrounding the paired cooperative vehicles such as the principal vehicle 1306 and the subordinate vehicle 1308.

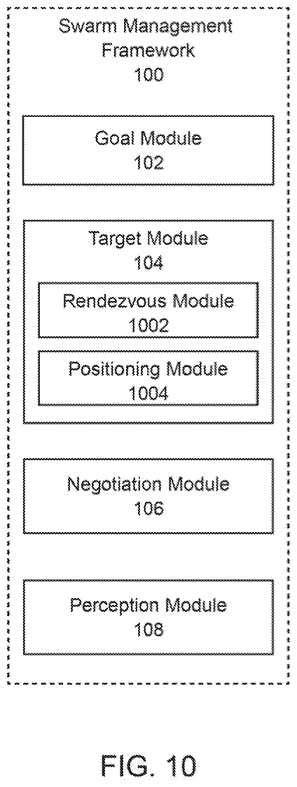

FIG. 10 is a schematic view of an exemplary traffic scenario on a roadway having vehicles engaging in cooperative sensing to generate a sensor map according to one embodiment. The sensor map 11302 is based on the sensor footprint of the combined sensor areas, including the light sensing area 1711 and the image sensing areas 1713a-1713f of the principal vehicle 1306 and the image sensing subordinate areas 1715a-1715e of the subordinate vehicle 1308. For example, the size of the sensor map 1802 may be based on the combined ranges of the sensors of the principal vehicle 1306 and the subordinate vehicle 1308. The sensor map 1802 may also be based on the sensor footprint of the principal vehicle 1306 and the subordinate vehicle 1308 given a threshold sensitivity of the sensors. For example, an underperforming sensor may not contribute to the sensor map 1802. In some embodiments, not all sensors may be continuously actuated. For example, the light sensor 1710 of the principal vehicle 1306 may have a 110-degree field of view that rotates about the principal vehicle 1306. Accordingly, the sensor map may be dynamic based on how the sensors are calibrated and/or actuated.

In some embodiments, the principal vehicle 1306 may control the sensors of the principal vehicle 1306 and the subordinate vehicle 1308 to capture sensor data for specific areas of the sensor map 1802. For example, the principal vehicle 1306 may control actuation of subordinate sensors (e.g., triggering the activation of sensors) of the subordinate vehicle 1308 and control transmission of sensor data to the principal vehicle 1306 using a communication network 420. The synchronized actuation of the sensors and the synchronized transmission of sensor data allows the cooperating vehicles to synergistically share relevant sensor information that each vehicle alone may not be able to acquire and/or process.

The sensor map 1802 uses both the principal vehicle 1306 and the subordinate vehicle 1308 to encompass the combined vehicle area 1804 of the principal vehicle 1306 and the subordinate vehicle 1308. Accordingly, the combined vehicle area 1804 can be considered a single aggregate vehicle formed by the cooperating vehicles, here the principal vehicle 1306 and the subordinate vehicle 1308.

Returning to FIG. 11, at block 1136 the method 1100 includes generating a behavior plan for the subordinate vehicle 1308 based on the sensor map 1802. For example, the perception module 108 may generate the behavior plan. In particular, the principal vehicle 1306 utilizes its increased decision-making ability to make decisions for itself as well the subordinate vehicle 1308. For example, the behavior planning module 1208 uses information from the localization module 1210 and the combined sensor data from the cooperative perception module 1214 to generate the behavior plan. In some embodiments, the cooperating parameters may define a destination. The perception module 108 may use the vehicle systems 404 such as the navigation system 446 to plan a route. The actions of the behavior plan may include the directions necessary to travel the planned route. Likewise, the perception module 108 may use the vehicle sensors 406 to navigate the roadway, such as maneuvering through traffic. Additionally, at 1136 the behavior plan may be executed by principal control module 1216. The principal control module 1216 may access the vehicle systems 404, such as the navigation system 446 and the steering system to control the principal vehicle 1306.

Like the cooperative position plan 1400 shown in FIG. 14, the behavior plan includes one or more actions for navigating a roadway. The actions may correspond to messages between the principal vehicle 1306 and the subordinate vehicle 1308. The actions may include longitudinal movements, lateral movements, trajectory, speed, etc. to achieve the actions. For example, the actions may result in a subordinate vehicle 1308 being directed to mirror the maneuvers of the principal vehicle 1306. The behavior plan may include spatial or temporal offsets. The spatial and temporal offsets indicate a specific location or time at which an action is to occur. For example, a spatial and/or temporal offset may be used so that the subordinate vehicle maneuvers before, simultaneously, or after the principal vehicle 1306 maneuvers. In another example, a first action may be set to happen at a first time and a second action, if necessary, may be set to happen at a second time using a temporal offset. In this manner, it may appear that the subordinate vehicle 1308 is acting independently of the principal vehicle 1306.

At block 1138, the behavior plan is provided to the subordinate vehicle 1308. For example, the perception module 108 can transmit the subordinate vehicle 1308 through the communication network 420 or using the transceiver 430 and the remote transceiver 432. The behavior plan may be received at a subordinate control module 1224 for execution. The subordinate control module 1224 may access the vehicle systems 404, such as the navigation system 446 and the steering system to control the subordinate vehicle 1308.

In some embodiments, the behavior plan may be reviewed by the collision check module 1222. Here, the collision check module 1222 receives information from the vehicle system 404 and the vehicle sensors 406 to determine if the actions from the behavior plan are feasible for the subordinate vehicle 1308. For example, the collision check module 1222 may determine if an action, like a lane change, is possible or should be prevented for some reason, such as an obstacle in the roadway.

Once received, the subordinate vehicle 1308 executes the behavior plan at block 1140. Because the behavior plan may be executed according to offsets, the subordinate vehicle 1308 may delay any maneuvers. Executing the behavior plan may result in the subordinate vehicle 1308 acting with a higher level of autonomy than the subordinate vehicle 1308 is intrinsically capable of.

At block 1142, an obstacle is identified. The obstacle may be any manner of object in the roadway. FIG. 19 illustrates a roadway 1900 having obstacles including a geofence 1902 and an object 1904 in a path according to one embodiment. The geofence 1902 is an intangible boundary defined by coordinates such as global positioning satellite (GPS) coordinates or radio-frequency identification (RFID) coordinates. As discussed above, the geofence 1902 identifies a boundary at which shared autonomy, such as cooperative sensing or vehicle-to-vehicle control, is not permitted or scheduled to end. The geofence 1902 may be placed for a safety. For example, the geofence 1902 may be defined if the region beyond is not safe to travel autonomously. Alternatively, the geofence 1902 may be defined due to local legal requirements, zoning laws, terrain concerns, weather conditions, cooperating vehicle limitations, etc.

The geofence 1902 may be known obstacle. For example, the navigation system 446 may receive and/or store data about the geofence 1902. Suppose the navigation system 446 plans a route, the navigational data may include information about the geofence 1902. Alternatively, the coordinates of the geofence 1902 may be received from a remote vehicle 418, such as the cooperating vehicle 218, processed by a remote processor 438 stored on the remote memory 440 or stored on the remote server 436, as remote data 442 and received over the communications interface 444 over the communication network 420 or the wireless network antenna 434. In another embodiment, the geofence coordinates may be received from roadside equipment 452.

The object 1904 may be any obstacle including pedestrians crossing the roadway, other vehicles, animals, debris, potholes, roadway conditions, etc. The combined sensor data including the principal sensor data and the subordinate sensor data may be used to identify the object 1904. Additionally, the vehicle systems 404 or subsystems 1200 may be used to identify the obstacle as an object 1904.

At block 1144, it is determined whether a return handoff is required. Whether a return handoff is required may be based the type of obstacle, cooperating parameters, and/or a combination thereof. For example, encountering the geofence 1902 may require a return handoff. However, the object 1904 may not necessarily require a return handoff. Instead, a relationship parameter may indicate that if the object 1904 is within 50 yards of the cooperating vehicle leading in the cooperation position then return handoff is required. Otherwise the return handoff may be based on the ability of the principal vehicle 1306 to generate a behavior plan to navigate around the object 1904 regardless of the location of the principal vehicle 1306 in the cooperative position. If a return handoff is not required at block 1144, the method 1100 returns to 1136 and a behavior plan is generated. Thus, as discussed above, the behavior plan can incorporate sensed changes to the roadway such as the object 1904. In this manner, behavior plans may be continually updated since the vehicles are typically moving and therefore the roadway is typically changing.

If return handoff is required at block 1144, the method 1100 continues to block 1146. At block 1146 the shared autonomy ends by initiating a return handoff that returns control to the subordinate vehicle 1308 such that the principal vehicle 1306 is no longer providing data, functionality, and/or control that allows the subordinate vehicle 1308 to function in a manner consistent with a higher level of autonomy than the inherent level of autonomy of the subordinate vehicle 1308. Accordingly, the subordinate vehicle 1308 returns to behaving in a manner consistent with its inherent level of autonomy. Likewise, the principal vehicle 1306 no longer receives subordinate sensor data from the subordinate vehicle 1308.

The return handoff may be a standard return handoff or an emergency return handoff. The type of handoff may be based on obstacle identified at block 1142 as well as the negotiated cooperating parameters provided by the cooperating vehicles. For example, the geofence 1902 may be known before it can be directly sensed and thus may be included in the planned route and/or the behavior plan. Accordingly, the return handoff can be planned and executed as a standard return handoff. The standard return handoff may be a planned event that has a pattern of handoff alerts and/or handoff actions. In some embodiments, control of the subordinate vehicle 1308 may be returned in stages. Conversely, the object 1904 may not be planned for in the behavior plan. The principal vehicle 1306 may have to perform an emergency handoff to the subordinate vehicle 1308. The emergency handoff may be performed on a predetermined time scale to return control to the vehicle occupant of the subordinate vehicle as soon as may be.

While the FIGS. 13-19 are described with respect to a cooperative pairing including a principal vehicle 1306 and the subordinate vehicle 1308, as discussed above, the systems and methods may include cooperative pairings of one or more principal vehicles and one or more subordinate vehicles. For example, the cooperative pairings may include three or more vehicles and each of the three or more vehicles may agree to cooperating parameters. A principal vehicle among the three or more vehicles combines sensor data from the three or more vehicles in order to generate a behavior plan for each of the three or more vehicles. Alternatively, the principal vehicle 1306 may combine sensor data from the three or more vehicles to generate a behavior plan for two of the three or more vehicles.

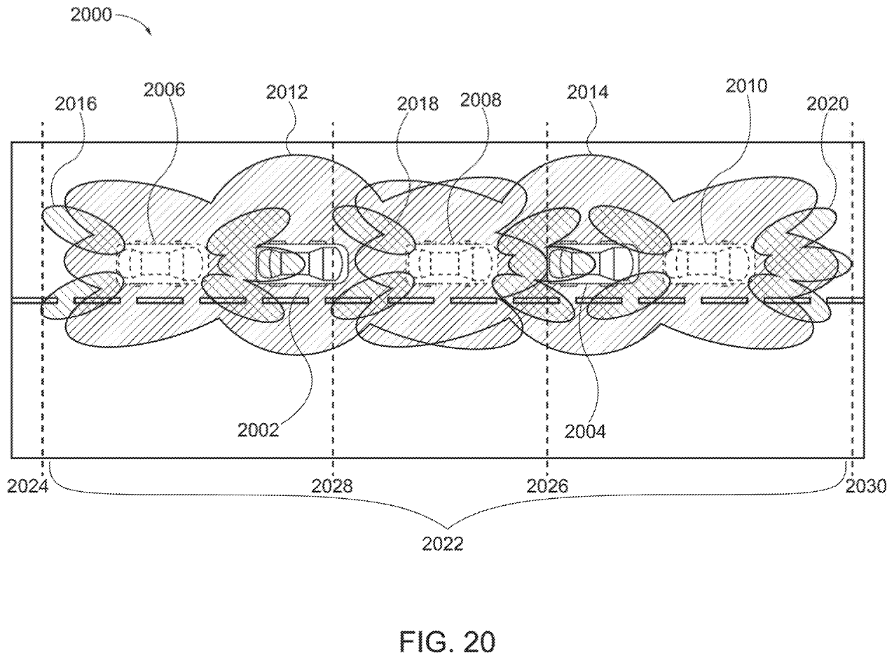

For example, a plurality of cooperating vehicles may participate in a cooperative swarm 2000. FIG. 20 is a schematic view of an exemplary traffic scenario on a roadway having multiple principal vehicles engaging in a cooperative swarm 2000 according to one embodiment. The cooperative swarm 2000 may include three or more cooperating vehicles. The three or more cooperating vehicles may include at least two principal vehicles and/or two subordinate vehicles. The cooperative swarm 2000 includes two principal vehicles: a first principal vehicle 2002 and a second principal vehicle 2004 and three subordinate vehicles: a first subordinate vehicle 2006, a second subordinate vehicle 2008, and a third subordinate vehicle 2010.

The first principal vehicle 2002 has a first principal sensor area 2012 based on the sensor footprint of the first principal vehicle 2002. The size of the first principal sensor area 2012 may be based on the ranges and/or threshold sensitivity of the sensors of the first principal vehicle 2002. The first principal sensor area 2012 encompasses the first subordinate vehicle 2006 and the second subordinate vehicle 2008. The first subordinate vehicle 2006 has a first subordinate sensor area 2016 and the second subordinate vehicle 2008 has a second subordinate sensor area 2018. The subordinate sensor areas 2016 and 2018 are based on the on the ranges and/or threshold sensitivity of the sensors of their respective subordinate vehicles 2006 and 2008.

The second principal vehicle 2004 has a second principal sensor area 2014 based on the sensor footprint of the second principal vehicle 2004. The size of the second principal sensor area 2014 may be based on the ranges and/or threshold sensitivity of the sensors of the second principal vehicle 2004. The second principal sensor area 2014 encompasses the second subordinate vehicle 2008 and the third subordinate vehicle 2010. The third subordinate vehicle 2010 has a third subordinate sensor area 2020.

During the cooperative perception stage, the sensor data from one or more of the cooperating vehicles is provided to the other cooperating vehicles. For example, the first principal vehicle 2002 may receive sensor data from the second principal vehicle 2004, the first subordinate vehicle 2006, the second subordinate vehicle 2008, and the third subordinate vehicle 2010. The sensor data can be used to generate a sensor map 2022 that combines the first principal sensor area 2012, second principal sensor area 2014, the first subordinate sensor area 2016, the second subordinate sensor area 2018, and the third subordinate sensor area 2020.

Using the sensor map 2022, the first principal vehicle 2002 and/or the second principal vehicle 2004 can provide decisions for itself as well as the other principal vehicle and/or the subordinate vehicles 2006, 2008, and 2010. For example, the behavior planning module 1208 of the first principal vehicle 2002 may use information from the localization module 1210 and the sensor data from the sensor map 2022 of the cooperative perception module 1214 to generate behavior plans for the second principal vehicle 2004 and/or the subordinate vehicles 2006, 2008, and 2010.

The manner in which the cooperating vehicles function together may be determined during the rendezvous stage or the parameter negotiation stage. The cooperating vehicles may meet in one or more impromptu meetings, described at 1102, one or more arranged meetings, described at 1104, or a combination of impromptu meetings and arranged meetings. For example, the first principal vehicle 2002 may have an arranged meeting 1104 with the first subordinate vehicle 2006 and the second principal vehicle 2004 may have had an arranged meeting 1104 with the second subordinate vehicle 2008 and an impromptu meeting 1102 with the third subordinate vehicle 2010.

Suppose the first principal vehicle 2002 is cooperating with first subordinate vehicle 2006. The first principal vehicle 2002 may also be broadcasting a broadcast message requesting additional principal vehicles for a cooperative swarm. A principal vehicle may request an additional principal vehicle to enlarge the size of the sensor map of the principal vehicle. The larger the sensor map the more sensor data that the principal vehicle receives allowing the principal vehicle to make more informed and safer decisions for itself and any other cooperating vehicles it is engaging in cooperative perception. For example, the first principal vehicle 2002 has an individual sensor map that extends from a first sensor border 2024 to a second sensor border 2026 based on the first principal sensor area 2012. The second principal vehicle 2004 has a sensor map that extends from a third sensor border 2028 to a fourth sensor border 2030. By engaging the second principal vehicle 2004 in cooperative sensing, the first principal vehicle 2002 can extend the sensor map 2022 from the first sensor border 2024 to the fourth sensor border 2030.

The third subordinate vehicle 2010 may have sent a broadcast message with a cooperative proposal received by the second principal vehicle 2004 in an impromptu meeting. In such an example, the second principal vehicle 2004 may have conditional accepted the cooperative proposal if the third subordinate vehicle 2010 is able to assume a cooperative position in which the third subordinate vehicle is ahead of the second principal vehicle 2004. Thus, even though the second principal vehicle 2004 is in the cooperative perception stage with the second subordinate vehicle 2008, the second principal vehicle 2004 may also be in the rendezvous stage or cooperative position stage with the third subordinate vehicle 2010. Accordingly, cooperating vehicles can simultaneously participate in different stages of cooperative sensing with different vehicles. In this manner, the second principal vehicle 2004, the second subordinate vehicle 2008, and the third subordinate vehicle 2010 form a cooperative swarm of three vehicles.

In addition to messaging between the principal vehicles and the subordinate vehicles, principal vehicles may communicate with each other in order to form a cooperative swarm together. FIG. 13 is a process flow for shared autonomy between principal vehicles in a cooperative swarm according to one embodiment. Referring now to FIG. 13, a method 2100 for cooperative sensing will now be described according to an exemplary embodiment. FIG. 13 will also be described with reference to FIG. 20.

Like FIG. 11, the method for shared autonomy between principal vehicles in a cooperative swarm can be described by the four stages: (A) rendezvous, (B) cooperative positioning, (C) parameter negotiation, and (D) cooperative perception. For simplicity, the method 2100 will be described by these stages, but it is understood that the elements of the method 2100 can be organized into different architectures, blocks, stages, and/or processes.

As discussed above with respect to FIG. 11, cooperating vehicles identify other cooperating vehicles in an impromptu meeting 2102 or an arranged meeting 2104. For example, an impromptu meeting 2102 may occur when the cooperating vehicles are traveling in the same direction on a roadway. At block 2106, the cooperating vehicles transmit broadcast messages. The broadcast messages may be generated and transmitted by the rendezvous module 1002. The broadcast messages include vehicle identifiers and a level of autonomy of the cooperating vehicle. In the event that a cooperating vehicle is currently acting as a principal vehicle, the broadcast message may also include this information as well as details regarding the current cooperative sensing. For example, the broadcast message may include the cooperating parameters (e.g., the destination of the current cooperative sensing, the destination of the broadcasting cooperating vehicle, the number of cooperating vehicles receiving behavior plans from the cooperating vehicle, etc.). The broadcast message may also include information about the sensor map of the broadcasting cooperating vehicle and/or sensor map of vehicles cooperating with the broadcasting cooperating vehicles.

The broadcast message may also include a vehicle identifier for each of the cooperating vehicles already engaged in cooperative sensing and the cooperating vehicles' level of autonomy. Suppose that the second principal vehicle 2004 is the broadcasting cooperating vehicle. The broadcast message may include that the second principal vehicle 2004 has two subordinate vehicles and/or may identify the second subordinate vehicle 2008 and the third subordinate vehicle 2010. The broadcast message may also include the size of the second principal sensor area 2014 and the length of the sensor map of the second principal vehicle 2004. For example, the length of the sensor map and may include the location of the third sensor border 2028 and the fourth sensor border 2030. The sensor border may be identified as a distance from the second principal vehicle 2004. Thus, the broadcast message may include GPS coordinates of the second principal vehicle 2004 and a distance to the third sensor border (e.g., 10 meters rearward from the second principal vehicle 2004, 10 meters including a trajectory, to meters in a southerly direction, etc.) and a distance to the fourth sensor border (e.g., 10 meters forward from the second principal vehicle 2004, 10 meters including a trajectory, to meters in a northerly direction, etc.). Suppose that the second principal vehicle 2004 is a Level 4 autonomous vehicle, the second subordinate vehicle 2008 is a Level 2 autonomous vehicle and the third subordinate vehicle 2010 is a Level 3 autonomous vehicle, that information may also be included in the broadcast message.

At 2108, a compatibility check is performed in a similar manner as described above with respect to FIG. 11. The compatibility check may be performed by the rendezvous module 1002. Suppose that the first principal vehicle 2002 receives the broadcast message from the second principal vehicle 2004. Here, shared autonomy between the principal vehicles occurs when the first principal vehicle 2002 and the second principal vehicle 2004 exchange information. Unlike the principal vehicle and the subordinate vehicle described above with respect to FIG. 1, the principal vehicles may have the same autonomy level such that the principal vehicles do not have a differential autonomy. Here, a cooperating vehicle may be a principal vehicle if it is supporting a subordinate vehicle.

Additionally or alternatively, the status of a cooperating vehicle as a principal vehicle or a subordinate vehicle may be based on the autonomy level of the cooperating vehicle. For example, the autonomy level of the cooperating vehicle may be compared to a principal vehicle threshold. For example, the principal vehicle threshold may be Level 4 vehicles and higher. Accordingly, if the cooperating vehicle is a Level 4 vehicle it is determined to be a principal vehicle. In some embodiments, the cooperating vehicle may be a principal vehicle based on the sensor capabilities of the cooperating vehicle. For example, a cooperating vehicle may be a principal vehicle if it has a sensor threshold. The sensor threshold may be at least one predetermined sensor capability. In another embodiment, the status of the cooperating vehicles may be determined relative to other cooperating vehicles. For example, cooperating vehicles with a higher autonomy level than the cooperating vehicles that it is cooperating with, may be deemed a principal vehicle.

Instead, the compatibility check between principal vehicles may determine whether the sensor area of the principal vehicles is sufficient to encompass any subordinate vehicles that are sharing autonomy with the principal vehicles. For example, during the compatibility check, the first principal vehicle 2002 may determine if the first principal sensor area 2012 and the second principal sensor area 2014 of the second principal vehicle 2004 are sufficient to provide adequate sensor coverage to the first subordinate vehicle 2006, the second subordinate vehicle 2008, and the third subordinate vehicle 2010. Adequate sensor coverage may be determined based on whether each of the first subordinate vehicle 2006, the second subordinate vehicle 2008, and the third subordinate vehicle 2010 can be covered if the principal vehicles share autonomy. In this manner, the compatibility check may involve cooperative positioning 2120 discussed above with respect to FIG. 11. For example, the compatibility check may include determining whether the sensor coverage is adequate based on one or more generated cooperative position plans.

Suppose that the first principal vehicle 2002 is sharing autonomy with the first subordinate vehicle 2006 and that the second principal vehicle 2004 is sharing autonomy with the second subordinate vehicle 2008 and the third subordinate vehicle 2010. During a compatibility check, at 2108, between the first principal vehicle 2002 and the second principal vehicle 2004, may generate a cooperative position plan, described at 1116, and/or modify a desired cooperative position, described at 1120, for each of the cooperating vehicles. For example, the cooperative position plans may include different positional arrangements of the first principal vehicle 2002 and the second principal vehicle 2004 relative to each other, and relative to the first subordinate vehicle 2006, the second subordinate vehicle 2008, and the third subordinate vehicle 2010. Thus, the compatibility check can determine whether the first principal vehicle 2002 and the second principal vehicle 2004 can share autonomy safely.

The compatibility check at block 2108 may also include determining whether the routes of the first principal vehicle 2002 and the second principal vehicle 2004 are compatible. For example, suppose the second principal vehicle 2004 is broadcasting broadcast messages requesting cooperative autonomy. The broadcast message from the second principal vehicle 2004 may include a planned route that the second principal vehicle 2004 plans to travel to a desired destination. The planned route of the second principal vehicle 2004 may be based on an individual route of the second principal vehicle 2004 or the shared autonomy route of the second principal vehicle 2004 and the second subordinate vehicle 2008 and/or the third subordinate vehicle 2010. Additionally, the planned route may include a geofence as discussed above with respect to FIG. 19.

Upon receiving the broadcast message, the first principal vehicle 2002 may determine if the first principal vehicle 2002 also plans to travel along the planned route of the second principal vehicle 2004. For example, the first principal vehicle 2002 may compare the planned route to navigation data from the navigation system 446. If the first principal vehicle 2002 does plan to travel at least a portion of the planned route of the second principal vehicle 2004, the route planning portion of the compatibility check, at block 2108, may be deemed successful.

At block 2110, the cooperating vehicles determine which vehicle will act as the primary vehicle. The primary vehicle is the principal vehicle that makes decisions for at least some of the cooperating vehicles. The primary vehicle may make decisions for each of the cooperating vehicles in the cooperative swarm. For example, if the first principal vehicle 2002 is the primary vehicle, then the first principal vehicle 2002 may generate a behavior plan and transmit the behavior plan to the second principal vehicle 2004, the first subordinate vehicle 2006, the second subordinate vehicle 2008, and the third subordinate vehicle 2010. Accordingly, the behavior plan may include individualized actions for each of the cooperating vehicles and any offsets.

In another embodiment, the first principal vehicle 2002 acting as the primary vehicle generates a behavior plan and transmits the behavior plan to the second principal vehicle 2004. Suppose the second principal vehicle 2004 is sharing autonomy with the second subordinate vehicle 2008 and the third subordinate vehicle 2010. The second principal vehicle 2004 may then transmit the behavior plan to the second subordinate vehicle 2008 and the third subordinate vehicle 2010. Accordingly, the principal vehicles sharing autonomy may be transparent to the subordinate vehicles. In this example, because the second subordinate vehicle 2008 and the third subordinate vehicle 2010 receive the behavior plan from the second principal vehicle 2004, vehicle occupants of the second subordinate vehicle 2008 and/or the third subordinate vehicle 2010 may be unaware of the first principal vehicle 2002.

In some embodiments, determining the primary vehicle may be based on the differential autonomy of the principal vehicles. Suppose that the first principal vehicle 2002 has a Level 4 autonomy level and the second principal vehicle 2004 has a Level 5 autonomy level. The primary vehicle may be the principal vehicle with a higher level of autonomy. Therefore, in this example, the primary vehicle would be the second principal vehicle 2004 because it has a higher level of autonomy than the first principal vehicle 2002.

In other embodiments, the primary vehicle may be determined based on the compatibility check. For example, determining the primary vehicle may be based on the planned route exchanged during the compatibility check. Suppose that the first principal vehicle 2002 is traveling a planned route to a predetermined destination and the second principal vehicle 2004 is traveling along only a portion of the planned route. The first principal vehicle 2002 may be determined to be the primary vehicle since it is traveling a longer distance on the planned route.

At block 2112, the method 2100 includes sending an acceptance message to initiate a shared autonomy mode when the compatibility check is successful and a primary vehicle is determined. The acceptance message may be sent by the rendezvous module 1002 when the host vehicle performs a successful compatibility check. For example, suppose the first principal vehicle 2002 transmits a broadcast message indicating that it is available for sharing autonomy with the rendezvous module 1002. The second principal vehicle 2004 performs the compatibility check with its rendezvous module 1002 upon receiving a broadcast message from the first principal vehicle 2002. The second principal vehicle 2004 may send an acceptance message indicating that the second principal vehicle 2004 is entering a shared autonomy mode and recommending that the first principal vehicle 2002 enter a shared autonomy mode.

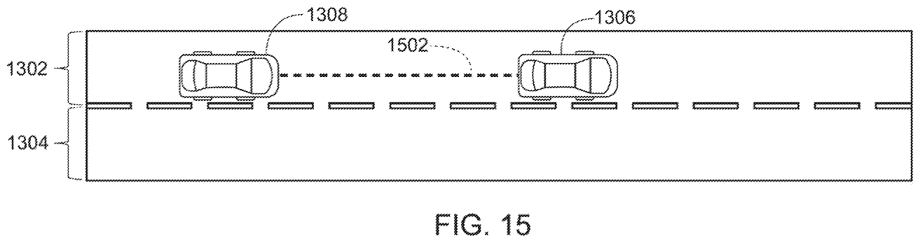

Alternatively, at block 2114, the method 2100 includes scheduling a prearranged meeting between cooperating vehicles at 2104. For example, vehicle occupants may be able to schedule shared autonomy through the host vehicle, such as through a display 450, or through a portable device 454 using an application as will be discussed at FIG. 15. For example, a vehicle occupant may be able to search for and schedule shared autonomy with other principal vehicles to form a cooperative swarm. In some embodiments, the scheduling at block 2114 may be made by indicating a location and time for the first principal vehicle 2002 and the second principal vehicle 2004 to meet. This may be done well in advance of a meeting or while a host vehicle is traveling.

At block 2116, the cooperating vehicles determine which vehicle will act as the primary vehicle. In some embodiments, the primary vehicle determination may be made during scheduling. In other embodiments, the determination may be made once the principal vehicles are within a shared autonomy range of one another. The shared autonomy range may be based on the sensor range of the principal vehicles, a predetermined distance (300 yards, 1300 yards, 750 yards, etc.), arrival at the scheduled location, or a combination thereof. For example, the first principal vehicle 2002 initiates a determination once the first principal vehicle 2002 is within shared autonomy range of the second principal vehicle 2004 to determine which vehicle will act as the primary vehicle.

At block 2118, the method 2100 includes sending an acceptance message to initiate a shared autonomy mode when the compatibility check is successful and a primary vehicle is determined. Accordingly, the method 2100 progresses to cooperative positioning 2120, parameter negotiation 2122, and cooperative perception 2124 as discussed above with respect to the stages described in FIG. 11.

FIG. 14 is a schematic view of an exemplary traffic scenario on a roadway having grouping of cooperating vehicles engaging in a cooperative swarm according to one embodiment. The roadway 2200 has a first lane 2202, a second lane 2204, and a third lane 2206. Cooperating vehicles may share autonomy in numerous arrangements shown on the roadway 2200. For example, a first principal vehicle 2208 may be following a first subordinate vehicle 2210 in the first lane 2202. The combination of the first principal vehicle 2208 and the first subordinate vehicle 2210 have a first sensor map 2212.

In another arrangement, cooperating vehicles form a cooperative swarm including a second principal vehicle 2214, a second subordinate vehicle 2216, a third subordinate vehicle 2218, and a third principal vehicle 2220 in the second lane 2204. The cooperative swarm has a second sensor map 2222. Although positioned in a longitudinal arrangement in the second lane 2204, the cooperative swarm may span a plurality of lanes. For example, a cooperating vehicle 2230 in the third lane 2206 may be included in the cooperative swarm if the second sensor map 2222 is large enough to encompass the cooperating vehicle 2230.

In one arrangement, cooperating vehicles, including a fourth subordinate vehicle 2224 and a fourth principal vehicle 2226 form an inter-lane combination that spans the first lane 2202 and the second lane 2204. Accordingly, the combination of the fourth subordinate vehicle 2224 and the fourth principal vehicle 2226 have a third sensor map 2228 that spans the first lane 2202 and the second lane 2204.

Cooperating vehicles may be identified, scheduled and/or selected using a visual representation, such as the visual representation 2300 shown in FIG. 15. The visual representation 2300 may be displayed on the display 450 of the infotainment system 448 or on the portable device 454. In some embodiments, the visual representation 2300 is generated in conjunction with an application, program, or software and displayed on the display 450 of the infotainment system 448 or on the portable device 454. The visual representation 2300 may be modified using a touch screen or input device, such as a keyboard, a mouse, a button, a switch, voice enablement, etc.

The visual representation 2300 may include a map area 2302 and a settings area 2304. Here, the map area 2302 and the settings area 2304 are shown side by side for clarity, but one or the other may be dominant in the field of view of a user. Alternatively, the user may be able to toggle between the map area 2302 and the settings area 2304 so that one or the other is displayed at a given time. The map area 2302 and the settings area 2304 are exemplary nature and may rendered with different or additional features. For example, the settings area 2304 is shown with radio buttons, however, toggle switches, check boxes, dialog boxes, pop-up menus, drop down menus, among other graphical interfaces may be used additionally or alternatively. In some embodiments, other data related to cooperating vehicles may also be shown with the map area 2302 and the settings area 2304.

The map area 2302 may be rendered based on the location of the display rendering the map area 2302. For example, suppose the map area is displayed on a portable device 454. The map area 2302 may be rendered based on the location of the portable device 454 and thus, a user. The map area 2302 may be rendered using any of a number of network-based mapping tools available. Network-based mapping tools generally provide the user with on-demand textual or graphical maps of user specified locations. Further, several related systems may provide the user with on-demand maps of automatically determined device locations based, for example, positioning technology such as satellite navigation (GPS, Galileo, Glonass, etc.) or as some function of Wi-Fi mapping, GSM-based cell signal mapping, RFID tracking, etc. In some embodiments, the portable device 454 may be tracked by using signal triangulation from nearby cell towers to pinpoint the location of the portable device 454. Similarly, Wi-Fi mapping generally locates a user by evaluating signal samples from multiple access points. In this manner, the map area 2302 can be rendered by tracking the portable device 454. Thus, the map area 2302 can be rendered to illustrate a predetermined area centered on the portable device 454. In some embodiments, the user can select the size of the predetermined area or change the size of the predetermined area based on a desired radius.

The map area 2302 may be displayed on the portable device 454 such that a user can see, select, and/or track cooperating vehicles that are available for cooperative sensing. In one embodiment, a vehicle and or a location can be selected for cooperative sensing. For example, a user can select a destination by placing a destination indicator 2306 in the map area 2302. Alternatively, a user can select a vehicle by selecting a vehicle icon such as a first vehicle icon 2308, a second vehicle icon 2310, a third vehicle icon 2312, or a fourth vehicle icon 2314. The vehicle icons may represent cooperating vehicle on the roadway illustrated in the map area 2302 in real-time. Accordingly, a user can track the locations of cooperating vehicles.

In some embodiments, the cooperating vehicles may be shown in the map area 2302 when the vehicle occupants of the cooperating vehicles are participating in shared autonomy by broadcasting requests or availability. In another embodiment, the cooperating vehicles may be shown in the map area 2302 when a vehicle occupant inputs a destination for a cooperating vehicle. The destination may be input using the navigation system 446 of the operating environment or through an application running on the portable device 454. In another embodiment, the cooperating vehicles may be shown in the map area 2302 when the application is running on the portable device 454.

In some embodiments, the cooperating vehicles may be filtered from the map area 2302 based on settings in the settings area 2304. The settings area 2304 may allow a user to select cooperating vehicles the type of broadcast message selection at 2316. For example, the broadcasting message selection 2316 may be a radio button that allows the user to select between requesting cooperative sensing or available for cooperative sensing. As shown, the user has selected to request cooperative sensing. Accordingly, the user can modify the map area 2302 to show filtered results based on the user's preferences. Other filter preferences may include, but are not limited to, showing cooperating vehicles with a threshold autonomy level or higher, showing cooperating vehicles based on a shared travel route, whether the cooperating vehicle is operating as a principal vehicle or a subordinate vehicle, proximity to the host vehicle, etc. For example, the proximity to the host vehicle may be based on cooperating vehicles located in the area of the roadway rendered in the map area 2302.

The settings area 2304 may allow a user to select features of the host vehicle. For example, the settings area 2304 may allow a user to select whether the user wishes the host vehicle to operate as a principal vehicle or a subordinate vehicle at status selection 2318. For example, the host vehicle may have an autonomy level such that the host vehicle can act as a principal vehicle and/or a subordinate vehicle. Suppose that the host vehicle has a Level 4 autonomy level. Accordingly, the host vehicle can act as a principal vehicle to a subordinate vehicle having a lower level of autonomy or in conjunction with another principal vehicle in a cooperative swarm.

Alternatively or additionally, the host vehicle may act as a subordinate vehicle to a vehicle having a sufficient autonomy level. Therefore, a user can choose whether the host vehicle acts as a principal vehicle or a subordinate vehicle using the status selection 2318. In this manner, the user can select whether the host vehicle broadcasts as a principal vehicle or a subordinate vehicle by selecting a radio button or other input interface. Other selectable features of the host vehicle may include, but are not limited to, the cooperating parameters to exchange with other cooperating vehicles, the cooperating vehicle profile to be shared, etc.

In addition to filtering the display results for cooperating vehicles, the settings area 2304 may provide a way for the user to set meeting preferences. For example, a user may identify a preference to schedule a meeting with a location, for example using a destination indicator 2306, or schedule a meeting with a specific vehicle, for example, using a vehicle icon such as the first vehicle icon 2308, using a meet selection 2320. Other meeting preferences may include, but are not limited to, how the rendezvous is conducted, how a user is prompted when cooperating vehicles meet, etc.

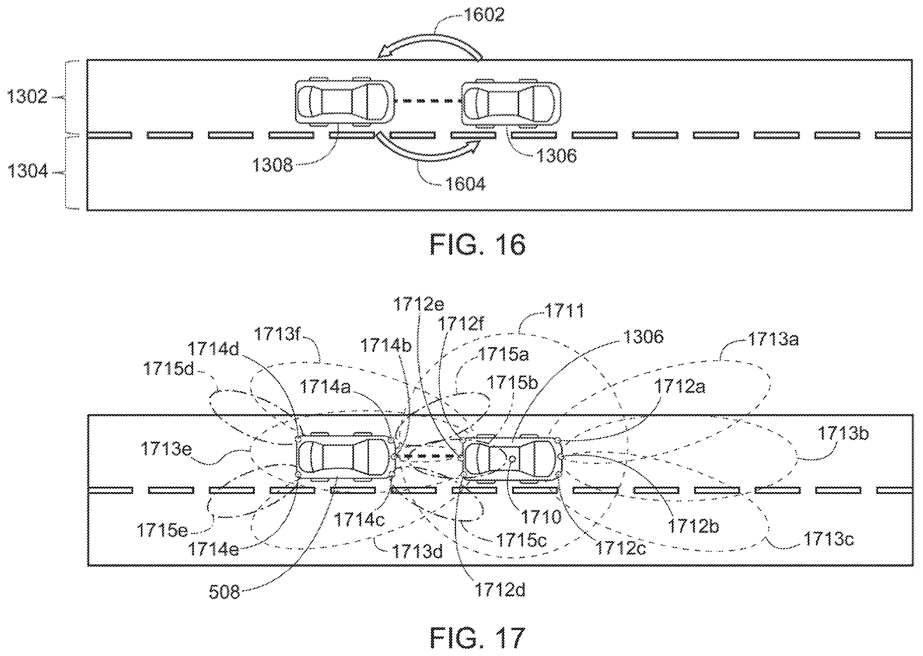

FIG. 16 is a process flow for shared autonomy using a visual representation according to one embodiment. FIG. 16 will be described with reference to FIGS. 1, 2, and 16. In particular, the method 2400 will be described with respect to the operating environment 400. For example, the VCD 402 may be used in conjunction with the display 450 of the infotainment system 448 and/or the portable device 454. In one embodiment, the VCD 402 may be accessed thought the display 450 and/or the portable device 454. Additionally or alternatively, the VCD 402 may be have one or more modules, components, or units distributed, combined, omitted or organized with other components or into different architectures on the display 450 and/or the portable device 454.

At block 2402, a request is sent to a first cooperating vehicle for cooperative sensing from a second cooperating vehicle. The request may be sent by the rendezvous module 1002 using a visual representation 2300. A user may interface with the visual representation 2300 using the display 450 and/or the portable device 454. The first cooperating vehicle may be selected based on a visual representation 2300 of the first cooperating vehicle. For example, the first cooperating vehicle may be selected by selecting a vehicle icon such as a first vehicle icon 2308, a second vehicle icon 2310, a third vehicle icon 2312, or a fourth vehicle icon 2314, shown in FIG. 15. The first cooperating vehicle may be selected based on its autonomy level. For example, the first cooperating vehicle may have a first autonomy level and the second cooperating vehicle may have a second autonomy level that is different than the first autonomy level. The visual representation 2300 may have icons that identify both the first cooperating vehicle and the second cooperating vehicle.

At block 2404, an acceptance message is received in response to the request from the first cooperating vehicle. The acceptance message may be received by the rendezvous module 1002 or received remotely and sent to the rendezvous module 1002 using wireless network antenna 434, roadside equipment 452, and/or the communication network 420 (e.g., a wireless communication network), or other wireless network connections. In another embodiment, the acceptance message may be received at a portable device 454. For example, the acceptance message may be received as an audio and/or visual prompt associated with the visual representation 2300.

At block 2406, a cooperative position is received at the second cooperating vehicle. The cooperative position describes a position of the second cooperating vehicle relative to the first cooperating vehicle.

At block 2408, a navigation path is generated that when executed causes the second cooperating vehicle to be within a predetermined radius of the first cooperating vehicle. The navigation path may be rendered in real-time on the visual representation 2300 and is modified to illustrate the relative position of the first cooperating vehicle and the second cooperating vehicle. In some embodiments, following the navigation path causes the second cooperating vehicle to assume the cooperative position.

At block 2410, cooperative sensing is initiated with the first cooperating vehicle when the first cooperating vehicle and the second cooperating vehicle are positioned in the cooperative position.

FIG. 17 is a process flow for shared autonomy with a cooperative position sensor adjustment according to one embodiment. FIG. 17 will be described with reference to FIGS. 1 and 2. In particular, the method 2500 will be described with respect to the operating environment 400.

At block 2502, broadcast messages are received from a plurality of cooperating vehicles on the roadway. The cooperating vehicles may include a principal vehicle 906 and the subordinate vehicle 908. In one embodiment, each cooperating vehicle of the plurality of cooperating vehicles has an autonomy level. The broadcast message received from a cooperating vehicle of the plurality of cooperating vehicles may include a vehicle identifier and an autonomy level of the cooperating vehicle. The broadcast message may include a cooperative proposal with one or more cooperating parameters.

At block 2504, a subordinate vehicle 908 is selected from the plurality of cooperating vehicles. The subordinate vehicle 908 may be selected based on the subordinate vehicle 908 having a lower autonomy level of the subordinate vehicle 908 as compared to the principal vehicle 906. Additionally or alternatively, the subordinate vehicle 908 may be selected due to the proximity of the subordinate vehicle 908 to the principal vehicle 906. Moreover, the subordinate vehicle 908 may be selected based on a cooperating proposal and or one or more cooperating parameters broadcast by the subordinate vehicle 908 in a broadcast message. In another embodiment, the subordinate vehicle 908 may be selected due to a response or acceptance of the cooperating proposal and or one or more cooperating parameters broadcast by the principal vehicle 906 in a broadcast message.

At block 2506, a cooperative position is determined for the principal vehicle 906 and the subordinate vehicle 908. The cooperative position may be determined by the principal vehicle 906. The cooperative position may be sent to the subordinate vehicle 908 in a position message. The position message may also include a cooperative position plan that has one or more actions, which if executed by the subordinate vehicle 908, will cause the subordinate vehicle 908 to be arranged, with the principal vehicle 906, in the cooperative position.

At block 2508, a sensor direction is determined for at least one sensor of the principal vehicle 906 based on the cooperative position. For example, the at least one sensor may include a light sensor 910 and one or more principal image sensors 912a, 912b, 912c, 912d, 912e, and 912f. The sensor direction may be determined to focus the field of view of the at least one sensor in a predetermined area. The sensor direction may include sensor factors that affect the at least one sensor's ability to capture sensor data. For example, the sensor factors may include location, range, field of view, sensitivity, actuation, and timing, among of others.

As discussed above with respect to FIG. 9, the light sensor 910 captures principal sensor data in a light sensing area 911 and the one or more principal image sensors 912a, 912b, 912c, 912d, 912e, and 912f for capture principal sensor data in corresponding image sensing principal areas 913a, 913b, 913c, 913d, 913e, and 913f. The sensor direction may be determined based on a desired area. The desired area may be the area where a cooperating vehicle is located. In another embodiment, the desired area may be an area which is a sensor gap between the cooperating vehicles. Thus, the sensor direction can accommodate cooperative sensing and/or correct sensor issues. The sensor direction may be represented as a coordinate shift the light sensing area 911 and the image sensing areas 913a-913f to focus the at least one sensors.

In another embodiment, a sensor direction may additionally or alternatively be determined for at least one sensor of the subordinate vehicle 908 based on the cooperative position. For example, the subordinate vehicle 908 may include one or more subordinate image sensors 914a, 914b, 914c, 914d, and 914e. The one or more subordinate image sensors 914a-914e capture subordinate sensor data from the corresponding image sensing subordinate areas 915a, 915b, 915c, 915d, and 915e. For example, the principal vehicle 906 may determine a sensor direction of at least one sensor of the subordinate vehicle 908.

At block 2510, the sensors of the principal vehicle 906 are adjusted based on the determined sensor direction. For example, the sensor factors, such as the location, range, field of view, sensitivity, actuation, and/or timing, of the light sensor 910 and/or the one or more principal image sensors 912a-912f may be adjusted in accordance with the sensor direction. Likewise, the sensor factors of the one or more subordinate image sensors 914a-914e may be adjusted based on the determined sensor direction. In one embodiment, the perception module 108. Therefore, the sensors can be adjusted to facilitate cooperative autonomy between the cooperating vehicles.

At block 2512, cooperative sensing is initiated with the subordinate vehicle according to the at least one cooperating parameter. The cooperative sensing is initiated in response to the principal vehicle and the subordinate vehicle being positioned in the cooperative position.

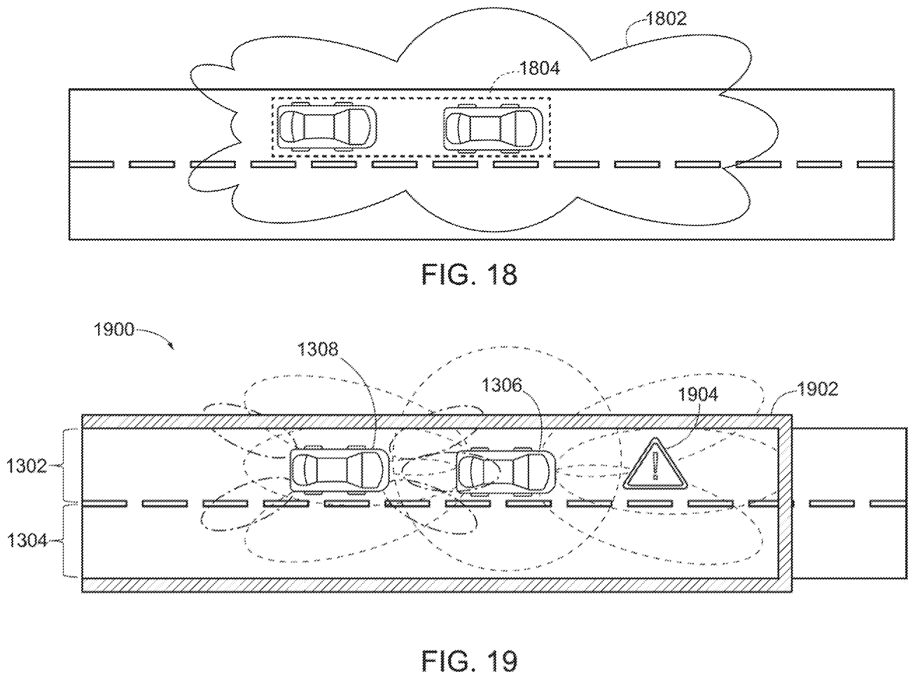

FIG. 18 is a process flow for shared autonomy with a business parameter negotiation according to one embodiment. FIG. 18 will be described with reference to FIGS. 1 and 2. In particular, the method 2600 will be described with respect to the operating environment 400.

At block 2602, broadcast messages are received from a plurality of cooperating vehicles on the roadway. Block 2602 operates in a similar manner as described with respect to blocks 2402 and 2502. For example, each cooperating vehicle of the plurality of cooperating vehicles has an autonomy level. The broadcast message received from a cooperating vehicle of the plurality of cooperating vehicles may include a vehicle identifier and an autonomy level of the cooperating vehicle.

At block 2604, a subordinate vehicle 908 is selected from the plurality of cooperating vehicles based on a lower autonomy level of the subordinate vehicle 908 as compared to the principal vehicle 906. Block 2604 operates in a similar manner as described with respect to blocks 2404 and 2504.

At block 2606, a cooperative position is determined for the principal vehicle 906 and the subordinate vehicle 908. Block 2606 operates in a similar manner as described with respect to blocks 2406 and 2506.

At block 2608, at least one cooperating parameter is received from the subordinate vehicle 908. The at least one cooperating parameter defines a behavioral aspect of the subordinate vehicle 908 during cooperative sensing. For example, the cooperating parameter may define a range speeds of that the vehicle occupant of the subordinate vehicle 908 would like to travel. Thus, cooperating parameters may inform the principal vehicle 906 how the subordinate vehicle 908 should be directed to maneuver during cooperative sensing. The at least one cooperating parameter may be received individually or as a part of cooperating proposal and/or cooperating vehicle profile.

At block 2610, cooperative sensing is initiated with the subordinate vehicle 908 according to the at least one cooperating parameter. The cooperative sensing may be initiated when the subordinate vehicle 908 enters a shared autonomy mode. The cooperative sensing is initiated in response to the principal vehicle 906 and the subordinate vehicle 908 being positioned in the cooperative position. During cooperative sensing, the subordinate vehicle 908 receives actions to execute from the principal vehicle 906. For example, the subordinate vehicle 908 may receive a behavior plan from the principal vehicle 906. By executing the actions from the principal vehicle 906, the subordinate vehicle 908 appears to operate with a higher level of autonomy than the subordinate vehicle 908 inherently has until handoff occurs.

In some embodiments, the hand off procedure may be initiated based on the actions of the vehicle occupant of the principal vehicle 906 or the subordinate vehicle 908. For example, the perception module 108 may use the vehicle sensors 406 to monitor the vehicle occupant. Additionally or alternatively, the principal vehicle subsystems 1202 of the principal vehicle 906 or the subordinate vehicle subsystems 1204 of the subordinate vehicle 908 may perform, facilitate, or enable monitoring of the vehicle occupant.

FIG. 19 is a process flow for shared autonomy based on a vehicle occupant state according to one embodiment. FIG. 19 will be described with reference to FIGS. 1-3. In particular, the method 2700 will be described with respect to the operating environment 400.

At block 2702, the principal vehicle 906 and/or the subordinate vehicle 908 may receive the vehicle occupant data. The vehicle occupant data may be received in any stage of cooperation. For example, the vehicle occupant data may be collected during the rendezvous stage, the cooperative positioning stage, the parameter negotiation stage, and/or the cooperative perception stage. Accordingly, while the method 2700 is discussed with respect to the perception module 108, the method may occur in any stage of cooperation. Furthermore, as described above, the cooperating vehicles may share vehicle occupant data from one or more of the sensors.

The vehicle occupant data may measure a body temperature, a pulse, a pulse rate or heart rate, a respiration rate, perspiration rate, a blood pressure, demographic data, eye movement, facial movement, body movement, head movement, gesture recognition, carbon dioxide output, consciousness, or other biometric or functional aspects of the vehicle occupant. Eye movement can include, for example, pupil dilation, degree of eye or eyelid closure, eyebrow movement, gaze tracking, blinking, and squinting, among others. Eye movement can also include eye vectoring including the magnitude and direction of eye movement/eye gaze. Facial movements can include various shape and motion features of the face (e.g., nose, mouth, lips, cheeks, and chin). For example, facial movements and parameters that can be sensed, monitored and/or detected include, but are not limited to, yawning, mouth movement, mouth shape, mouth open, the degree of opening of the mouth, the duration of opening of the mouth, mouth closed, the degree of closing of the mouth, the duration of closing of the mouth, lip movement, lip shape, the degree of roundness of the lips, the degree to which a tongue is seen, cheek movement, cheek shape, chin movement, and chin shape, among others. Head movement includes direction (e.g., forward-looking, non-forward-looking) the head of the driver is directed to with respect to the vehicle, head vectoring information including the magnitude (e.g., a length of time) and direction of the head pose.

At block 2704, the vehicle occupant data is utilized to determine a vehicle occupant state. The perception module 108, the principal vehicle subsystems 1202 of the principal vehicle 906, and/or the subordinate vehicle subsystems 1204 of the subordinate vehicle 908 may utilize the vehicle occupant data to determine and/or measure the vehicle occupant state. The vehicle occupant states may include drowsiness, attentiveness, distractedness, vigilance, impairedness, intoxication, stress, emotional states and/or general health states, among others of the vehicle occupant. The perception module 108 may include and/or access a database, look-up table, algorithm, decision tree, protocol, etc. to determine the vehicle occupant state. Moreover, the vehicle occupant state may be assigned a level and/or value that indicates the intensity of the vehicle occupant state.

At block 2706, a corresponding cooperating state of the principal vehicle 906 and/or the subordinate vehicle 908 is identified. The cooperating state determines the manner in which the cooperating vehicles should cooperate, compliance in the parameter negotiation stage, future processes for cooperation. The cooperating state, for example, may include continuing the cooperation as is, proposing that a cooperating parameter be modified, or initiating a change in cooperation, such as by initiating a handoff or emergency handoff. For example, suppose that it is determined that a vehicle occupant is drowsy. The perception module 108 may identify that cooperating state as requiring an emergency handoff. In another example, a business parameter may set, altered or proposed based on the cooperating state. For example, if the vehicle occupant of the subordinate vehicle 908 is drowsy, the principal vehicle 906 may charge more per mile for cooperative sensing, such as $0.10 per mile rather than $0.05 per mile when the vehicle occupant state is drowsy. Accordingly, the subordinate vehicle 1308 may object to being charged $0.10. Likewise, the parameter negotiation may require that the vehicle occupant state satisfy a threshold that corresponds to a cooperating state that results in cooperative sensing. The perception module 108 may again include and/or access a database, look-up table, algorithm, decision tree, protocol, etc. to identify the cooperating state.

At block 2708, a cooperation notification is issued based on the cooperating state. The perception module 108 may cause the cooperating notification to be issued to one or more vehicle occupants of the principal vehicle 906, and/or the subordinate vehicle 908. The cooperation notification may utilize the display 450 of the infotainment system 448 or lights associated with a cooperating vehicle including dashboard lights, roof lights, cabin lights, or any other lights. The cooperation notification may also generate various sounds using speakers in a cooperating vehicle. The sounds could be spoken words, music, alarms, or any other kinds of sounds. Moreover, the volume level of the sounds could be chosen to ensure the vehicle occupant is put in an alert state by the sounds. The type of cooperating notification may be based on the type of vehicle occupant state and/or vehicle occupant data including demographic information about the vehicle occupant.

Suppose that the vehicle occupant of the subordinate vehicle 908 is determined to be drowsy. The cooperation notification may notify the vehicle occupant of the subordinate vehicle 908 that the vehicle occupant state is drowsy using an alarm. In this example, the notification may act as an alert that gives the vehicle occupant of the subordinate vehicle 908 an opportunity to achieve a minimum state of alertness. For example, the cooperation notification may be issued a predetermined number of times and/or for a predetermined length. In another embodiment, additional cooperating vehicles, for example, in a cooperating chain may be notified. Continuing the example from above in which the vehicle occupant of the subordinate vehicle 908 receives an issued cooperating notification, the principal vehicle 906 may also receive a cooperation notification. The cooperation notification may be sent via the remote transceiver 432 of the cooperating vehicle 218, over remote networks by utilizing a wireless network antenna 434, roadside equipment 452, and/or the communication network 420 (e.g., a wireless communication network), or other wireless network connections.

In some embodiments, one or more criteria could be used to determine if a second cooperating vehicle should be notified of the vehicle occupant state detected by the host vehicle, here, the subordinate vehicle 908. In embodiments where multiple vehicle systems are in communication with one another, the perception module 108 may broadcast a cooperating notification to any communicating vehicles within a predetermined distance. For example, the perception module 108 of the subordinate vehicle 908 may broadcast a cooperative notification to any vehicles within a ten meter distance to inform other vehicles and/or vehicle occupants that the vehicle occupant of the subordinate vehicle 908 is incapacitated and is unable to independently control the subordinate vehicle 908.

In another embodiment, a predetermined number of cooperating notifications may be issued to the host vehicle. Also, the cooperating notifications may increase with the intensity of the vehicle occupant state and/or with each iteration of the cooperating notifications. In some embodiments, the timing and/or intensity associated with various cooperating notifications could also be modified according to the level of distraction. For example, an initial cooperating notification may include an audio alert, while a subsequent cooperating notification may use an electronic pretensioning system to increase or decrease the intensity and/or frequency of automatic seat belt tightening. Accordingly, the cooperating notification may escalate. In this manner, the cooperating notification may gain the vehicle occupant's attention in order to prompt the user to act. For example, the vehicle occupant may be able to stop, delay, mute, or otherwise impede receiving the cooperating notifications by providing feedback. The feedback may be a gesture, such as a haptic feedback, a vocal response, providing an entry on the portable device 454, etc.

The cooperation notification may be delayed to allow the vehicle occupant to self-correct the vehicle occupant state. The length of the delay may be based on the vehicle occupant state, cooperating state, and/or vehicle occupant data including demographic information about the vehicle occupant. For example, if the vehicle occupant state indicates that the vehicle occupant has unbuckled the seatbelt, the cooperation notification may be delayed by ten seconds to allow the vehicle occupant time to re-buckle the seatbelt before a cooperation notification is issued. The delay may also snooze the cooperation notification before a second iteration of the cooperation notification.

At block 2710, it is determined whether a pre-conditioned feedback is received. The pre-conditioned feedback may be feedback from the principal vehicle 906, the subordinate vehicle 908, or a vehicle occupant of either. In the example in which the vehicle occupant of the subordinate vehicle 908 is drowsy, a pre-conditioned feedback may be the vehicle sensors 406 determining that a vehicle occupant's hands are in contact with the front and/or back of the touch steering wheel (e.g., gripped and wrapped around the steering wheel). Additionally or alternatively, the pre-conditioned feedback may be received from another cooperating vehicle. For example, the pre-conditioned feedback may include a vehicle occupant of the principal vehicle 906 acknowledging the vehicle occupant state of the vehicle occupant of the subordinate vehicle 908. Accordingly, there are many forms of feedback which may vary based on the intensity of the vehicle occupant state, the origination of the feedback the type, or number of cooperating notifications.

In addition to stopping an escalating cooperative notification, the pre-conditioned feedback may return the subordinate vehicle 908 of this example to its cooperation with the principal vehicle 906 as it is being conducted. Accordingly, the method 2700 returns to the receiving sensor data about the vehicle occupant at block 2702. And the cooperating vehicles continue monitoring the vehicle occupants.

If it is determined that the pre-conditioned feedback was not received, the method continues to block 2712. At block 2712, the identified cooperating state is initiated. For example, if the identified cooperating state was a control hand-off, then the control hand-off is initiated in the manner described above, for example, with respect to FIG. 11. In this manner, the cooperative notification may be repeated and/or escalated a predetermined number of times before the identified cooperating state is initiated. Accordingly, the cooperation of the cooperating vehicles can be altered based on the state of the vehicle occupants.

In one embodiment, the cooperating state maybe escalated. Suppose that the cooperating state is a control handoff. The control handoff may require further action from a vehicle occupant. For example, the control handoff may require that a vehicle occupant have their hands on the steering wheel of the principal vehicle 1306 and/or that a vehicle occupant have their hands on the steering wheel of the subordinate vehicle 1308. Suppose, that none of the vehicle occupants place their hands on the steering wheel of subordinate vehicle 1308 as required in the control handoff, then the control handoff may be escalated to an emergency handoff. An emergency handoff may halt principal vehicle and/or subordinate vehicle 1308 quickly and safely. The escalated cooperating state, here the emergency handoff, may be performed to grow, develop, increase, heighten, strengthen, intensify, and/or accelerate the effects of the cooperating state. For example, if the control handoff provides control back to a vehicle occupant of the subordinate vehicle 1308, the emergency handoff may reduce the requirements (e.g., hands on steering wheel, maintaining speed of a cooperating vehicle, etc.) to affect the handoff as soon as possible in the safest manner possible. In this manner, the cooperating state can also evolve based on the vehicle occupant data.

### III. Methods for Shared Autonomy for Multiple Swarms

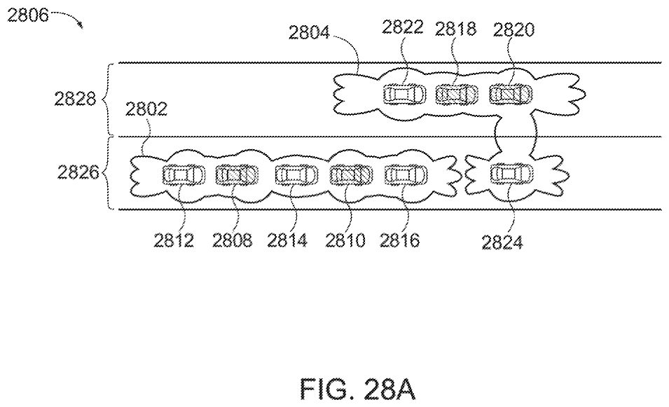

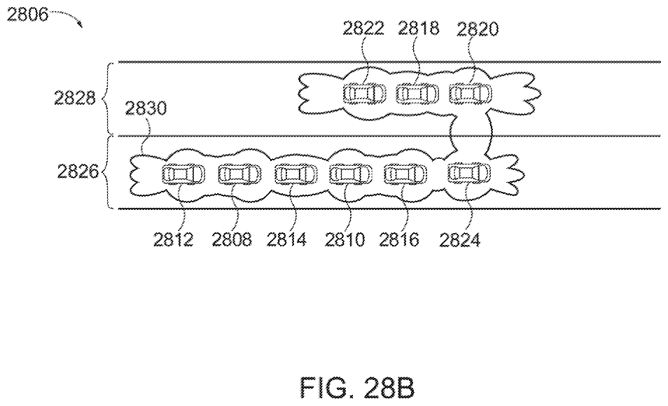

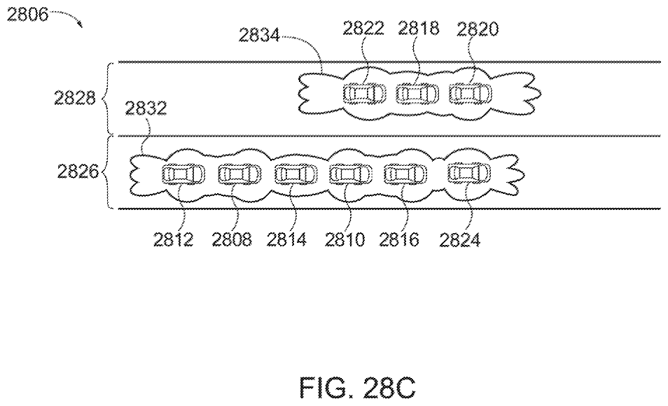

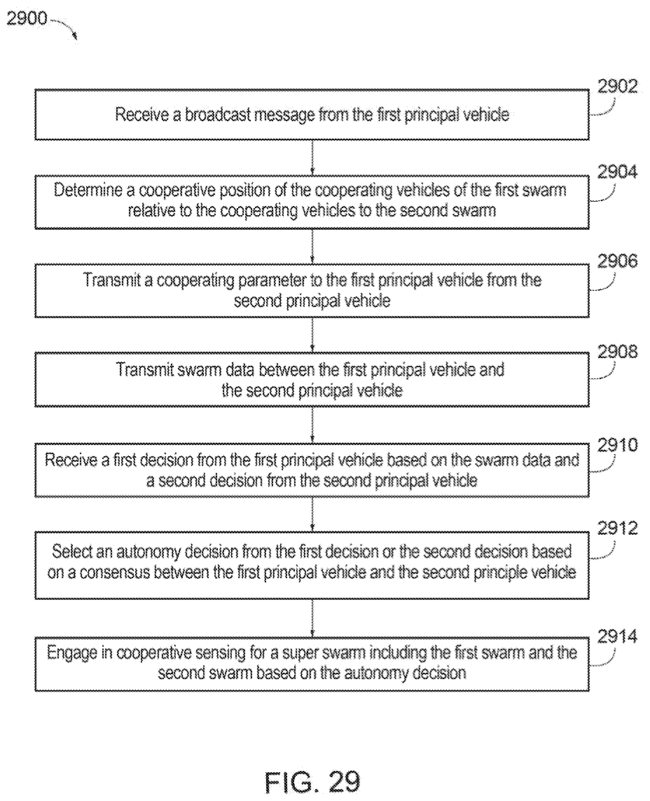

As described above, multiple principal vehicles may engage in a cooperative swarm. In some embodiments, multiple swarms and/or groups of cooperating vehicles may interact on a roadway. For example, as shown in FIG. 28A a first swarm 2802 and a second swarm 2804 may interact on a roadway 2806. The first swarm 2802 includes a first principal vehicle 2808, a second principal vehicle 2810, a first subordinate vehicle 2812, a second subordinate vehicle 2814, and a third subordinate vehicle 2816. The second swarm 2804 includes a third principal vehicle 2818, a fourth principal vehicle 2820, a fourth subordinate vehicle 2822, and a fifth subordinate vehicle 2824.

In some embodiments, the swarms and/or groups of cooperating vehicles may merge or exchange vehicles. For example, as shown in FIG. 28B, the first swarm 2802 and the second swarm 2804 combine over the first lane 2826 and the second lane 2828 of the roadway 2806 to form a super swarm 2830. Alternatively, one or more cooperating vehicles may move from one swarm to another. For example, in FIG. 28C, the fifth subordinate vehicle 2824 leaves the second swarm 2804 and joins the first swarm 2802. The first swarm 2802 and the fifth subordinate vehicle 2824 may form a new generation swarm, a third swarm 2832, whereas the second swarm without the fifth subordinate vehicle 2824 is also in the new generation, a fourth swarm 2834. Accordingly, the swarms may evolve and change as they travel the roadway 2806.

The swarms interact in a similar manner as individual cooperating vehicles and therefore can be described by the same four stages, namely, (A) rendezvous, (B) cooperative positioning, (C) parameter negotiation, and (D) cooperative perception illustrated in FIG. 11. The manner in which the swarms interact will now be described according to exemplary embodiments with reference to the steps of FIG. 11 and described with respect to FIGS. 28A-28C. For simplicity, individual steps are described with respect to the method 1100, but steps may be added, skipped or performed in an alternative order. Although the examples herein are described with respect to one swarm or another or a specific cooperating vehicle, the processes described may be performed by any of the swarms or cooperating vehicles.

### A. Rendevous

In the rendezvous stage, swarms may identify one another in a similar manner as described above with respect to FIG. 11. For example, the first swarm 2802 and the second swarm 2804 may have an impromptu meeting 1102 or an arranged meeting 1104. The rendezvous processes described below are performed by, coordinated by, and/or facilitated by the rendezvous module 1002 of cooperating vehicles of the first swarm 2802 and the second swarm 2804. Returning to FIG. 28A, the first principal vehicle 2808 of the first swarm 2802 and the third principal vehicle 2818 of the second swarm 2804 may communicate on behalf of their respective swarms. In one embodiment, the first principal vehicle 2808 may issue a broadcast message that include information about the cooperating vehicles of the first swarm 2802. For example, the broadcast message may include vehicle identifiers and levels of autonomy of the first principal vehicle 2808, the second principal vehicle 2810, the first subordinate vehicle 2812, the second subordinate vehicle 2814, and the third subordinate vehicle 2816.

Additionally or alternatively, the broadcast message may include information about the first swarm 2802. For example, the broadcast message may include location information that indicates the boundaries of the sensor map corresponding to the first swarm 2802. The broadcast message may also include the destinations of the individual cooperating vehicles of the first swarm 2802 as well as the destination of the first swarm 2802 to which the first principal vehicle 2808, the second principal vehicle 2810, the first subordinate vehicle 2812, the second subordinate vehicle 2814, and the third subordinate vehicle 2816 will travel together.

The broadcast message may also include a cooperating proposal that includes cooperating proposal for individual cooperating vehicles or other swarms in a similar manner as described above. Suppose that the third principal vehicle 2818 of the second swarm 2804 responds to the cooperating proposal on behalf of the second swarm 2804. A cooperating vehicle, such as the first principal vehicle 2808, may perform a compatibility check. As described above, shared autonomy occurs when principal vehicles, having a higher autonomy levels, provide information to subordinate vehicles to allow the subordinate vehicles to operate at a higher autonomy level. The difference in the autonomy levels between the principal vehicles of the swarm elevate the functional autonomy of the subordinate vehicles. The compatibility check determines whether combining the swarms or swapping cooperating vehicles would benefit both the swarm and/or the cooperating vehicles through differential autonomy including sensor sharing. The compatibility check may determine whether combining the swarms or adding individual cooperating vehicles to a swarm will yield more benefit that cost. For example, if the first swarm 2802 and the second swarm 2804 combine, the resulting super swarm 2830 may be able to accommodate more subordinate vehicles. However, if the if the first swarm 2802 and the second swarm 2804 have different destinations and the super swarm 2830 would have to be rerouted, then the additional mileage and trip time may not comply with the cooperating proposal. Thus, the compatibility check may fail.

In some embodiments, the compatibility check may result in a provisional determination that the compatibility check is successful with regard to a specific cooperating vehicle. For example, the third principal vehicle 2818 may respond on behalf of second swarm 2804, but the first principal vehicle 2808 may provisionally determine that the compatibility check is successful for a specific cooperating vehicle of the second swarm 2804, such as the fifth subordinate vehicle 2824. The provisional determination may be revisited at the parameter negotiation stage, as will discussed below.

### B. Cooperative Positioning

To engage in cooperative sensing, the swarms, and possibly individual cooperating vehicles are arranged in a cooperative position. The cooperative positioning functions in a similar manner as the cooperative positioning processes described above. Furthermore, the cooperative positioning processes describe below are performed, coordinated, or facilitated by the positioning module 1004 for cooperative vehicles. The positioning module 1004 may additionally utilize other components of the operating environment 400, including vehicle systems 404 and the vehicle sensors 406 as well as the subsystems 1200 shown in FIG. 12.

Suppose the fifth subordinate vehicle 2824 is originally in the second lane 2828, and the cooperative position may have the fifth subordinate vehicle 2824 move into the first lane 2826 behind the first swarm 2802, as shown. For example, the first principal vehicle 2808 may generate a cooperative position plan that direct the fifth subordinate vehicle 2824 to move into the cooperative position behind the first swarm 2802. Although, the example is directed to a single cooperating vehicle, the cooperative position plan may be directed more of the vehicles of the second swarm 2804.

Because the fifth subordinate vehicle 2824 is subordinate to the third principal vehicle 2818 and the fourth principal 2820, the cooperative position plan may be directed to the third principal vehicle 2818 and the fourth principal 2820. The third principal vehicle 2818 or the fourth principal 2820 may cause the fifth subordinate vehicle 2824 to move using a behavior plan generated in a similar manner as that described at block 1136. The first principal vehicle 2808, the second principal vehicle 2810, the third principal vehicle 2818, and/or the fourth principal vehicle 2820 may confirm that the desired cooperative position has been achieved, in a similar manner as described at 1118 of FIG. 11.

### C. Parameter Negotiation

As discussed above, once the cooperative sensing is initiated in response to the rendezvous stage being completed, the cooperating vehicles also enter the cooperative positioning stage and the parameter negotiation stage. The parameter negotiation processes described below are performed, coordinated, or facilitated by the negotiation module 106 for cooperative vehicles. The negotiation module 106 may additionally utilize other components of the operating environment 400, including vehicle systems 404 and the vehicle sensors 406 as well as the subsystems 1200 shown in FIG. 12.

In the parameter negotiation stage, the cooperating vehicles are able to adjust cooperating parameters and occurs in a similar manner as described above. The first swarm 2802 may exchange at least one cooperating vehicle profile with the fifth subordinate vehicle 2824 and/or the second swarm 2804. For example, the cooperating vehicle profile for the first swarm 2802 may include the cooperating parameters that each of the cooperating vehicles of the first swarm 2802 previously agreed to during the parameter negotiation of the first principal vehicle 2808, the second principal vehicle 2810, the first subordinate vehicle 2812, the second subordinate vehicle 2814, and the third subordinate vehicle 2816. For example, the cooperating vehicle profile for the first swarm 2802 may include business parameters, kinematic parameters, and/or relative parameters, as discussed above, common to the cooperating vehicles of the first swarm 2802.

Suppose that the first swarm 2802 and the second swarm 2804 are joining to form the super swarm 2830. The cooperating vehicle profile of the second swarm 2804 may be exchanged with the cooperating vehicle profile of the first swarm 2802. Alternatively, the cooperating vehicle profile associated specifically with the fifth subordinate vehicle 2824 may be exchanged with the cooperating vehicle profile of the first swarm 2802. In another embodiment, the cooperating vehicle profile associated specifically with the fifth subordinate vehicle 2824 may be exchanged initially and counter parameters may be based on the cooperating vehicle profile of the second swarm 2804 when those parameters better conform to the cooperating vehicle profile of the first swarm 2802.

### D. Cooperative Perception

During cooperative perception the cooperating vehicle share autonomy and sensor perception. The cooperative perception processes described below are performed by, coordinated by, or facilitated by the perception module 108 of cooperative vehicles. The perception module 108 may additionally utilize other components of the operating environment 400, including vehicle systems 404 and the vehicle sensors 406 as well as the subsystems 1200 shown in FIG. 12. For example, the principal vehicle subsystems 1202 may include a cooperative perception module 1214. As discussed above, during the cooperative perception stage, the cooperating vehicles participate in cooperative sensing such that the cooperating vehicles may share sensor data and/or autonomy.

Turning to the super swarm 2830 of FIG. 2B, the first swarm 2802 and the second swarm 2804 combine such that the super swarm includes a first principal vehicle 2808, a second principal vehicle 2810, the third principal vehicle 2818, and the fourth principal vehicle 2820. The principal vehicle of the super swarm 2830 share autonomy with the first subordinate vehicle 2812, the second subordinate vehicle 2814, the third subordinate vehicle 2816, the fourth subordinate vehicle 2822, and the fifth subordinate vehicle 2824. In particular, the principal vehicles continually share swarm data about the principal vehicles, the subordinate vehicles, and the roadway 2806, among others. In one embodiment, the principal vehicles may communicate information about specific subordinate vehicle.

For example, a principal vehicle may provide swarm data regarding one or more subordinate vehicles assigned to the principal vehicle based on proximity, sensor sensitivity, and/or vehicle relationships in previous generations of the swarms, among others. The principal vehicles of a swarm may also communicate swarm data about the current trip, obstacles, destination, etc. In this manner, the one or more of the principal vehicles 2808, 2810, 2818, and 2820 continually provide swarm data to the other principal vehicles in the swarm and vice versa.

The manner of the communication as well as the cooperative autonomy is based on the based on the evolution of swarm, for example if the original swarm evolves into a super swarm or swapped swarm. In particular when the original swarm evolves, the cooperative autonomy may be predicated on a handoff between the swarms in addition to the initial handoff of control from the subordinate vehicle 908 to the principal vehicle 906 as described above with respect to FIG. 11. The swarm handoff will be discussed in greater detail below.

### 1. Super Swarm

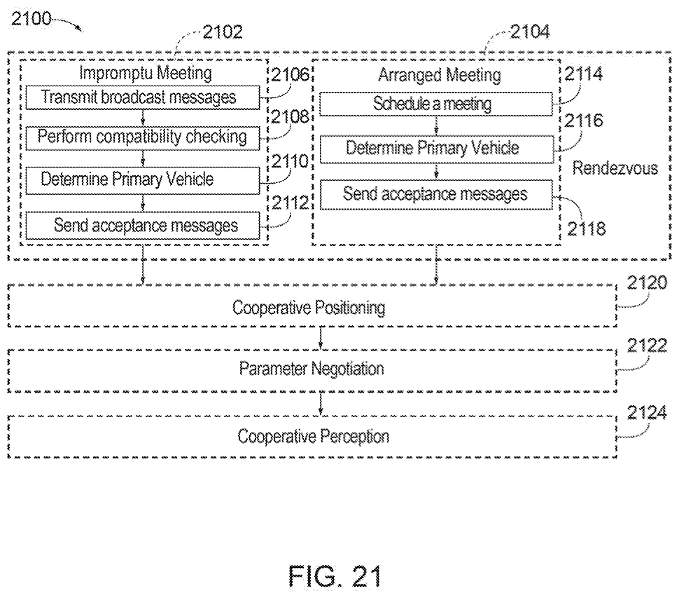

As shown in FIG. 28B, the super swarm 2830 is formed when the first swarm 2802 and the second swarm 2804 are combined. Turning to FIG. 21, a computer-implemented method for providing enhanced autonomy to cooperating vehicles of the first swarm 2802 and the second swarm 2804 of FIG. 28A. As discussed above, the first swarm includes one or more principal vehicles and corresponding subordinate vehicles, as does the second swarm. At block 2902 of the method 2900, suppose that the first principal vehicle 2808 of the first swarm 2802 broadcasts a broadcast message that is received by the third principal vehicle 2818 of the second swarm 2804. At block 2904, a cooperative position for the cooperating vehicles of the second swarm 2804 may be determined based on the broadcast message.

At block 2906, the cooperative position is transmitted to the cooperating vehicles of the second swarm 2804. The cooperative position may also be transmitted to the cooperating vehicles of the first swarm 2802, as the first principal vehicle 2808, the second principal vehicle 2810, the first subordinate vehicle 2812, the second subordinate vehicle 2814, and the third subordinate vehicle 2816. In some embodiments, the cooperative position may be transmitted to the principal vehicles, and the principal vehicles will transmit the positioning parameters, such as vectoring, coordinates, etc. to the subordinate vehicles.

At block 2908, swarm data is transmitted between the swarms. For example, the first principal vehicle 2808 and the second principal vehicle 2810 of the first swarm 2802 may be exchanging data with the third principal vehicle 2818 and the fourth principal vehicle 2820 of the second swarm. Once the first swarm 2802 and the second swarm 2804 are in a cooperative position and exchanging swarm data, the first swarm 2802 and the second swarm 2804 are operating as a super swarm 2830, as shown in FIG. 28B. Accordingly, the principal vehicles of the super swarm 2830 are making autonomy decisions for the subordinate vehicles based on a common interest.

At block 2910, decisions are received from one or more of the principal vehicles of the super swarm. For example, each of the first principal vehicle 2808, the second principal vehicle 2810, the third principal vehicle 2818, and the fourth principal vehicle 2820 may each generate a decision based on the swarm data. Accordingly, multiple decisions may be received by the perception module 108. At block 2912, the perception module 108 may select an autonomy decision from the received decisions based on a consensus between the principal vehicles. Because the principal vehicles are making decisions on behalf of a common interest of the cooperating vehicles of the super swarm 2830, the decisions may be the same and thus a consensus is achieved.

However, differences in the decision may occur when multiple outcomes yield the same result with the same exertion. For example, rerouting around an obstacle (not shown) may be achieved by either changing lanes into a left or a right lane. Because the cost and kinematic parameters for both moves may be the same, the principal vehicles will have to select one option. In one embodiment, the consensus may be achieved by selecting an option at random. Alternatively, the decisions may be considered votes for an option, and the option with the majority of the votes is selected as the autonomy decision. In another embodiment, the decision of a predetermined principal vehicle may be selected when there is not consensus. For example, the perception module 108 may selection the decision of the first principal vehicle 2808 as a leader when the first principal vehicle 2808, the second principal vehicle 2810, the third principal vehicle 2818, and the fourth principal vehicle 2820 are in conflict.

As 2914, cooperative sensing for a super swarm is engaged based on the autonomy decision. Executing the autonomy decision for shared autonomy may include performing a handoff for one or more of the cooperating vehicles based on the cooperative position of the cooperating vehicles in the super swarm 2830. Alternatively, the handoff may occur as a part of cooperative positioning of the cooperative vehicles in the super swarm 2830.

### 2. Swapped Swarm

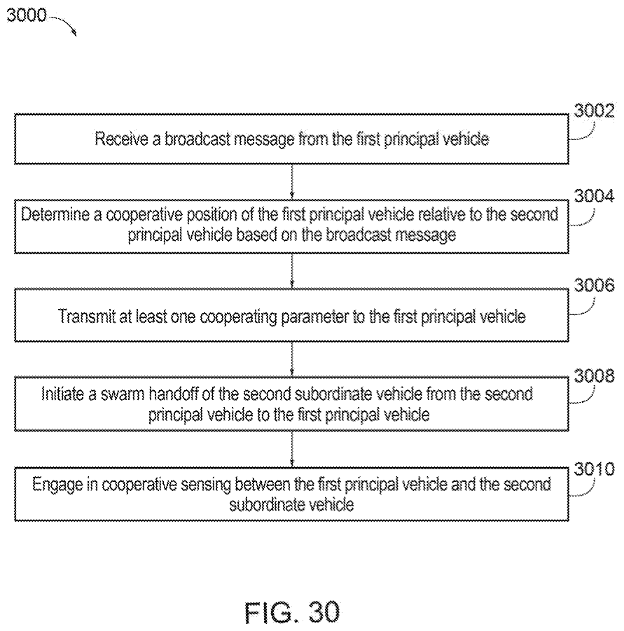

As shown in FIG. 28C, one or more cooperating vehicles may migrate to another swarm to form swapped swarms such as the third swarm 2832 and the fourth swarm 2834. Accordingly, the first swarm 2802 and the second swarm 2804, shown in FIG. 28A, evolve as the membership of the swarms changes through interaction of the swarms, here into, the third swarm 2832 and the fourth swarm 2834. Turning to FIG. 30, a process flow for shared autonomy for swapped swarms according to one embodiment.

At block 3002, suppose that the first principal vehicle 2808 of the first swarm 2802 broadcasts a broadcast message that is received by the cooperating vehicles of the second swarm 2804. For example, suppose that the fourth subordinate vehicle 2822 receives the broadcast message. The fifth subordinate vehicle 2824 may respond based on cooperating parameters offered by membership in the first swarm. Alternatively, the third principal vehicle 2818 and/or the fourth principal vehicle may recommend that the fifth subordinate vehicle 2824 migrate to the first swarm 2802. For example, a vehicle occupant of the fifth subordinate vehicle 2824 may be prompted to be select between staying in the second swarm 2804 or migrate to the first swarm 2802.

At block 3004, a cooperative position for any cooperating vehicle migrating from one swarm to another swarm is determined based on the broadcast message. For example, the cooperative position of the fifth subordinate vehicle 2824 may be determined. Additionally or alternatively, a cooperative position for one or more of the cooperating vehicles of the first swarm 2802 and/or the second swarm 2804 may be determined to accommodate a migrating vehicle, such as the fifth subordinate vehicle 2824.

At block 3006, at least one cooperating parameter is transmitting to the first principal vehicle 2808. For example, the cooperating parameter may define a behavioral aspect of the fifth subordinate vehicle 2824. In this manner, the fifth subordinate vehicle 2824 may negotiate with the first swarm 2802, in a similar manner as described above with respect to second III(C) above.

At block 3008, a swarm handoff for the migrating vehicle, here the fifth subordinate vehicle 2824. For example, suppose that the fifth subordinate vehicle 2824 originally cooperates with the fourth principal vehicle 2820 in the second swarm 2804 as shown in FIG. 28A. The swarms evolve as shown in FIG. 28C such that the fifth subordinate vehicle 2824 migrates to the first swarm 2802. In particular, the fifth subordinate vehicle 2824 may begin cooperating with the second principal vehicle 2810. Accordingly, a swarm handoff is performed for a subordinate vehicle from one principal vehicle to another, here from the fourth principal vehicle 2820 to the second principal vehicle 2810.

At block 3010, the fifth subordinate vehicle 2824 engages in cooperative sensing with the first swarm 2802. Continuing the example from above, the migration of the fifth subordinate vehicle 2824 is complete, and the fifth the subordinate vehicle 2824 shares autonomy with the second principal vehicle 2810 of what is now the third swarm 2832. In this manner, the swarms can interact and evolve based on their interaction.

The embodiments discussed herein can also be described and implemented in the context of computer-readable storage medium storing computer executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer-readable storage media excludes non-transitory tangible media and propagated data signals.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A swarm management framework comprising
a goal module configured to determine a cooperation goal;
a target module configured to identify a vehicle associated with the cooperation goal and send a swarm request to the vehicle to join a swarm;
a negotiation module configured to receive a swarm acceptance from the vehicle; and
a perception module configured to determine a cooperative action for the vehicle relative to the swarm.

2. The swarm management framework of claim 1, wherein the negotiation module is further configured to transmit at least one cooperating parameter to the swarm from the vehicle.

3. The swarm management framework of claim 2, wherein the at least one cooperating parameter defines a behavioral aspect of the swarm.

4. The swarm management framework of claim 1, wherein the perception module is further configured to initiate a swarm handoff from the vehicle to the swarm.

5. The swarm management framework of claim 1, wherein the goal module further comprises:
a sensor fusion module configured to receive vehicle sensor data from the vehicle;
a prediction module configured to generate a prediction model including a set of possible future events based on prediction parameters and the vehicle sensor data; and
a decision module configured to:
determine whether at least one possible future event of the set of possible future events does not satisfy a threshold compliance value;
in response to each of the possible future events of the set of possible future events satisfies the threshold compliance value, determine that the vehicle would benefit from cooperation in the swarm based on a threshold benefit; and
trigger swarm creation of the swarm.

6. The swarm management framework of claim 5, further comprising a personalization module configured to identify a set of personalization parameters, wherein the threshold benefit is based on the set of personalization parameters.

7. The swarm management framework of claim 1, wherein the target module further includes a positioning module configured to determine a cooperative position for the vehicle relative to the swarm based on the swarm request.

8. A computer-implemented method for utilizing a swarm management framework, the computer-implemented method comprising
determining a cooperation goal;
identifying a vehicle associated with the cooperation goal and send a swarm request to the vehicle to join a swarm;
receiving a swarm acceptance from the vehicle; and
determining a cooperative action for the vehicle relative to the swarm.

9. The computer-implemented method of claim 8, further comprising transmitting at least one cooperating parameter to the swarm from the vehicle.

10. The computer-implemented method of claim 9, wherein the at least one cooperating parameter defines a behavioral aspect of the swarm.

11. The computer-implemented method of claim 8, wherein the cooperative action is a swarm handoff from the vehicle to the swarm.

12. The computer-implemented method of claim 8, the method further comprising:
receiving vehicle sensor data from the vehicle;
generating a prediction model including a set of possible future events based on prediction parameters and the vehicle sensor data; and
determining whether at least one possible future event of the set of possible future events does not satisfy a threshold compliance value;
in response to each of the possible future events of the set of possible future events satisfies the threshold compliance value, determining that the vehicle would benefit from cooperation in the swarm based on a threshold benefit; and
triggering swarm creation of the swarm.

13. The computer-implemented method of claim 12, further comprising identifying a set of personalization parameters, wherein the threshold benefit is based on the set of personalization parameters.

14. The computer-implemented method of claim 8, further comprising determining a cooperative position for the vehicle relative to the swarm based on the swarm request.

15. A non-transitory computer readable storage medium storing instructions that when executed by a computer, which includes a processor perform a method, the method comprising:
determining a cooperation goal;
identifying a vehicle associated with the cooperation goal and send a swarm request to the vehicle to join a swarm;
receiving a swarm acceptance from the vehicle; and
determining a cooperative action for the vehicle relative to the swarm.

16. The non-transitory computer readable storage medium of claim 15, further comprising transmitting at least one cooperating parameter to the swarm from the vehicle.

17. The non-transitory computer readable storage medium of claim 16, wherein the at least one cooperating parameter defines a behavioral aspect of the swarm.

18. The non-transitory computer readable storage medium of claim 15, wherein the cooperative action is a swarm handoff from the vehicle to the swarm.

19. The non-transitory computer readable storage medium of claim 15, further comprising:
receiving vehicle sensor data from the vehicle;
generating a prediction model including a set of possible future events based on prediction parameters and the vehicle sensor data; and
determining whether at least one possible future event of the set of possible future events does not satisfy a threshold compliance value;
in response to each of the possible future events of the set of possible future events satisfies the threshold compliance value, determining that the vehicle would benefit from cooperation in the swarm based on a threshold benefit; and
triggering swarm creation of the swarm.

20. The non-transitory computer readable storage medium of claim 19, further comprising identifying a set of personalization parameters, wherein the threshold benefit is based on the set of personalization parameters.
